(19) United States
(12) Patent Application Publication
(10) Pub. No.: US 2023/0298042 A1
(43) Pub. Date: Sep. 21, 2023

(54) SYSTEM AND METHOD FOR CARBON OBJECTS, CARBON OBJECT DATABASES AND CARBON PLATFORM APPLICATION PROGRAMMING INTERFACE

(71) Applicant: CARBON FINANCE LABS, LLC, Darien, CT (US)

(72) Inventors: Nick GOGERTY, Darien, CT (US); Jonathan HOLLANDER, Darien, CT (US); David UNGAR, Darien, CT (US)

(21) Appl. No.: 17/950,156

(22) Filed: Sep. 22, 2022

Related U.S. Application Data
(60) Provisional application No. 63/318,232, filed on Mar. 9, 2022.
(60) Provisional application No. 63/318,234, filed on Mar. 9, 2022.
(60) Provisional application No. 63/318,237, filed on Mar. 9, 2022.
(60) Provisional application No. 63/318,239, filed on Mar. 9, 2022.
(60) Provisional application No. 63/247,137, filed on Sep. 22, 2021.

(51) Int. Cl. G06Q 30/018

(52) U.S. Cl. CPC G06Q 30/018

(57) ABSTRACT

Described is a system and method for the trusted gathering, accounting, recording, tracking, displaying, and transferring of embodied CO2e or greenhouse gas (GHG) associated with a product or service over the cradle to gate life cycle of the product or service, as an assignable certificate. The system provides an interface and architecture for adding environmental attributes such as carbon credits, offsets, and others mitigation instruments to reduce the declared GHG associated with goods and services to create new higher value add goods and services. The system provides a number of interconnected carbon object library modules and interfaces to instantiate, process and store extensible carbon objects that encodes trackable carbon data.

### RELATED APPLICATIONS

This application claims the benefit of U.S. Application No. 63/318,232, filed Mar. 9, 2022, U.S. Application No. 63/318,234, filed Mar. 9, 2022, U.S. Application No. 63/318,237, filed Mar. 9, 2022, U.S. Application No. 63/318,239, filed Mar. 9, 2022, and U.S. Application No. 63/247,137, filed Sep. 22, 2021, all of which are incorporated herein by reference in their entirety.

### BACKGROUND

Carbon credits have a product wall problem. A carbon credit instrument allows a company or entity that holds it to retire it from trading and claim a certain amount of carbon dioxide or other greenhouse gases (GHG) have been avoided, offset, or removed on their behalf. Typically, one credit instrument reflects the avoidance, offset or removal of a mass equal to one ton of carbon dioxide equivalent in terms of GHG GWP (global warming potential).

The compliance carbon credit is one half of a so-called “cap-and-trade” program. Companies that pollute are awarded credits that allow them to continue to pollute up to a certain limit. That limit is reduced periodically. Meanwhile, the company may sell any unneeded credits to another company that needs them. In the voluntary Carbon market firms are allowed to make a public claim relative to the GHG avoided, offset, or removed on their behalf.

Companies are thus doubly incentivized to reduce greenhouse emissions. First, they will be fined if they exceed the cap. Second, they can make money by saving and reselling some of their emissions allowances.

Numerous cap-and-trade programs exist throughout the world, each with their own rules and implementation. These include, for example 10 US states via the Regional Greenhouse Gas Initiative (RGGI) and also California, and the 190 nations signed on to the Paris Agreement.

Many nations also have carbon taxes or penalty schemes, including as of the date of this disclosure, Argentina, Canada, Chile, China, Colombia, Denmark, the European Union (27 countries), Japan, Kazakhstan, Korea, Mexico, New Zealand, Norway, Singapore, South Africa, Sweden, the UK, and Ukraine. Furthermore, at the date of this disclosure there are, according to the World Bank, 64 carbon pricing initiatives are currently in force across the globe.

FIG. 41 shows a typical system flow for existing technology for tracking and exchanging carbon instruments at the time of the present disclosure. At block 902, a process manager responsible for carbon instrument management generates widgets for that entity’s proprietary system that encodes a need to mitigate x tons of CO2 for a product or process. At block 904, the widgets records the carbon instruments to a back-office inventory for the proprietary system with attendant paperwork for each carbon instrument. At block 906, a carbon purchasing agent submits a purchase of the x tons as a “portfolio” to a Registry. At block 908, the Registry registers the purchase, which at block 910 is inventoried as carbon credits by the proprietary system. At block 912, the basis for the purchased carbon credits of x tons is recorded at an accounting or tax system. At block 914, for a sale of the widgets and carbon instruments, the proprietary system checks its inventory of widgets and carbon instruments. At block 916, sells the widgets and carbon credits and at block 918 attaches attendant documentation for the carbon instruments for x tons to a third party. At block 920, the process manager adjusts the widget inventory of carbon instruments to account for sale, and at block 922, the widgets record the carbon credit adjustment to the back-office inventory for the proprietary system. At block 924, the carbon purchasing agent receives a notification to record the sale of the x tons of carbon to the third party. At block 926, the Registry registers the sale. At block 928, the accounting system then closes the carbon instrument as the x ton basis in the trade is closed.

The problem with typical carbon credit accounting technology as exemplified above includes a lack of technology for carbon attribute management, as well as a lack of a technological tool to determine what entities are responsible for carbon units and carbon credits throughout the process and manufacture life cycle of a product or service. Further, conventional technology offers no solution for providing users and consumers outside of the product or service supply chain a measure of the carbon attributes of the products and services they are purchasing, adding value to, or selling. Conventional ledgering and trading of carbon credits relies on proprietary or closed systems with opaque measurement and reporting. This leaves many consumption behaviors by corporations or individuals largely outside of climate change solutions.

Another problem with traditional carbon credits, offsets, and other instruments associated with tracking or assigning environmental attributes for voluntary or compliance requirements is the inability to scale and track a carbon footprint to discrete and practical measurements. Conventional carbon instruments are typically measured in increments of 1 metric ton of carbon removed, abated, or generally managed relative to an environmental attribute. Similarly, traits such as green credits or REC (renewable energy credits) are measured in 1 MWh (megawatt hour).

These current units face two challenges
1. Current environmental instruments are not divisible in the current registries. Meaning that small amounts such as 1 gram or 1 kWh (kilowatt-hour) cannot be assigned to climate mitigation or abatement activity
2. Current instruments are owned, transferred, and retired for claims or obligations by corporate entities. These entities can only assign the increments to other entities. The system as envisioned allows these entities to extend the assignment of these attributes to specific products and services. The environmental attributes then become embedded within and “owned” by the assigned goods and services which can be passed across a value chain with these new traits tracked and traced with high environmental and accounting integrity.

Thus carbon credit tracking and management can only be measured and tracked at industrial scales, leaving small scale everyday usage - and tools remediation - in the dark.

Many goods and services are consumed in smaller increments such as a cup of coffee. Being able to assign and track environmental traits in small increments can be useful in creating new products, interfaces, tracking mechanisms, and services.

Further, there are numerous measurements, policies, mandates, systems, formats, and tools designed to measure carbon emissions; however there is no consistency between them. As noted above, carbon tracking and focus today is mainly at the industrial and company, not the individual product level. Carbon embodied in making products remains hidden across supply chains. Nor is there any consistent method to determine how carbon is calculated, verified, and tracked at each exchange.

Finally, systems for carbon management are not designed to for interoperability across literally millions of stakeholders and users, and have no consistent technological tool for interfacing with coherent yet flexible carbon management.

### SUMMARY

Described herein are embodiments of a system, method, computer program product, and application programming interface and coding schema for a carbon management platform. In an implementation, a system configured to generate, process, and store extensible carbon objects comprises an input and a memory including non-transitory program memory for storing at least instructions and a processor that is operative to execute instructions that enable actions, the system comprising an application programming interface (API) gateway server between a logical layer and a representational layer.

The API gateway server can be configured with an extensible Carbon Reporting Markup Language (<CarML>) configured to interface software with the logical layer, the <CarML> comprising a core set of common data schema including interface objects for extensible carbon objects, the API gateway configured to allow the user to generate an extensible carbon object.

The logical layer of the system can comprise a plurality of library modules for monitoring and tracking carbon emissions, including: a process library comprising a user interface to an external client. The logical layer of the system can also comprise a Defined Unit Inventory configured to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data.

The logical layer of the system can also comprise a Reference Unit Library comprising an extensible absolute unit reference manager to instantiate and store the Reference Unit object wherein the Reference Unit object comprises a unit of emission datum. A Reference Unit Library of the system can comprise an extensible absolute unit reference manager to instantiate and store the Reference Unit object. The Reference Unit Library can comprise a conversion algorithm configured to convert data values to base units associated with the Reference Units.

The logical layer of the system comprising the plurality of library modules for monitoring and tracking carbon emissions can further comprise: an Attribute Library comprising a plurality of the extensible attribute objects configured to include a plurality of attribute dimensions including a dimensional structure for the Reference Units and the Defined Units, the attribute dimensions comprising the environmental carbon attribute data. The extensible attribute objects can further comprise an import attribute configured to import an attribute into a client user’s Attribute Library; a create new attribute object configured to create a new attribute for an attribute library; a modify attribute object configured to allow a user modify an attribute, wherein each version of the attribute object is stored on the system; an archive attribute configured to remove an attribute from a library, depreciate objects associated with the attribute, and alert users to the depreciation; a copy attribute object; and a designate attribute object configured to designate an object as a unit of measurement. An attribute object designated as a unit of measurement (UoM) attribute can be configured be selected as key UoM for an object or as a functional UoM for a Life Cycle Inventory (LCI).

The logical layer of the system comprising the plurality of library modules for monitoring and tracking carbon emissions can further comprise: a relational database comprising a database for carbon data transactions, wherein the relational database can comprise a distributed immutable ledger.

The system can comprise a Life Cycle Inventory (LCI) library database configured to store an environmental carbon impact record for the life cycle of an item or process, based on the process inputs and outputs of a Reference Unit and a Defined Unit. The system can comprise the ledger configured to: record an extensible carbon object to the LCI. The system can be configured to generate a carbon life cycle analysis (LCA) a report of the life cycle from the LCI. The system can be configured to encode carbon emissions and removals for a carbon life cycle analysis (LCA) to the extensible carbon object.

The library modules can further comprise: a Conversion Library comprising conversion information for the environmental carbon attribute data and comprising a conversion algorithm configured to convert data values to base units associated with the Reference Unit.

The system can be configured to encode searchable carbon objects that are stored to a searchable greenhouse gas database and reporting module. The system can further comprise: a display layer interface comprising: a display manager user interface configured to allow a user to input data to a storage and compute layer; and a report manager, the report manager being configured to generate a greenhouse gas (GHG) life cycle for an item or process as a structured data object and a machine-readable code associated with a Defined Unit.

In an embodiment, this disclosure relates to a system comprising input and a memory including non-transitory program memory for storing at least instructions and a processor that is operative to execute instructions that enable actions. The system comprises a logical layer comprising a plurality of library modules for capturing, monitoring, tracking, and publicly declaring carbon emission data as a digital twin associated with a real world product or service, including: a process library comprising a user interface to an external client; a Reference Unit Library comprising an extensible absolute unit reference manager to instantiate and store a Reference Unit object, the Reference Unit object comprising a unit of emission datum; a Defined Unit Inventory configured to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data; and an Attribute Library comprising a plurality of extensible attribute objects configured to include a plurality of attribute dimensions including a dimensional structure for the Reference Units and the Defined Units, the attribute dimensions comprising the environmental carbon attribute data and <CarML> tags. The system also includes an application programming interface (API) gateway between a logical layer and a representational layer. The API gateway server is configured with an extensible Carbon Reporting Markup Language (<CarML>) configured to interface software with logical layer. The <CarML> comprises a core set of common data schema and message types including interface objects for extensible carbon objects, and third party external systems.

In another embodiment, this disclosure relates to a method of gathering, accounting, recording, tracking, displaying and/or transferring of embodied CO2e of a product or service as an assignable certificate. The method comprising providing a system comprising input and a memory including non-transitory program memory for storing at least instructions and a processor that is operative to execute instructions that enable actions; a logical layer comprising a plurality of library modules for capturing, monitoring, tracking, and publicly declaring carbon emission data as a digital twin associated with a real world product or service; an application programming interface (API) gateway between a logical layer and a representational layer. The API gateway server is configured with an extensible Carbon Reporting Markup Language (<CarML>) configured to interface software with logical layer. The <CarML> comprises a core set of common data schema and message types including interface objects for extensible carbon objects, and third party external systems. The plurality of library modules includes: a process library comprising a user interface to an external client; a Reference Unit Library comprising an extensible absolute unit reference manager to instantiate and store a Reference Unit object, the Reference Unit object comprising a unit of emission datum; a Defined Unit Inventory; and an Attribute Library comprising a plurality of extensible attribute objects. The method involves configuring the Defined Unit Inventory to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data; configuring the Attribute Library to include a plurality of attribute dimensions including a dimensional structure for the Reference Units and the Defined Units, the attribute dimensions comprising the environmental carbon attribute data and <CarML> tags; and configuring a report manager to generate an embodied CO2e life cycle of a product or service as a structured data object report or assignable certificate which has a machine-readable code associated with the Defined Unit, and can be recorded to a public ledger.

In accordance with this disclosure, a system and method are disclosed for the trusted gathering, accounting, recording, tracking, displaying, and transferring of embodied CO2e or greenhouse gas (GHG) associated with a product or service over the cradle to gate life cycle of the product or service, as an assignable certificate. The system provides an interface and architecture for adding environmental attributes such as carbon credits, offsets, and others mitigation instruments to reduce the declared GHG associated with goods and services to create new higher value add goods and services. The system provides a number of interconnected carbon object library modules and interfaces to instantiate, process and store extensible carbon objects that encodes trackable carbon data.

A partial list of key features of carbon system platform are:
representing the supply chain involved in the creation of a good or service as a concatenation of processes with discrete physical, environmental, business, and other attributes;
providing extensibility to dimensionalize the attributes of a good or service in a manner consistent with an organization’s definitions of that good or service and to convert between units of measurement;
initiating an out-bound transfer of an inventoried good or service and accept ownership of an in-bound transfer;
tracing and display a highly branched lineage of products, as processes can involve multiple inputs to produce multiple outputs, inventory units may split to be consumed in multiple discrete processes, and homogeneously merge together from multiple supplies; and
assigning a risk buffer to produce a defensible statement of emission by accounting for factors that may generate emissions beyond what is attested to by the user, for example but not limited to: known rare occurrence events, unknown emission sources, or the use of industry average life cycle analyses when measured emissions data is not present.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 a logical architecture and system flow for a carbon management system.

FIG. 2 shows logical flow and interface for a Process Library.

FIG. 3 shows an embodiment of a logical flow for a Defined Unit Inventory in accordance with at least one of the various embodiments.

FIG. 4 shows a logical flow and interface for a Reference Unit library.

FIG. 5 shows a logical flow and interface a process for an Attribute Library in accordance with one of the various embodiments.

FIG. 6 shows a logical flow and interface for objects for a Public Life Cycle Inventory (LCI) library.

FIG. 7 shows an illustrative flow and implementation of a carbon transaction system.

FIG. 8 shows an illustrative flow and implementation of a carbon transaction system.

FIGS. 9A-9B show a logical flow and data input models for a multiple input, single output interface.

FIGS. 10A-10B show logical flows for a single input, multiple output interface.

FIG. 11 shows a logical flow for a branched network carbon object.

. FIG. 12A shows a carbon credit object for nano-piece carbon credits.

FIGS. 12B-12C show examples of GHG reports.

FIG. 13 shows an example of an object model for a single carbon object.

FIG. 14 shows a simplified logical flow and GHG process model for carbon accounting.

FIG. 15 shows an example of a network map of carbon objects and processes for a carbon life cycle.

FIGS. 16A-16D show carbon object encoding the processes as shown in FIG. 15.

FIGS. 17A-17E show examples of GHG reports for the carbon objects of FIG. 15-16D.

FIG. 18 shows an exemplary flow a network map for carbon objects a multiple input, multiple output process.

FIGS. 19A-19B, show carbon object encoding the processes as shown in FIG. 18.

FIGS. 20A-20C shows examples of GHG reports for the carbon objects of FIG. 18-19B.

FIG. 21 shows a network map of carbon objects for processing lumber to wood products.

FIGS. 22A-22E show a logical flow and directed graphs for the processes of FIG. 21.

FIGS. 23A-23G show GHG reports for the processes of FIGS. 21-22E.

FIG. 24 shows a logical flow for a carbon life cycle.

FIG. 25 shows an exemplary carbon message record structure.

FIG. 26 shows a concatenation for a carbon offset.

FIG. 27 shows an exemplary bifurcation of products and services across supply chains for a carbon product for a carbon report interface.

FIG. 28 shows an auto sum total for conservation of carbon.

FIG. 29 shows an exemplary carbon message record structure interface.

FIG. 30 shows an exemplary GHG database.

FIG. 31 shows a dataset of exemplary GHG declarations and reporting standards.

FIG. 32 shows a taxonomy that can be employed in a Carbon Markup Language <CarML> schema.

FIG. 33 shows an example of a <CarML> message type implemented in a JSON schema.

FIG. 34 shows an exemplary architecture interface for a <CarML> encoded messaging bus 214 for a carbon system platform.

FIG. 35 shows an example of an XML structure and a large database of the XML data.

FIG. 36 shows an exemplary <CarML> message type structure configured for tracking and declaring carbon objects.

FIG. 37A shows an exemplary <CarML> declaration schema which lays out the taxonomic structure for <CarML> key, value pairs and object metadata. FIG. 37B shows an exemplary <CarML> Root Schema, Taxonomy, and Key Value tagging for declaration data objects. FIG. 37C shows that the <CarML> schema illustrated in FIG. 36 can be expanded to any product or service library or database 272.

FIG. 38 shows an illustrative cloud computing environment for the system.

FIG. 39 shows an illustrative set of layers provided by an example cloud computing environment.

FIG. 40 shows the logical architecture for an example cloud computing environment.

FIG. 41 shows a conventional carbon reporting and certificate system and registry process.

FIG. 42 shows base primitive logical elements of the system.

FIG. 43 shows assigning a cradle to gate LCI (life cycle inventory CO2e (carbon dioxide equivalent) functional unit to an object.

FIG. 44 shows a system for combining any mix of objects and processes to determine the process emissions associated with a terminal object representing a product or service.

FIG. 45 shows creating a product’s CO2e footprint using a digital carbon twin to model a mix of products, services, and processes across a value chain or multiple value chains.

FIG. 46 shows creating a digital carbon twin to track CO2e of a service using multiple objects and processes in a model.

FIG. 47 shows special objects associated with managing and sharing the declared CO2e of products and services across supply chains and process transformations.

FIG. 48 shows attaching a carbon related instrument or declaration to an object using a special process.

FIG. 49 shows transferring the environmental process claims as an object certificate associated with an object (process or service) representing a digital carbon twin to a third party who then owns the public rights to the environmental claims.

FIG. 50 shows the ability to visualize any product or service’s provenance of CO2e declarations.

FIG. 51 shows adding value to a product or service by managing the net declared carbon dioxide equivalence across supply chains for multiple end products.

FIG. 52 shows LCI Reference library for maintaining private, public and declared reference and specific product embodied carbon facts.

FIG. 53 shows an example of keeping and using third party and custom LCI (life cycle inventory) embodied and net declared CO2e data.

### DETAILED DESCRIPTION OF THE EMBODIMENTS

Various embodiments now will be described more fully hereinafter with reference to the accompanying drawings, which form a part hereof, and which show, by way of illustration, specific embodiments by which the innovations described herein can be practiced. The embodiments can be embodied in many different forms and should not be construed as limited to the embodiments set forth herein. Rather, these embodiments are provided so that this disclosure will be thorough and complete, and will fully convey the scope of the embodiments to those skilled in the art. Among other things, the various embodiments can be methods, systems, media, or devices. Accordingly, the various embodiments can take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in an embodiment” or “in at least one of the various embodiments” as used herein does not necessarily refer to the same embodiment, though it can. Furthermore, the phrase “in another embodiment” as used herein does not necessarily refer to a different embodiment, although it can. Thus, as described below, various embodiments can be readily combined, without departing from the scope or spirit of the present disclosure.

In addition, as used herein, the term “or” is an inclusive “or” operator, and is equivalent to the term “and/or” unless the context clearly dictates otherwise. In addition, throughout the specification, the meaning of “a” “an” and “the” include plural references. The meaning of “in” includes “in” and “on.”

The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and can be within a single module or device or between one or more remote modules or devices.

For example, a computer hosting a platform can communicate to a computer hosting one or more websites, and/or event databases via local area networks, wide area networks, direct electronic or optical cable connections, dial-up telephone connections, or a shared network connection including the Internet using wire and wireless based systems.

The following briefly describes embodiments to provide a basic understanding of some aspects of the innovations described herein. This brief description is not intended as an extensive overview. It is not intended to identify key or critical elements, or to delineate or otherwise narrow the scope. Its purpose is merely to present some concepts in a simplified form as a prelude to the more detailed description that is presented later.

Described herein are embodiments of technology for analyzing and providing technological solutions for interfacing, generating, and linking objects that are configured for a carbon and greenhouse gas (GHG) identification and exchange across entities and product or service life cycles.

Described is a system for trusted accounting, recording, tracking, and displaying the embodied carbon dioxide equivalent (CO2e) or greenhouse gas (GHG) associated with producing a product or service, over the cradle to gate life cycle of the product or service. Cradle to gate refers to all transactions, activities, and events, from initial conception or production to final disposition of a product or service, affecting the embodied CO2e or GHG of the product or service. Transactions include, but are not limited to, carbon offsets, credits, removals, environmental declarations, environmental certificates, environmental verifications, and the like. Activities and events include, but are not limited to, all processing, usage, transfers, assignments, and the like, of products or services.

Accounting involves the tracking and assignment of GHGs associated in such a way that the GHG associated with a product or service accurately reflects a technically defensible declaration included in the production of the good or service up to a point in time over the entire value or supply chain associated with the product or service.

The recording involves various owners of a good or service pre-consumption contributing their defensible declarations of the GHGs associated with their step in the value chain into a transferrable immutable public certificate and transparent ledger or verified or recorded on a blockchain to build trust.

The output at any step in the process can be displayed as a digital or paper report or as a digital object with unique identifiers and certifications associated with supporting documentation over the present and prior life of the good or service.

The system provides an interface and architecture for adding environmental attributes such as Carbon Credits, offsets, removals, and other mitigation instruments to reduce the net declared GHG associated with goods and services to create new higher value add goods and services.

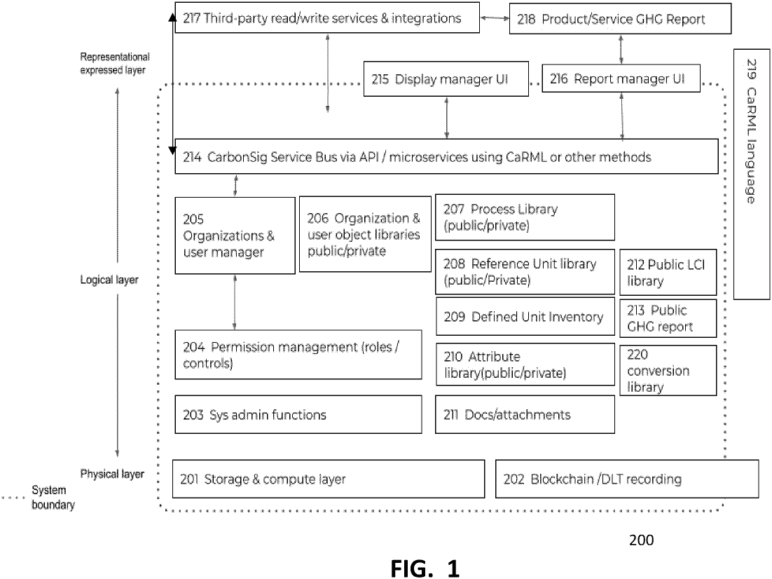

In an implementation, FIG. 1 shows an overall logical architecture and system flow.

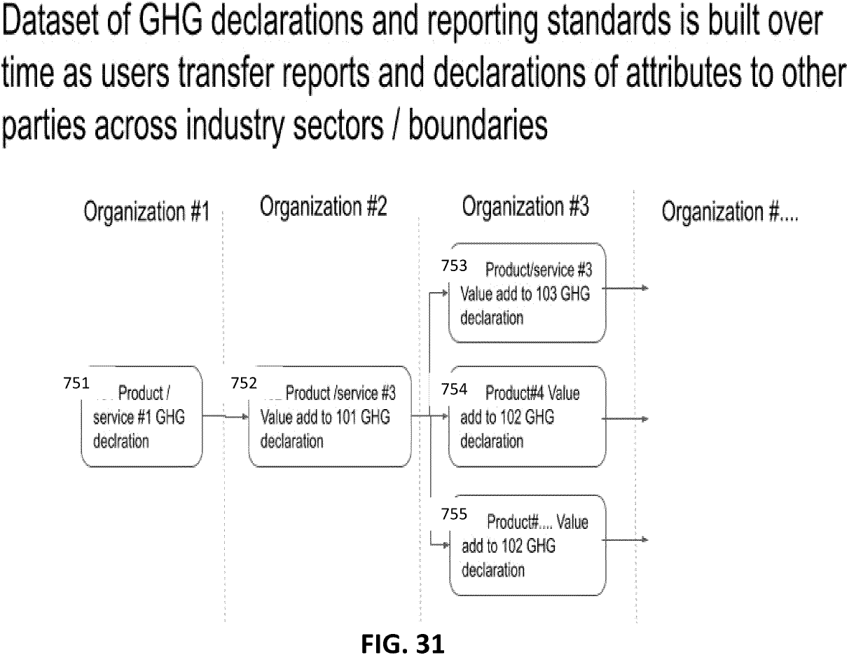

A storage and compute layer 201 comprises a relational database and virtual computational environment. In an implementation, the storage and compute layer 201 can be configured to be hosted by a third-party cloud services provider. An exemplary cloud service architecture is described more fully herein with respect to FIGS. 31-33.

In an implementation, the system 200 comprises system administration functions 203 (Sys Admin). The Sys Admin 203 permits platform administrators to access higher functions of the system, including but not limited to: provisioning new organizations and organizational administrators, customer billing, software updates and other changes required to keep the system 200 functional and performant.

In an implementation, the system 200 comprises permission management 204 (roles/controls). This allows for the management of data access to specific parties with assigned permissions and privileges. In an implementation, specific bounds can be defined for various data and action parameters for an organization and user manager 205 and organization and user object libraries 206 allowed by the system 200, such as the transfer of a carbon data object, a declaration of product / service attributes, and a report and the assigned ownership of environmental attributes and claims to another organization within the system 200.

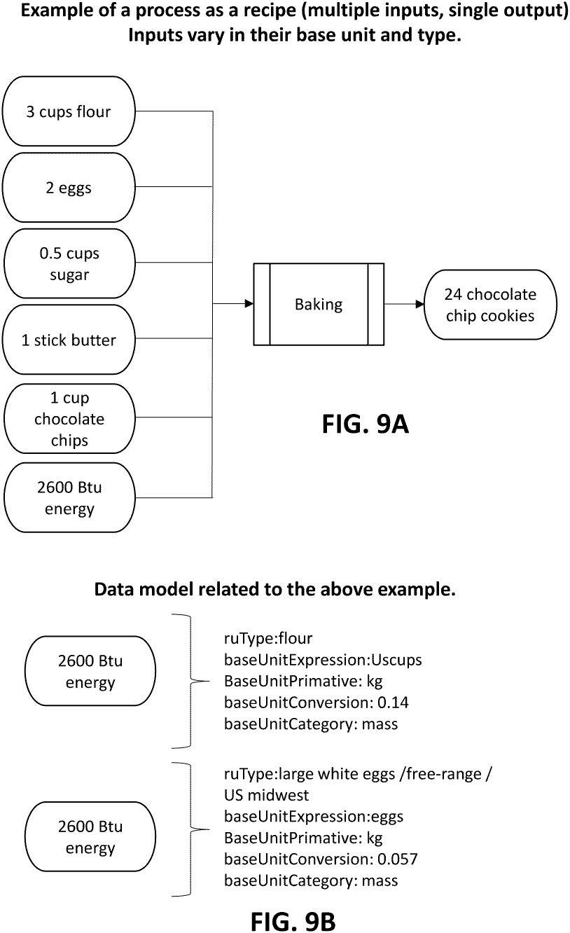

In an implementation, the system can be configured to integrate with a distributed immutable ledger 202 or Blockchain. In an embodiment, carbon data transactions can be hashed with a unique hash as an identifier that is recorded, replicated, shared, and synchronized with a consensus of digital data logs that are spread across multiple sites without a central administrator. This decreases the likelihood that data can be tampered with to produce an immutable historical record of transactions with high transparency and trustworthiness. Multiple actors may then confirm and maintain the integrity of the system data, records, and logs. A distributed immutable ledger 202 is described in more detail with respect to FIGS. 9-11.

In an implementation, the system 200 comprises an organizations and user manager 205. The organizations and user manager 205 includes a digital representation of an organization and its member users on the system 200. Data owned by or pertaining to a specific organization or user can be created, managed, and permissioned to the organization through this layer. Organizational administrators can create and suspend user accounts through this module.

In an implementation, the system 200 comprises organization and user object libraries 206, which can be configured as public for reference, reuse, and modification or private. The organization and user object libraries 206 are configured to allow the system 200 to identify users and organizations on the service for customer service, billing, marketing, communications, and internal functions including confirming parties to the transfer of reports between organizations; and tracking of organizationally defined Process templates, Base Units, Attributes, and Reference Units, described in more detail below.

In an implementation, the system 200 comprises a process library 207. The process library can be configured as public or private. Processes include processes and algorithms configured to process input objects and output objects. These processes and algorithms can be created, stored, or referenced for re-use as templates to be populated with values by a user. Process libraries can be configured as publicly open, private to an organization, or configured with both public and private databases.

In an implementation, the system 200 can be configured to make a process public when declared in a summary report. In an implementation, making the process public thus can be done automatically.

The system 200 can be configured to allow entities to publish reference libraries of processes. For example, entities such as industry groups, regulatory bodies or other entities can publish reference libraries of processes

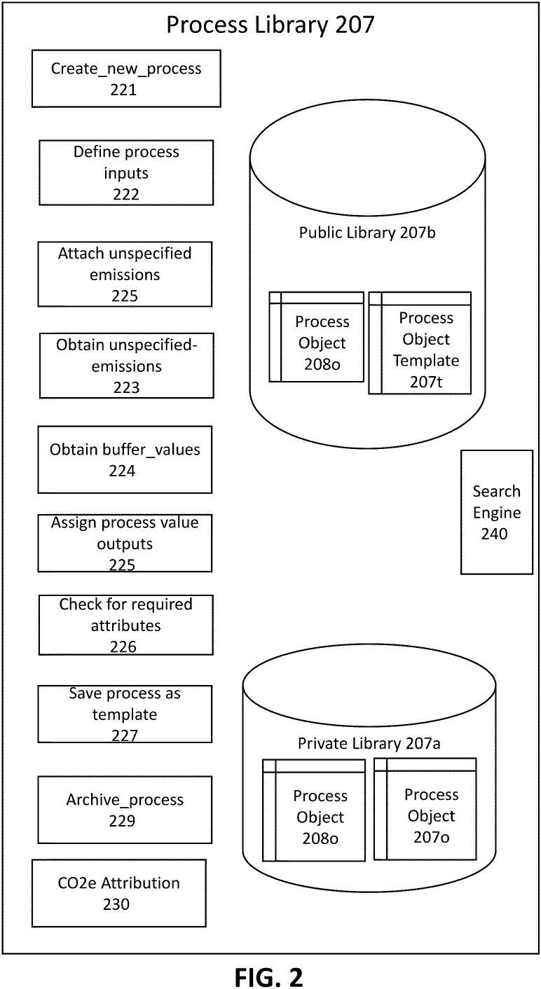

A logical flow and interface for a Process Library is shown in FIG. 2.

In an implementation, at block 221, the system 200 interface can be configured to comprise a create new process (create_new_process) operation. The create new process operation is configured to allow a user to create a new process object 207o in a private process library 207a. The new process object 207o can then be flagged to a public process library as public.

At block 222, the interface is configured to allow a user to define a process’s inputs, which can be selected from reference inputs and/or defined objects The interface is configured to allow the user to state the quantity used in the process. In a defined object (defined_object), described in more detail below, it can be any amount up to an entire inventory value

In an implementation, at block 223, the system 200 interface comprises an unspecified emissions operation (unspecified_emissions) operation. The unspecified omissions operation 223 can be configured to allow a user to attach a process object’s 207o unspecified emissions from the process library 207. At block 224, the interface is configured with an operation to obtain buffer values (buffer_values) from the Attribute library 210.

In an implementation, at block 225, the system 200 interface comprises an operation to assign/attach process’s outputs for a process object 207o in the process library 207. The system 200 is configured to obtain selected outputs from extended objects templates in a user organization’s object library reference library 208. The extended objects template 208x provides attribute structure and what information is public/private. The interface is configured to allow a user to enter the quantity produced. The interface is also configured to allow a user to enter attribute values or to accept attribute values provided as defaults. At block 226, the system 200 is configured to check for required attributes and determine if they are not entered or confirmed.

In an implementation, at block 227, the system’s interface comprises an operation to save the process as a template. The system 200 is configured with an operation to allow a user to save the process as a template 207t into the Process library 207. In an implementation, saving a process template is not automatic. The system 200 can be configured to save the template 207t to a private process library 207a, for example, a local entity library 207a. The system 200 can be configured to allow the user to publish the process template 207t to a public process library 207b or to keep the process private. For example, a user may wish to keep a process private if it is a working project, training session, proprietary information, a modelling exercise, and so on.

If the process template 207t is saved, the system 200 is configured to capture the reference objects that were used as inputs and outputs for quick reference.

In an implementation, the process library 207 is configured with a search engine 240 to be searchable. The system 200 interface can be configured to allow a user search for a process in a process reference library 207 for use. In an implementation, search can be by organization, process type, keyword, input, output, etc. The system 200 can be configured with a filter to allow the user to filter search of inputs. The search can be limited to showing only those described by the process’ input objects. If there are no defined objects or reference inputs that match the process’ inputs, then system 200 is configured to alert or flag to the user that they cannot continue.

In an implementation, at block 229, the system 200 interface can comprise an operation to archive a process template 207t in the process library 207. The archive reference input operation removes the process template 207t from future use. In an implementation, the system 200 can be configured to allow the archived process to be visible for review only or view only.

In an implementation, at block 230, the system 200 interface can be configured with an operation to determine CO2e attribution method and allocation value for a process library object 208o. The system 200 can be configured so that CO2e is attributed to a product or service to reflect not less than 100% of prior CO2e. Operations for assigning CO2e for declaration include a functional unit-base (mass or energy etc.) and, in the case of functional unit loss, CO2e that is conserved and allocated proportionately. The attribution for the process library object 207o also includes an economic value-base, whereby a user can give a relative economic value of the product or service stage when allocating the Co2e. The interface attribution for the process library object 207o can also include user determined explicit assignments and callout cases.

In an implementation, the system 200 can be configured to comprise a Defined Unit Inventory 209. A Defined Unit are output data objects of a process on the system 200. Defined Units are described by their quantity, environmental attributes, and other associated attributes. The quantity and data values of a Defined Unit exist as a physical service capacity or capability and/ or an object for an inventory item owned by an organization or entity.

In an implementation, the system 200 is configured to link Defined Units to processes in the system 200. Defined units existing in an organization’s entity Defined Unit Inventory 209 are depleted during use as an input to a process. The system 200 is configured to tag each Defined Unit consumed as an input to a process as a parent object of the process outputs. The process outputs become newly created Defined Units acting as digital twins. The system 200 is configured to generate and process new Defined Units as a concatenation of historical processes throughout a supply chain across inter or intra organizational boundaries.

Defined Unit certificates can be transferred between organizations as legal claims or representations to the attributable provenance of the physical, logical, process or other inputs and actors required to produce a product or deliver a service. A Defined Unit exists in a user’s inventory until a trigger event occurs, such as being consumed as an input in another process or transferred as a publicly assignable object certificate to another organization.

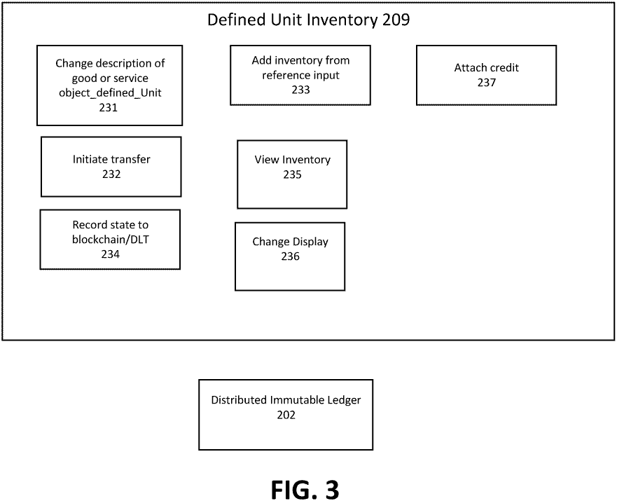

A logical flow and interface showing exemplary process types for a Defined Unit Inventory 209 is shown in FIG. 3.

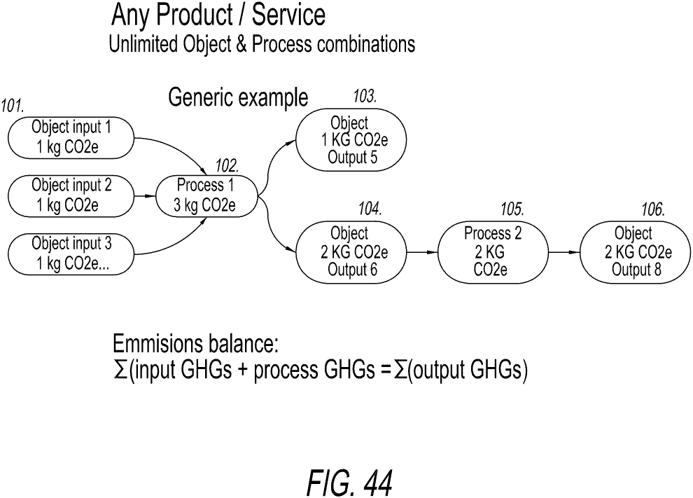

In an implementation, at block 231, the Defined Unit Inventory 209 interface comprises an operation to define an object. The system 200 interface is configured to change the description of a good/service (object_defined_Unit) stored in defined unit inventory 209 by changing an extended object template 208x that dimensionalizes it. This is, in effect, a process with the entire inventory item object that is used as the sole input and values mapped onto a new different extended object template as the output. The process genealogy and concatenation of carbon emissions/reductions are unaffected by this process, thus producing no new carbon emission records. This allows a user to add logical attributes to the Defined Unit such as, for example, tracking number, purchase order, location type, internal identifier, tags, SIC, and so on. Attributes can be local (e.g.: internal ID), transactional (e.g., purchase order), or global (tag in <CarML>). A clear technological advantage is the linking and concatenation via the extended object templates 208x, and mapping is record fidelity and accurate, non-duplication carbon GHG emissions across the system 200. As will be appreciated, this type of process produces highly accurate GHG emission transfers and tracking on a full audit. This can be seen in FIGS. 44-46.

In an implementation, at block 232, the system 200 comprises an initiate transfer operation. The system 200 is configured to initiate a transfer of ownership of a defined object certificate from Defined Unit inventory 209 to another tenant member inventory (organization) or another tenant organization or user 205 in the system 200. In an implementation, all records of transactions and data to be verified and or recorded on a blockchain /DLT 202. The transfer is a process with a quantity of the inventory object (up to the entire amount) consumed as the single input and the emissions/reduction and public attributes mapped onto a newly defined object as the output.

At block 234 the system 200 is configured to record Defined Unit Transfer states to a transaction database, for example, a blockchain /DLT 202. A Defined Unit Transfer has 5 states with records of transactions and data to be recorded to the blockchain /DLT 202. An offered state is a form of transfer that places an inventory item into a public offered state which is visible (searchable) like a public listing marketplace. The offered state may be reverted to inventory by the initiator or a transfer initiated to a counterparty. An initiated state means the transfer is released from the initiator’s inventory. A pending state means a transfer is published/not accepted (awaiting acceptance). In an implantation, an offered or pending inventory item cannot be altered or used for processes. An accepted state is triggered when another tenet accepts the object certificate transfer, whereby the system 200 changes the Object_attribute (owner) of the object to the new tenant, who then owns interface privileges for the object (e.g.: read/write, transfer etc.) and becomes visible in their inventory. An accepted by (Expired) state can occur after a defined time period, where the transfer is considered consumed and not revocable. Once an offer is accepted, the attributes declared by the prior owner cannot be altered, but they can be extended.

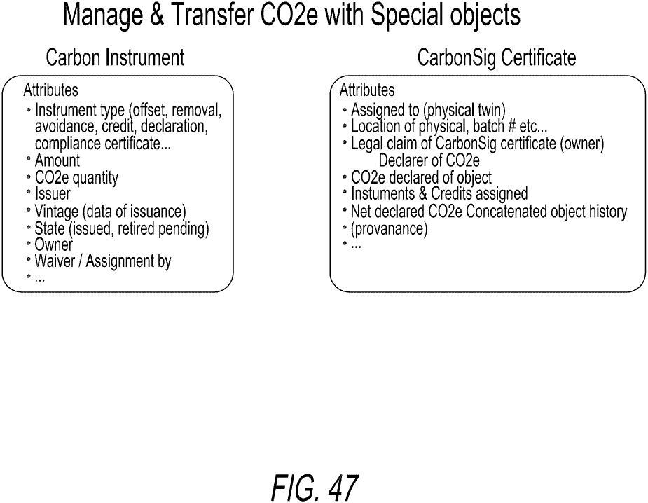

The transfer can be considered a certificate with multiple traits one being the owner of the expressed traits representing a real world good or service as a carbon equivalent digital twin as shown. The certificate data may include data attributes such as the example shown in FIG. 47, item 102.

At block 234, once accepted, the system 200 is configured to record accepted transactions to the blockchain /DLT 202 as described above. When a transfer is accepted, the new owner can use the interface operation to define an object 231 to describe the defined object with their own private attributes by changing the extended object template 208x. The owner attribute is updated to the tenant accepting the transfer. As noted above, this type of process produces highly accurate GHG emission transfers and tracking on a full audit.

In an implementation, the system 200 is configured to allow user to add to inventory records of transactions and data to be stored in blockchain /DLT recording 202. At block 233 the system 200 can be configured to create a defined object directly from a reference input. For example, the system 200 can be configured to create a carbon offset credit defined object directly from a reference input. When a reference input is consumed in a process, the system 200 can be configured to do this automatically. The system 200 thereby advantageously can add objects to inventory and immediately consumes an entire quantity in the process. The system 200 can also be configured to automatically consume a reference unit object and create a new defined object when accepting an offer. At block 234 the pending object certificate transfer can show up in the inventory of the potential acceptor as “pending” with the ability to accept or reject transfer of the object certificate. The carbon dioxide equivalent according to the process is calculated and managed across the process and value chain logically as shown in FIGS. 44- 46.

In an implementation, the system 200 comprises a view inventory interface 235 configured to allow a user to view inventory, search inventory, or export via the Display manager UI 215. From here, the interface is configured to Display a detailed GHG report 213 as described herein. The system 200 interface comprises a change display unit interface object configured to allow a user to change display units. A change display unit 236 is an interface level tool showing a preferred displayed functional unit and the significant figures to display. interface if, for example, shifting an order of magnitude can adjust related significant figures to display accordingly.

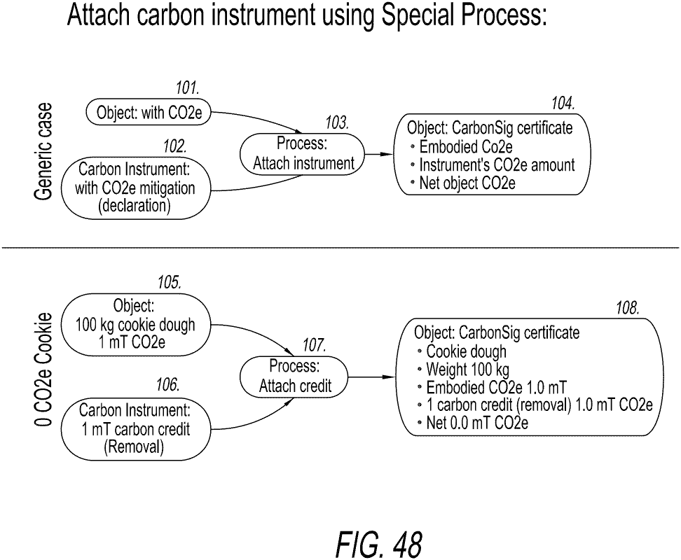

In an implementation, the system 200 comprises an attach credit operation 237. The attach credit operation is configured to attach a credit to an object in the defined unit inventory and thereby reduce the net declared carbon of an object by embedding an environmental instrument attribute. The system 200 executes object asset credit (Object_asset) for a GHG-related environmental instrument from Defined Unit inventory 209 input to a process found in process library 207. In an implementation, the environmental instrument credit can be “split” into smaller units. For example, a Metric Ton credit can logically be broken into grams or smaller units. In an implementation, the environmental unit credit may not be disaggregated or stripped from the object via a process once assigned and embedded into the object. A carbon related instrument or declaration can be represented by a special object with representative attributes shown in FIG. 47, item 101. The Carbon instrument’s attributes can be logically associated with an object in the system as shown in FIG. 48 by using a logical process.

The system 200 is configured to adjust the net declared output CO2e of the object by the credited instrument amount. The credit amount is carried along across processes with the object. This is displayed and explicitly called out in Public GHG Report 213 and Product/Service GHG report 218 or in Third-party read/write services and integrations 217. The credit data may specifically travel with the credit or be (consumed) by the process and embedded into the output(s) stored in the defined unit inventory 209 as described above.

Credits are special Reference Units with some required attributes per a schema associated with fields, described below with respect to the Reference Unit library.

A waiver assignment is an attached document signed by the attaching tenant organization that indicates the specific credit environmental attribute claims has been retired by the organization and assigned to an inventory item in the system which serves as system of public record for the rights to the claim.

A specific credit claim rights have been assigned to the carbon system 200 platform to act as the system 200 of record.

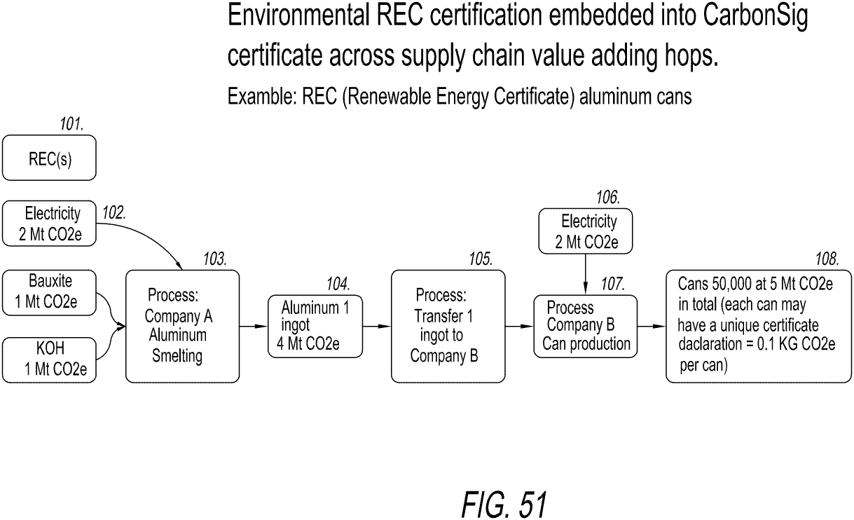

The carbon system 200 platform is configured to allow for the credit assignment in part or whole to multiple products and services in amounts in aggregate to not exceed the original 1 MT CO2e credit environmental attribute. An example of this is shown in FIG. 51., item 108 which is representative of 50,000 separate digital certificates.

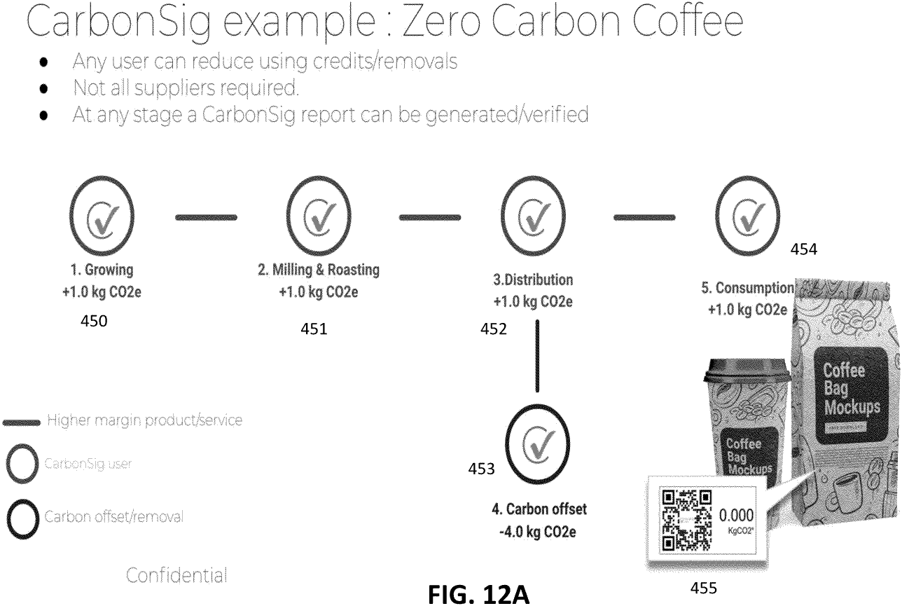

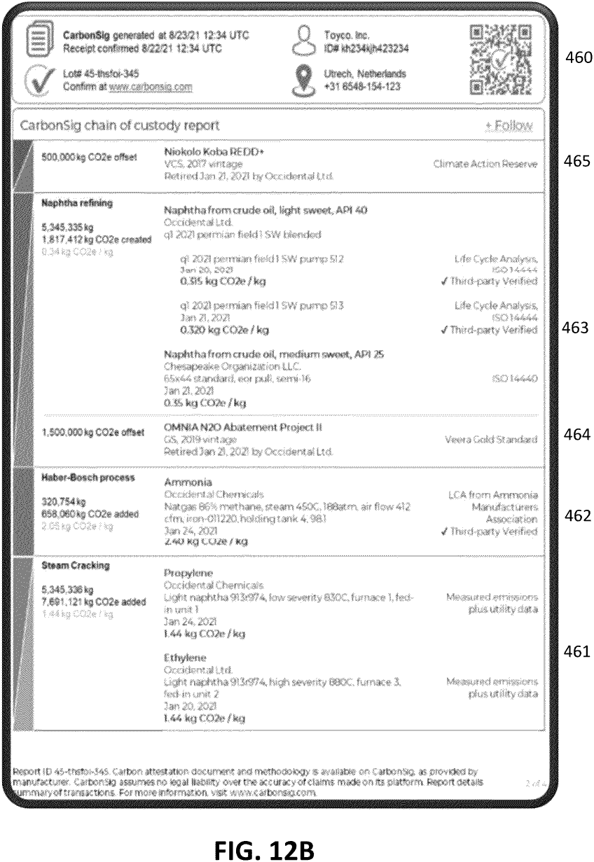

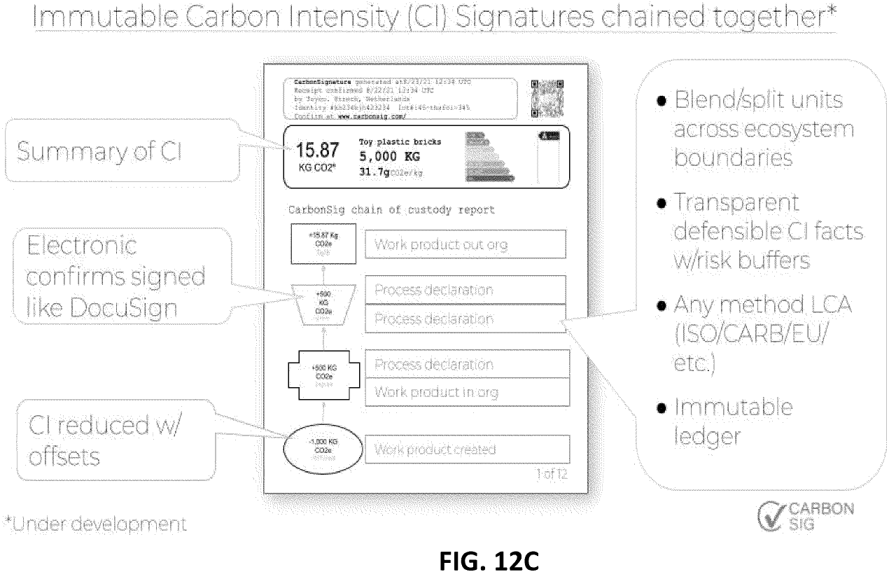

Credits show up as separate call-outs in a summary assignable Carbon Report certificate. An exemplary report interface is shown in FIGS. 12B and C

In an implementation, the system 200 comprises a Reference Unit Library 208. A reference unit is an object template 208t comprised of a number of attributes. The reference unit object template 208t can be configured as an object structure that instantiates an object when data is input, and the reference unit can then be stored in inventory. For example, a kilogram of PVC (poly vinyl chloride) can have multiple chemical, environmental, legal, and logical attributes associated with it. A user can reference the object structure template 208t and can the then populate the attributes’ values to a reference unit to properly describe a physical PVC in inventory or process.

Reference unit libraries 208 can be configured to be a public library208b or private library 208a. For example, many industry and government working groups may wish to publish multiple reference units in public libraries to aid industry and standardize data types for ease of data integration and reporting.

In an implementation, a Reference Unit library 208 is configured to record and store information regarding the environmental footprint - attributes such as emissions per greenhouse gas type - for the production of a given good or service. This includes an average environmental impact of production from the creation of raw material and the energy inputs to its current state (also referred to as a “cradle-to-gate” life cycle inventory). Where data is available, the Reference Unit library 208 provides granularity across different dimensions such as geography, seasonality/time, and other industrially relevant factors. For example, the greenhouse gas emissions resulting from electric power production are dependent on the composition of different regional producers; the emissions are greater where power is made from largely coal thermal power plants versus where proportionately more supply comes from solar photovoltaics. Reference Units are indexed by category/function and come from a variety of third-party resources as well as created by individual organizations on the carbon system 200 platform. The emissions associated with a Reference Unit are expressed relative to a known Base Unit quantity (i.e., “3 metric tons of CO2” per “1 MWh”). Reference Units are used on the carbon system 200 platform as inputs to a process object 208o. Total emissions contributed by a Reference Unit to a process are calculated based on the user-determined quantity. For example, 3 MWh would generate 9 metric tons of CO2). Reference Units can be used as inputs to a process object 208o when the organization does not have them expressed as inventoried Defined Units in the Defined Unit Inventory 209 and are therefore not depleted following use. Advantageously, Reference Units generated via the Reference Unit Library 208 interface can be used in a process 208o again and again.

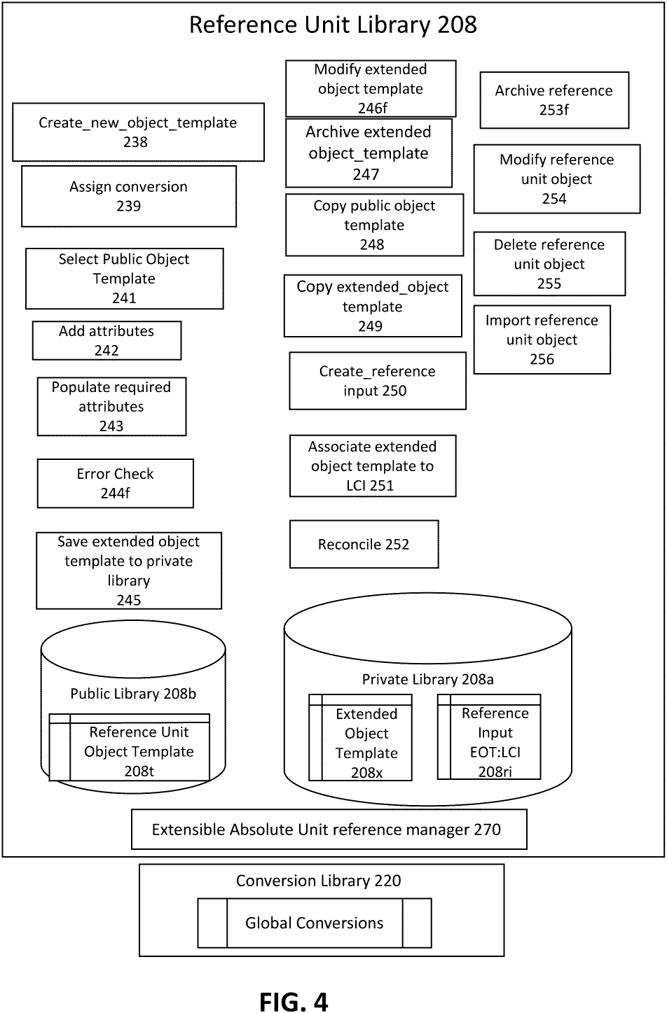

A logical flow and interface for objects for a Reference Unit library 208 is shown in FIG. 4.

### Objects

In an implementation, at block 238, the system 200 comprises a create new object template operation (create_new object template). The create new object template 238 operation is configured to allow a user to create a new object template 208t into a public reference library 208b. The new public object template 208t can be stored in a global library. In an implementation, the object template can comprise a single key unit of measurement (UoM) attributed for a quantity. The single key unit of measurement can be a required element of the new object template 208t. In an implementation, the new object template 208t is configured to allow a user to assign the attributes the user wants to be made public and give default values. The attribute field can include a null state. The new object template 208t is also configured to allow a user to set attributes that are required. A null value may or may not be allowed when defining the object. In an implementation, all attribute values associated with the public object template 208t will become public when a defined object is created. In an implementation, public object templates 208t are not used in processes.

In an implementation, an Extensible Absolute Unit reference manager 270 allows the conversion of one Base Unit to another through specific and defined conversion algorithms. In addition, conversion factors can be inputted by users. Conversion factors can also be resourced from, for example, third-party databases. Conversion factors such can be organizationally context specific to a user type, process, or industry. For example, converting from a volumetric Base Unit such as “barrels” of crude oil to a mass Base Unit such as “kg” would require knowledge of the density (a conversion factor) and the formulaic approach to the conversion. Advantageously, the system allows a user to generate bespoke conversion factors for unique or industry specific units of measurement. The Extensible Absolute Unit reference manager 270 can be configured to store and execute such conversions.

In an implementation, at block 239, the system 200 is configured to assign a conversion from Conversion library 220 to an object’s key Unit of Measurement (UoM) attribute. Standard conversions that are globally defined (e.g., meters to feet) can be configured not to be overwritten. Non-standard conversions can be stored within the object they describe and cannot be reused for another object. For example, an organization may have two objects named “crude oil” and “natural gas.” The key UoM for each is mass in ‘kg.’ The conversion from ‘kg’ to ‘metric tons’ is standard, is defined globally, and cannot be changed. For the object “crude oil,” a user can set the conversion 1 kg = 45 MJ. For the object “natural gas,” a user can set the conversion 1 kg = 50 MJ. Now that a conversion to energy (in MJ) exists, the crude oil and natural gas can be presented in any globally defined energy unit (e.g., the conversion from MJ to Btu is known, so now too is the conversion from kg to Btu).

In an implementation, the system 200 is configured so that conversion attributes are a default public in the Conversion library 220 once they are used in a transfer function. Conversion attributes are configured transfer with a defined object along with any other public attributes. The Conversion library 220 is searchable. Conversion attributes can be looked up or “chained” if they have shared attributes in a mathematically transitive fashion (e.g.: 2.204623 Lbs.= 1 Kg = 0.001 metric tons).

The Conversion library 220 can thus become a large network for mapping the relationships between multiple conversions and attributes. In addition, the conversion tool can be referenced as a tool for the user to select the “display” units and significant or necessary figures for the given user’s requirements associated with a specific context. For example, a retail driver may need a measurement of liters of petrol, whereas a shipper may need VLCC cargo ship units.

In an implementation, at block 240, the system 200 is configured to extend a public object template of reference unit 208t with private attributes from a storage layer 201 for a specific user’s operational context. At block 241, the system 200 is configured to allow a user to select a public object template 208t from the global reference unit library 208b. At block 242, the system 200 is configured to allow a user to add private attributes with a default value, including a null state if allowed, for example, from the Attribute Library 210. At block 243, the system 200 is configured to allow a user to populate required attributes (e.g.: from the Attribute Library 210). A null value may or may not be allowed when defining the object. At block 244 the system 200 is configured to perform an error check on submission. At block 245, the system 200 is configured save the extended object template 208x to the users’ private reference unit object library 208a. The public object template 208t is thus not affected by adding private attributes to the object. The private reference unit library can only be accessed by the user organization and is not publicly searchable. As such, the extended object template 208x is in the private library and cannot be found or used by another organization. When a defined reference unit object 208x is created, the attribute values contained in the public object template are public, while the added attributes values of the extended object template 208x are private.

In an implementation, at block 246, the system 200 is configured to allow a user to modify a public object template 208t from the reference unit library 208 if the user is its publisher. A modification is implemented in the system 200 as a copy and archive. In an implementation, this can be done via copy and archive operations. In an implementation, the system 200 can be configured to alert users of the change to the public object template 208t. When this occurs, any user having or the public object template 208t can be alerted to the change.

In an implementation, at block 246, the Reference Unit Library 208 interface can comprise an operation to modify an extended object template 208x from the library 208. In an implementation, this can be done via copy and archive operations. In an implementation, the system 200 can be configured to alert users of the change to the extended object template 208x. When this occurs, any user having or using the extended object template 208x can be alerted to the change.

In an implementation, at block 247, the Reference Unit Library 208 interface can comprise an operation to archive an extended object template 208x in the private library 208a. The system 200 is configured to remove archived extended object templates 208x from future use. In an implementation, the system 200 is configured not to allow public object templates 208t in the public library 208b to be archived. For example, as other extended object templates 208x can depend on public object templates 2008t, the public object templates 208t are maintained.

In an implementation, at block 248, the Reference Unit Library 208 interface can comprise an operation to copy a public object template 208t from the reference unit library (208). The system 200 is configured to allow a user to copy a public object template 208t from another organization’s reference unit library 208a into that user’s reference unit library 208b. In an implementation, when a user performs a copy public object template 208t operation 248, the system 200 is configured to require unique name-publisher for the copied public object template 208t and sets the user’s organization as the publisher for the copied public object template 208t. In an implementation, the system 200 is configured to pre-populate property values, assigned attributes, and attribute default values of the copied public object template 208t to editable fields that allows changes to the values. As noted above, the system 200 can be configured not to archive public object templates. Copy an extended object template from the reference unit library (208).

In an implementation, at block 249, the system’s reference unit library 208 interface can comprise a copy extended object template operation. The copy extended object template operation interface is configured to allow a user to copy an extended object template 208x from another organization’s reference unit library 208b into that user’s reference unit library 208b. In an implementation, when a user performs a copy of an extended object 208x operation 249 template, the system 200 is configured to require unique name-publisher for the copied extended object template 208x and sets the user’s organization as the publisher for the copied an extended object template 208x. In an implementation, the system 200 is configured to pre-populate property values, assigned attributes, and attribute default values of the copied extended object template 208x to editable fields that allow changes to the field associated values.

### Reference Input

In an implementation, at block 250, the system’s reference unit library 208 interface can comprise interface to create a new Reference Input (Create_Reference_Input) to be stored in the reference unit library 208. The reference unit library 208 supports carbon credits and related environmental instruments. In an implementation, at block 251, the system 200 is configured to allow a user to select an extended object template 208x and an LCI to associate with one another. The reference inputs 208ri are stored in a private reference unit library 208b in reference input object 208ri.

In an implementation, at block 252, the system 200 is configured to comprise a reconciled conversion formula operation for the reference input object 208ri. When creating the new reference input for the object 208ri, the system 200 accesses the conversion formula from the Conversion library 220 to check if the reference unit object’s 208ri key unit of measurement and LCI functional unit of measurement are different, and if a known conversion exists. If so, the system 200 is configured to link the conversion formula linked to the object 208ri. A technological advantage of the conversion link is that the system 200 can process the object 208ri with the linked conversion as though the conversion was established in the creation of the object 208ri itself.

In an implementation, at block 253, The Reference Unit Library 208 interface can comprise an archive reference input object 208ri operation. The archive reference input operation marks the reference input object 208ri as “no longer published” and, if available, indicates a version bump. The interface can be configured to identify updates to the publisher’s reference unit library 208. The archive reference input object 208ri operation removes the reference input object 208ri from future use. In an implementation, the system 200 can be configured to alert users using or storing objects associated with the archived reference unit object 208ri.

In an implementation, at block 254, the system 200′s reference unit library 208 interface can comprise a modify reference unit object operation (modify_reference_unit). The modify reference unit operation can be executed on reference unit objects 208ri in the public reference unit library 208b or an organization’s private reference unit library 208a. In an implementation, at block 255, the system’s reference unit library 208 interface can comprise an operation to delete a reference unit (Delete_reference_unit). The delete reference unit operation can be executed on reference unit objects 208ri in the public reference unit library 208b or an organization’s private reference unit library 208a. In an implementation, at block 256, the system’s reference unit library 208 interface can comprise an operation to import a reference unit object 208ri (Import_reference_unit) from another organization’s public reference unit library 208a into the user’s private reference unit library 208a

In an implementation system 200 is configured to notify global administrators of the system 200 of errors and exceptions in the reference unit library 208. This can include for example, deprecated units, version bumps, deprecated attributes or LCI expirations, etc.

In an implementation, the system 200 can be configured to comprise an Attribute Library 210. Attribute are a data dimension expressed by a value and associated type and descriptors. Attributes provide dimensional structure for Reference Units and Defined Units. All attributes have defined properties and states, such as quantity and type. Attribute extensibility allows for the structuring of industry-relevant or specific data on system 200 objects and provides third-party developers the opportunity to extend the data types and enumeration of the system 200 service enabling new services and features. Attributes can be generic for global use. For example, an object having a public attribute for kilograms as a unit of mass is an example of a global attribute that all organizations on the system 200 can use. Attributes can also be linked to a specific organization or industry group context, for example, for objects linked to organization and user object libraries 206. For example, a 1×1 brick can be an attribute for a specific named unit that the LEGO corporation uses to quantify its production output internally or only to downstream off takers. Accordingly, the Attribute Library 210 can be configured as publicly open, private to an organization, or configured with both public 210b and private databases 210a. In addition, the object could be indicated as “compliant” with <CarML> fields or message types, such that the object then can inherit or reference a fuller global context for usability across systems and operational contexts. For example, if a user declares a box of cereal, using unique ID from the GS1 product code declared as <CarML>. That “cereal” object is now recognizable as specific and globally known context of a uniquely identifiable 24 oz box of the cereal inheriting the global context referenced in the GS1 GTIN system. This allows other inventory systems using the GS1 GTIN as database key to integrate the “object” context more easily into their functional and logical operating context. This process reduces the need for manual or automated object level system mappings and integrations.

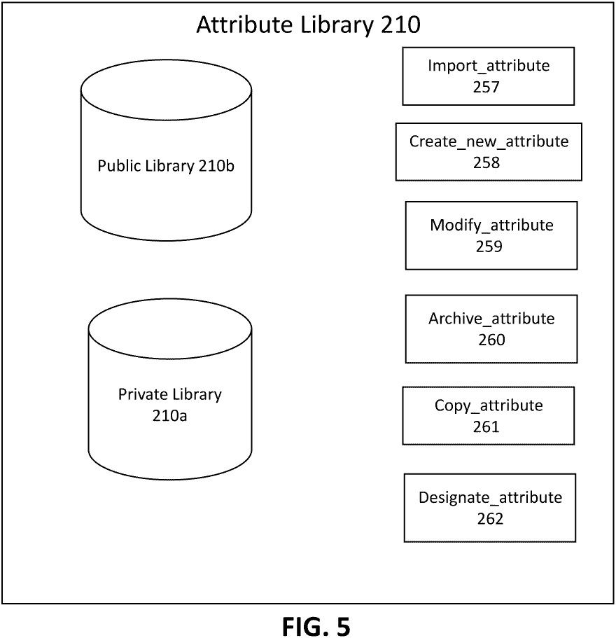

A logical flow and interface for an Attribute Library is shown in FIG. 5. In an implementation, an import attribute (Import_attribute) 257 operation is configured to import an attribute from another organization’s Attribute public library 210a into user’s Attribute private library 210b.

In an implementation, at block 258, An operation to create a new attribute (Create_new attribute) is configured to allow user to create and store a new attribute in the users private Attribute library 210b or the user’s public Attribute library 210b. The create new attribute interface operation 258 includes an input type selector (input_Type), which is configured to have the user select an attribute type. Input type selections can include text, number, date/time, location, true/false, <CarML> compliant or upload. In an implementation, all new attributes are set to be public by default, though the system 200 can be configured to not have the attribute default to a public setting. The interface can also include an option to make the attribute searchable on the platform (published for reuse) or not (e.g., with a block bot command).

At block 259, The Attribute Library 210 interface can comprise a modify attribute operation (Modify_attribute) configured to allow a user to modify an attribute in the Attribute library 210. In an implementation, the system 200 can be configured so that creator or publisher of the attribute can modify the attribute. As will be appreciated, in an implementation, each attribute version is archived such that a record of each version of the attribute is recorded and stored in the system. In an implementation, this can be done via copy and archive operations. In an implementation, the system 200 can be configured to alert users using or storing associated objects to the modification. For example, use instances within objects having the attribute can be updated with the new, modified attribute. When this occurs, any user having or using the object as described herein can be alerted to the change. A modify attribute can restrict access, indicate as expired/deprecated, point to an updated version, point to external context (e.g., <CarML> compliant or some other logical external contextual support). An attribute can also be configured to “link” or lookup any dependent reference in a conversion. For example, for an attribute “Bushel” = 60 lbs, the system can backward look-up “lbs” to find the attribute label and conversion for lookups.

In an implementation, at block 260, the Attribute Library 210 interface can comprise an archive attribute operation (Archive_attribute). The archive attribute operation can be configured to allow a user to remove an attribute from future use. In an implementation, the system 200 can be configured to alert users using or storing associated objects associated with the archive operation. For example, use instances within objects having the attribute can be deprecated.

In an implementation, at block 261, the Attribute Library 210 interface can comprise a copy attribute operation (Copy_attribute), whereby the system 200 is configured to allow a user to copy attributes from another organization’s public library 210a into a user’s private library 210b. In an implementation, when a user performs a copy attribute operation, the system 200 is configured to require unique name-publisher for the copied attribute and sets the user’s organization as the publisher for the copied attribute. In an implementation, the system 200 is configured to pre-populate property values of the copied attribute as editable fields that allow changes to the values.

In an implementation, at block 262, the Attribute Library 210 interface can comprise a designate attribute operation (Designate_attribute) configured to allow a user to designate an attribute as a Unit of Measurement (UoM)) in the users’ private library 210b. The attribute designated as a UOM can then be published to public library 210a. In an implementation, as described herein, a UoM is a special type of attribute that can be selected as the key UoM for an object or as the functional UoM for a Life Cycle Inventory Library 212. In an implementation, the input type is always a number and always public. The unit conversion micro-service is configured to refer to the list of UoM, but not all attributes, when establishing a conversion formula.

In an implementation, the system 200 can be configured to comprise a Documents and Attachment data store 211. Documents and attachments are digital objects or facsimiles that can be associated attributes of specific defined units, attributes, reference, and objects in the system 200. These can take the form of digital files in many formats such as PDF, Word, XLS, video or other file formats. The documents and attachments may be data objects in but not restricted to formats such as CSV, JSON, XML etc. or can be large binary objects of non-defined structure, commonly referred to as BLOBs.

In an implementation defined unit certificates, documents and attachments can be immutably recorded or fingerprinted using a distributed immutable ledger 202 or other means of maintaining the file state and its integrity or associated files and provenance either directly or indirectly via a stored Hash value of the object or the entire object itself.

In an implementation, the system 200 can be configured to comprise a Public Life Cycle Inventory (LCI) library 212. The Public LCI library is a digital library holding information about the procedures for assessing the environmental impacts associated with all the stages of the life cycle of a commercial product, process, or service. For instance, in the case of a manufactured product, environmental impacts are assessed from raw material extraction and processing (cradle), through the product’s manufacture (gate), to the distribution, use, and recycling or final disposal of the materials composing it (grave). These methodologies - for example, ISO 14000 series, GHG Protocol Product Standard, or PAS 2050 - can be used to generate a cradle-to-gate assessment of a good or service in order to claim a specific emissions profile resulting from a process on the system 200 platform. The methodologies are recorded into this library and can be made available to other platform users, for instance, to compel a change in behavior or help buyers find suppliers that conform to their organization’s own environmental needs and goals.

The Public LCI library 212 can be configured as a digital repository for the statements and supporting materials underpinning a claim of environmental impacts resulting from a process or Reference Units 209 or Defined Units 209. In an implementation, declarations and documents are associated with one or more Reference Units 208 or Defined Units 209. The documents can also serve as templates or supporting documentation for the environmental claims associated with Defined Units or processes and Defined Unit outcomes.

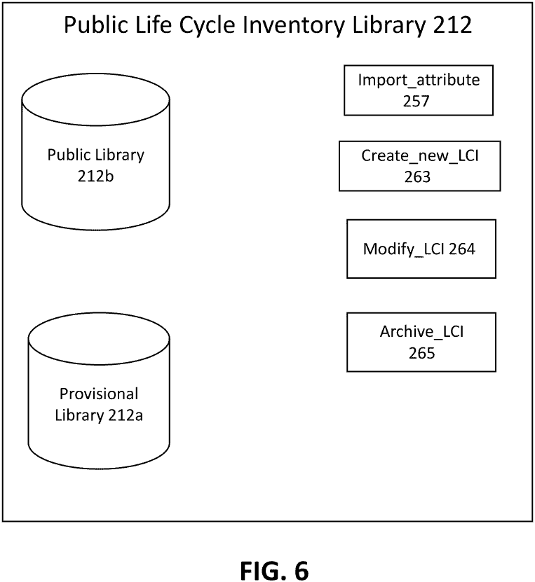

A logical flow and interface for objects for a Public LCI library 212 is shown in FIG. 6.

### Life Cycle Inventory

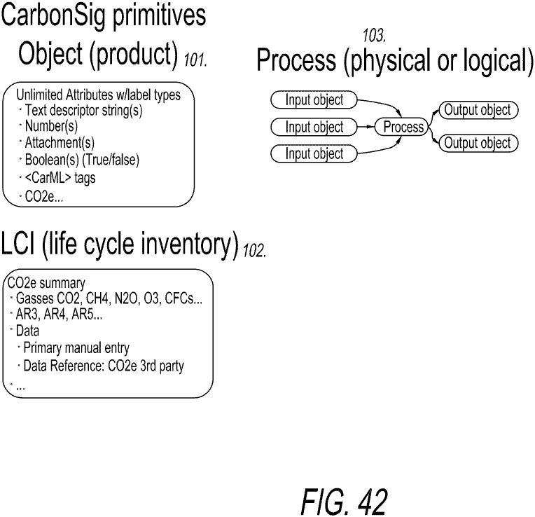

In an implementation, at block 263, an interface for the LCI library can comprise an operation to create a new life cycle inventory LCI. The system 200 can be configured to store the LCI in the LCI library 212, including attributes and uses for those not familiar. The Public LCI library 212 is configured to allow a user to provide emissions value per functional unit of measurement, and buffer measurement uncertainty values. All LCIs are stored in a public library 212b with publisher and versioning visible. In an implementation, the LCI library 212 can include a provisional LCI library 212a. The provisional LCI library 212b is configured to allow a user organization to create and store, for example, provisional or work in progress LCI refences. In an implementation provisional data can be forwarded to an approval entity to make the LCI reference “official.” Thus, a working reference can be public in a provisional state before being approved for use. An example of a LCI object is shown in FIG. 42, item 102.

In an implementation, at block 264, an interface for the LCI library can comprise an operation to modify an LCI from LCI library 212. The system 200 can be configured to log versioning inheritance. In an implementation, the system 200 can be configured to alert users using or storing associated LCI objects and LCI reference inputs to the modification. For example, LCI reference inputs associated with the LCI can be updated with the new, modified LCI object. When this occurs, any user having or using the object as described herein can be alerted to the change.

In an implementation, at block 265, an interface for the LCI library can comprise an operation to archive deprecated LCI objects in the LCI library 212. The archive operation deprecating the LCI can be configured to mark the LCI as unusable or archived. The system 200 can be configured to allow the archived and deprecated LCI to be visible for review only or view only. In an implementation, all reference inputs associated with the archived and depreciated LCI across the system 200 can be deprecated. The system 200 can be configured to alert users using or storing associated reference units associated with the LCI archive operation.

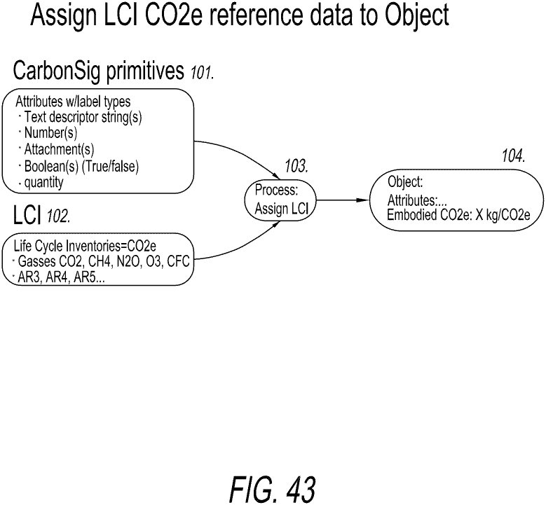

LCI object can be attached to Objects for the calculation of the GHG associated with the quantity of the object. This attachment process is shown in FIG. 43 and the derived calculations in the context of a process chain are shown in FIG. 44.

In an implementation, the system 200 can be configured to comprise a Public GHG Report interface 213. In an implementation, the Public GHG report interface 213 can include a searchable report database. In an implementation, some or all of the GHG report database can be searchable within the system 200, but not publicly searchable. Examples of use cases where this can be useful is the “listing” of available inventory defined unit certificates or products for potential sale in an online marketplace or the submittal of data associated with an RFP (request for proposal) in a bid process.

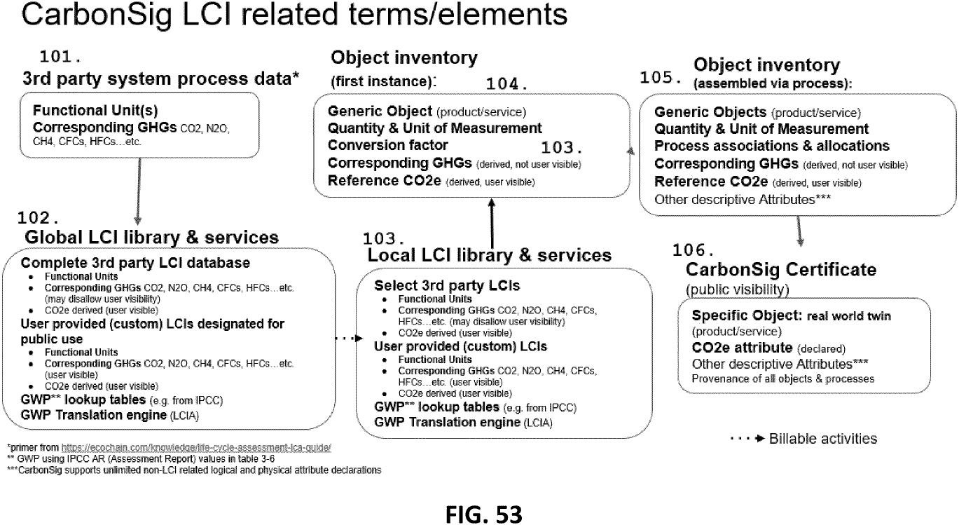

In an implementation, a GHG database comprises an updatable dataset that provides the Global Warming Potentials (GWP) for various gases to their CO2e based on future impact, for example, 20 year and 100-year impacts. As will be appreciated, the data sets for GWP potentials change over time, as the IPCC updates these on a periodic basis (every 2-3 years). With each revision, the system is configured to save and archive the previous GWP potentials. In an implementation, a reference entity tenant can generate public attribute objects, which then can have conversion factors maintained by the entity. (e.g.: 1_ton_of_CH4 20yr =83_CO2e). This GWP calculation is performed using LCI libraries and reference databases shown in FIG. 53, item 102. Third party data may be used in the system shown in FIG. 53, item 101.

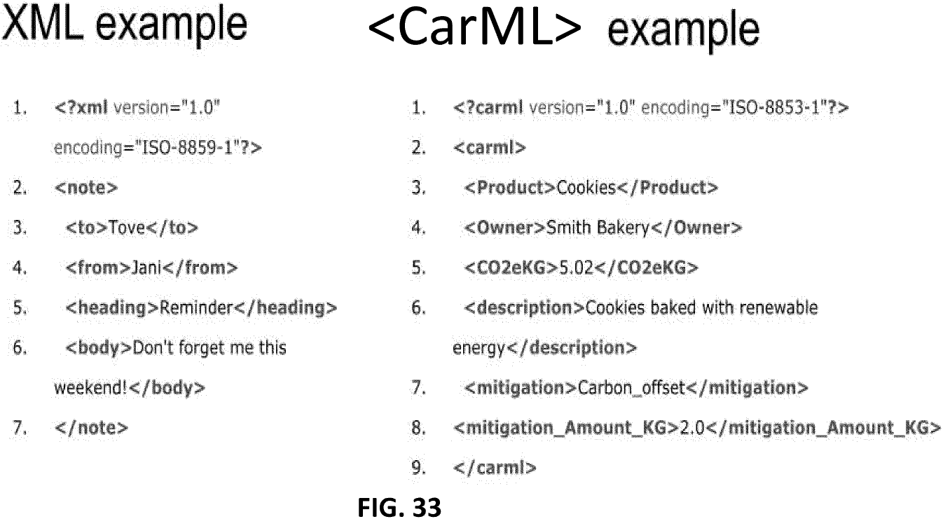

In an implementation, the system 200 can be configured to comprise a platform Service Bus 214. The platform Service Bus 214 can be integrated via an API to external systems and to system microservices using an extensible carbon language <CarML> or other methods. Operating between the logical layer and the representational layer, the platform Service Bus 214 can be configured to manage access to external digital information or requests for information from within the platform system 200. The communication between these mutually interacting software applications and the structure of data being transferred are formalized by the platform Service Bus 214 which may connect with third party external systems. The platform Service Bus 214 also processes error communications when interface requests are in error. An exemplary architecture for a platform Service Bus 214 is shown and described in more detail below in FIG. 33.

In an implementation, the system 200 can be configured to comprise a Display Manager UI 215. The Display Manager UI 215 can be configured to display information to a platform system 200 user via an internet browser or native application. The Display Manager UI 215 can also be configured to accept and store information input by the user to a storage and compute layer 201 for processing and recording. The Display Manager UI 215 is configured as the frontend of the software application interface for the platform.

In an implementation, the system 200 can be configured to comprise a Report Manager UI 216. The Report Manager UI 216 can be configured to display information specific to a Defined Unit, such as, for example, a concatenated history of process relationships and attributed environmental attributes, to be displayed via an internet browser or native application to a user. In an implementation, the Report Manager UI 216 can be configured for public report certificates acting as a system of record. In an implementation, the Report Manager UI 216 can be configured to format information sent from the backend of the system 200 so that it is presented to the public in a routine way, regardless of the type and number of processes shown. In an implementation, a machine-readable QR code can be associated with each Defined Unit so that a static URL address refers a request to the relevant data object.

The Report Manager UI 216 can also be configured to generate and express a full history of a product or service in terms of GHG and supply chain provenance as a structured data object certificate. This data object can be configured to be read by another system, printed out, or pushed to another system.

The Report Manager UI 216 can also be configured to support the acknowledgment and legal acceptance of the ownership and transfer of the rights to claim the environmental traits of a good or service. Thus, an end recipient can receive both the logical data associated with an environmental claim associated object as well as a legally recorded and recognized transfer for exclusive rights to use that environmental attribute claim in conjunction with the associated good or service.

In an implementation, the system 200 can be configured to comprise third-party read/write services and integrations 217. Third-party read/write services and integrations 217 includes third-party software that mutually interacts with the platform system software. The structure of data used by the third-party software can be mapped onto the data structure used by the platform system 200 through an integration. In this way, information is known to both applications.

In an implementation, the system Report Manager UI 549 can be configured to generate a Product/Service GHG Report certificate 218. An exemplary GHG report certificate is shown as user interface report certificate of FIGS. 12B-12C. The GHG Report certificate 218 is an assignable digital twin representation of the history of the GHG (greenhouse gasses) and mitigation efforts associated with a product or service over the life of its production. The Product/Service GHG Report 218 can be configured to be viewed as a summary on screen, a data object in structured format such as <CarML>, XML, JSON or as a physical printed artifact in PDF or another format. The GHG Report 218 has indicators describing the total GHG associated with a product or service at a known point in time.

The GHG Report 218 can also give indications or clues to the status of the report, for example, if it has been updated or can be subject to change. The GHG Report 218 can include the full attributes of a product or service including all of the attributes assigned and associated over the full production life of the product. The Product/Service GHG Report 218 can also be represented in a shorter form indicating a unique data set such as a URL, QR code, or SKU, which can be used to retrieve or confirm the entire data associated with the report.

In an implementation, the Product/Service GHG Report certificate 218 can be configured to be a digital twin system of record and may possibly be recognized as such from a legal or regulatory view to confirm the association, ownership and GHG liabilities or impacts associated with a good or service.

A full summary of the Product/Service GHG Report certificate 218 can be made available in a “physical printout” similar to type and object. The Product/Service GHG Report certificate 218 provides the full history and provenance of an object or defined unit CO2e and all of the preceding processes CO2e created from prior organizations or reference data.

In an implementation, the Product/Service GHG Report certificate 218 can be made publicly searchable on the platform.

A QR code and unique data/elements can be dynamically generated for the Product/Service GHG Report certificate 218 by the Report Manager 216. The output may be physical or digital. The digital output may be HTML, XML, JSON, or any machine-readable output. A status of the object and time stamp is shown (e.g.: active/transferred/pending etc.).

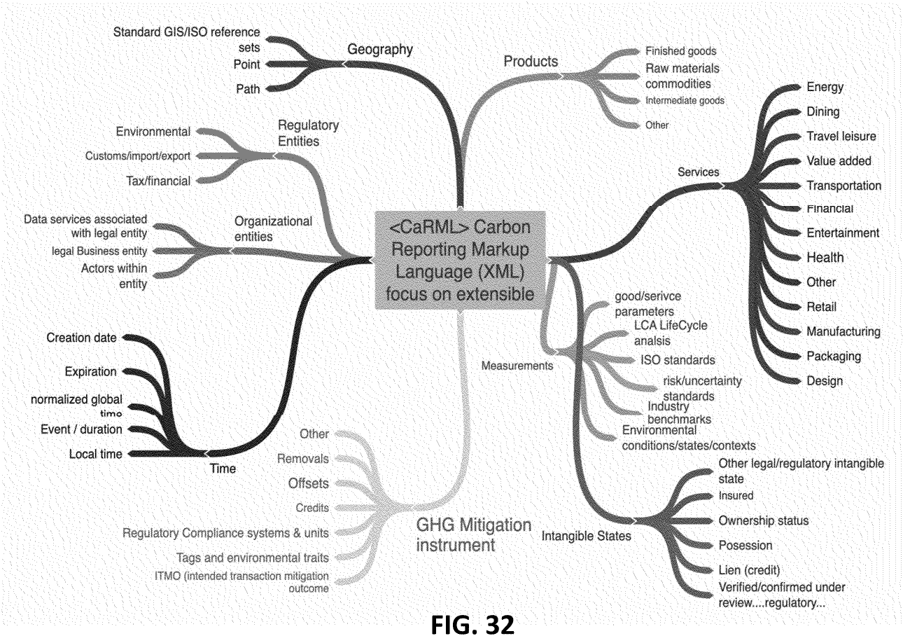

In an implementation, the system 200 can be configured to comprise a Carbon Reporting Markup Language <CarML> 219. The <CarML> 219 is a markup language and meta-schema that is extensible similar to XBRL. <CarML> and other extensible languages that are domain specific aid in structured communications between actors. Extensibility means a core set of common data elements can serve as collectively shared core framework for data sharing, while supporting local data structure term extensions for smaller groups of actors.

<CarML> 219 uses existing multiple reference schema and unique identifiers already in use by other actors where possible at its core to define and delineate in a structured way the actors, actions, objects, processes, and elements associated with tracking, reporting, recording, declaring, and transferring goods and services that have GHG associated with them. Extensibility of the language is a feature allowing multiple actors across domains to use a shared language for defining and describing the processes, products, and services they work with. <CarML> 219 is configured to put a carbon CO2e context around existing descriptive taxonomies as standard message types using <CarML> compliant tagged variables used in accounting, supply chains, process and other systems dealing with physical goods and services. An exemplary Carbon Markup Language <CarML> schema and coding is shown and described below in more detail with respect to FIGS. 32-38. Furthermore, data objects throughout this document are described with respect to <CarML> encoding.

In an implementation, the system 200 can be configured to comprise a Conversion library 220. The Conversion Library 220 can be configured as a private or public library. The Conversion Library 220 is configured to maintain a database of predefined ratios and mathematical relationships between local & globally recognized attributes. For example, the public library maintained by ISO (international standards organization) can include the global unit conversion of 2.204623 lbs = 1 KG. Global and local conversions can be published and maintained by entities. The Conversion Library can be configured to support the same versioning and updating mechanisms as the Attribute Library 210. Conversions can be contextually defined, for example, by industry practices, locality, or bespoke conventions. Conversions can also be globally accepted mathematical or algorithmic conversions.

In an implementation, the system is configured to provide a platform architecture and carbon object certificates for offering, transacting, tracking, attaching and retiring carbon instruments.

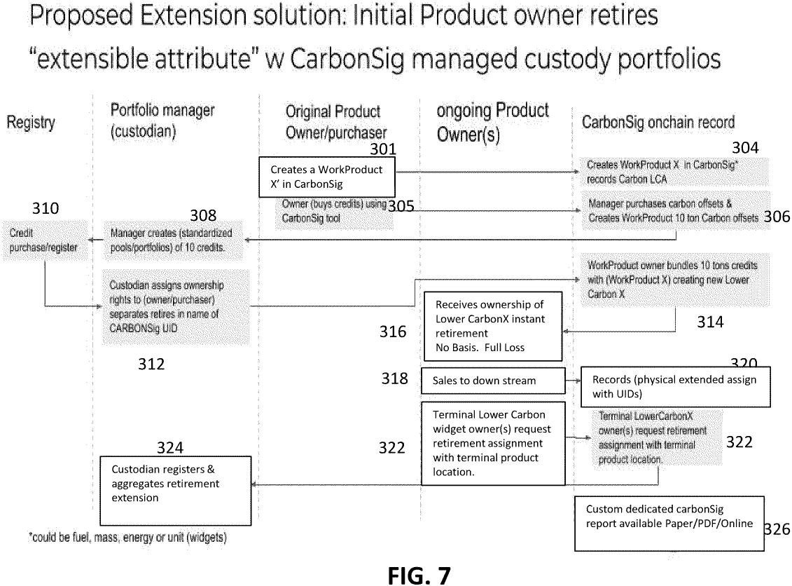

FIG. 7 shows an implementation of a system flow for tracking and exchanging carbon instruments. At block 301, a user generates a carbon object for a carbon financial instrument. In an implementation, the user can generate a process object 208 including a Defined Unit in the users Defined Unit inventory 209 as described above with respect to FIGS. 2-3. At block 304, the platform records the state of the carbon object Defined Unit to a transaction database, for example blockchain/DLT 202. At block 305, the user purchases x carbon credits, for example 10 carbon offsets, for example using the initiate transfer 232 operation to buy Defined Units from another tenant user’s Defined Unit Inventory 209 as described at FIG. 3. At block 306 the user generates a process object 208 including Defined Units for the x carbon offsets, which are recorded to the blockchain/DTL 202. At block 308, off the platform, a portfolio manager generates a standardized pool or portfolio of the x carbon credits. At block 310, the purchase of x carbon credits is recorded at a Registry. Then, at block 312, the portfolio manager assigns ownership rights to the product owner via user as recorded on the blockchain/DLT 202 to retire the carbon offset. At block 314, the user product owner that generated the carbon object bundles the x ton carbon credit with the carbon object, thus lowering the net declared embodied CO2e for that product. In an implantation, the process object 208. For example, the attach credit operation is configured to attach a credit to an object in the defined unit inventory and thereby reduce the net declared embodied CO2e of an object by embedding an environmental instrument as described herein, which is then recorded to the blockchain/DLT 202. At block 316, the new owner receives ownership of the carbon object with the lowered x tons of carbon. At block 318, when this owner makes a downstream sale of the carbon, at block 320 the system records the carbon transaction on the blockchain/DLT 202 in the same manner. This process then repeats until at block 322, the final owner of the carbon object requests a retirement along with giving the terminal location of the product or service associated with the carbon object. At block 322. the blockchain/DLT 202 records the retirement of the carbon object and its terminal location. At block 324, the custodian may register and aggregate the retirement extension for the product or service associated with the carbon object. At block 326, a user can then generate a report. The report can show the adjusted output CO2e of the object by the credited amount or the credit balance is carried along across processes with the object. This can be displayed and explicitly called out in a Public GHG Report certificate 213 and Product/Service GHG report certificate 218 or in Third-party read/write services and integrations 217. FIG. 48 shows an example of attaching a Carbon instrument object item 106 within the system to an object item 105 using an attach process item 107 to create a new object item 108 with a new derived data element, namely, the net declared CO2e.

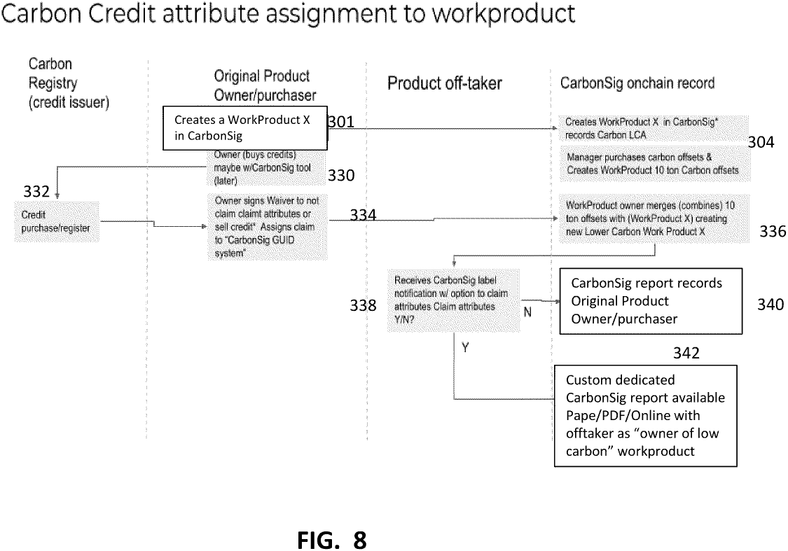

In an implementation, as shown at FIG. 8, at block 301, a user generates a carbon object for a carbon financial instrument. For example, the user generates a process object 208 including a Defined Unit in the users Defined Unit inventory 209 as described herein. At block 304, the platform records the carbon object to transaction database, for example blockchain/DLT 202 as a public system of record. At block 330, the user purchases x carbon credits, for example 10 carbon offsets, either on the platform or via a Registry. At block 332, the purchase of the x carbon credits is recorded at the Registry. At block 334, the owner of the product or service associated with the carbon object executes a waiver promising to not the claim the environmental carbon related attributes or sell the carbon credits and assigns the claim to the blockchain/DLT 202. At block 336, the user product owner that generated the carbon object bundles the x ton carbon credit with the carbon object, for example via the attach credit operation as described herein, thus lowering the carbon for that product. At block 338, a product off taker receives a label generated by the system for the product or service associated with the carbon object, which includes a notification with an option to claim the carbon attributes. If the user refuses, at block 340 a system report records the owner is still the original owner or most recent purchaser at the blockchain/DLT 202. If the off-taker accepts the option to claim the digital twin attributes, at block 342 the blockchain/DLT 202 records the transfer, and the report shows the off-taker as the owner of the product associated with the digital carbon object certificate including the net declared lowered carbon. [00190] FIGS. 9A-9B show a logical flow and data input models for a multiple input, single output interface. As shown in FIG. 9A, a process for a product can be broken down into multiple inputs to a process that outputs a single process for that output. For illustrative purposes, a recipe for chocolate chip cookies is given with the inputs as 3 cups flour, 2 eggs, 0.5 cups sugar, 1 stick of butter,1 cup of chocolate chip cookies, and 2500 btu of energy. Then, the baking process outputs 24 cookies. The system interface allows a user to establish or leverage a uniform packet including, inter alia, UoM data that can be standardized and concatenated across the entire system. For example, in simplified example as shown in Table 1, for each type (ruType: x) base units (baseUnit_) are given for expression, primitive measure, conversion and category.

TABLE 1

| | |
|---|---|
| 3 cups flour | ruType: flour baseUnitExpression: US cups baseUnitPrimative: kg baseUnitConversion: 0.14 baseunitCatergory: mass |
| 2 eggs | ruType; large white eggs / free-range / US midwest baseUnitExpression: eggs baseUnitPrimative: kg baseUnitConversion: 0.057 baseUnitCategory: mass |

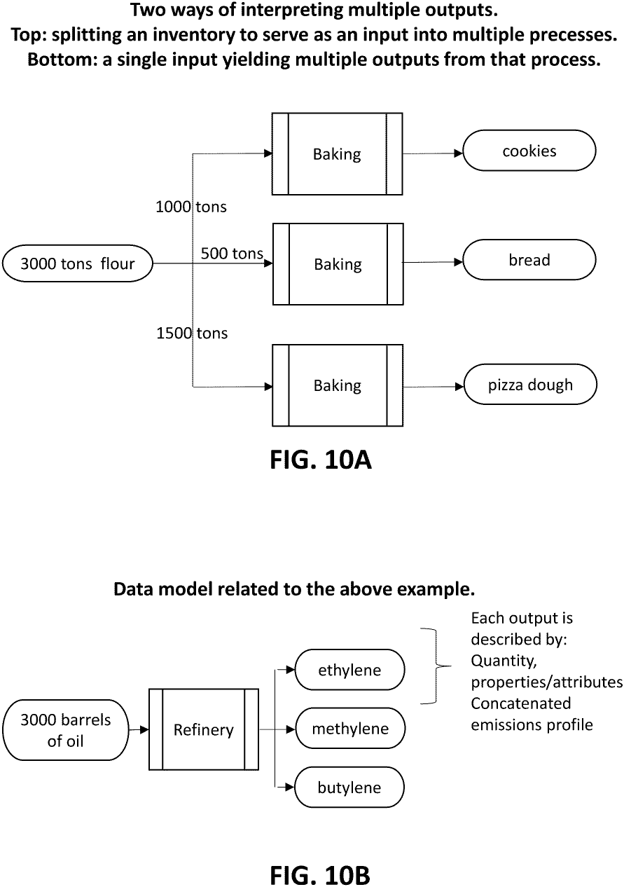

FIGS. 10A-10B show logical flows for a single input, multiple output interface. FIG. 10B shows the multiple outputs as a concatenated emissions profile, where each output can include quantity and attributes for a carbon object. For example, in FIG. 10A, 3000 tons of flour can be broken into 3 outputs of 1,000 ton, 500 tons, and 1,500 tons for baking processes that produce, respectively cookies, bread and pizza dough. As shown in FIG. 10B, for a completely different product, 3,000 barrels of oil are sent to a refining process, which breaks out into 3 outputs of ethylene, methylene, and butylene. As will be shown, the system interface and <CarML> base APIs provides an intuitive yet highly flexible technological ecosystem that is able to take any process and product and track inputs and outputs, origination, and digital twin ownership transfer across a life cycle, no matter how complex.

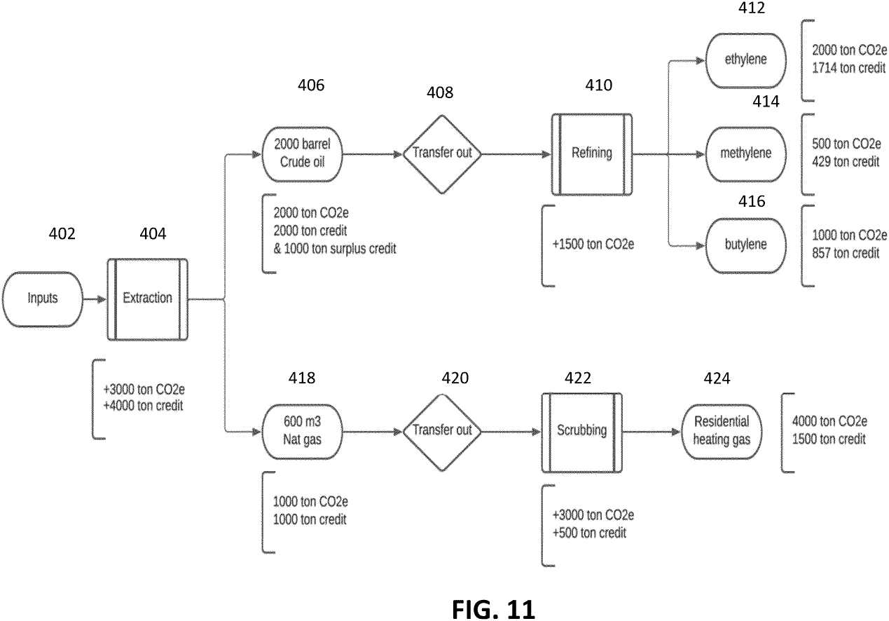

For example, FIG. 11 shows a logical flow for a branched network carbon object including multiple process outputs and certificate ownership transfers, including surplus credits and allocations. At block 402 the system receives a carbon object input. At block 404, the carbon object input records a process, in this example, an extraction process for extracting raw carbon energy products. The carbon object for the extraction records an addition of +3,000 tons of CO2e and an addition of a +4,000 tons carbon environmental attribute credit. At block 406, the carbon object for the extraction produces an input for a carbon object for 2,000 barrels of Crude Oil. The carbon object for the 2,000 barrels of crude oil records 2,000 tons of CO2e and a 2,000 ton credit as well as a 1000 ton surplus credit. At block 408, the 2,000 barrels of oil are transferred out for refining. At block 410, the refining process generates an input that adds +1,500 tons of CO2e to the carbon life cycle of the product. The refining then produces three carbon object outputs for corresponding products, each including the final carbon totals for each respective product. At block 412, the carbon object for ethylene produced from the refining has 2,000 tons of CO2e and a 1,714 ton credit. At block 414, the carbon object for methylene produced from the refining has 500 tons of CO2e and a 429 ton credit. At block 416, the carbon object for butylene produced from the refining has 1,000 tons of CO2e and an 857 ton credit.

At block 418, the carbon object for the extraction at block 404 outputs a carbon object for 600 m3 of natural gas. The carbon object for the 600 m3 natural gas records 1000 tons of CO2e and a 1,000 ton credit. At block 420, the 600 m3 natural gas are transferred out for scrubbing. At block 422, the scrubbing process generates an input that adds +3,000 tons of CO2e and adds a +500 ton carbon credit to the carbon life cycle of the product. At block 424, the scrubbing produces a carbon object output for residential heating gas, which as a carbon object total of 4,000 tons of CO2e and a 1,500 ton credit.

As will be appreciated, at each stage of the product life cycle, from the extraction of the raw natural resources to the final products, the carbon objects record and maintain an accurate and traceable record of the carbon inputs and outputs associated with each process and product produced.

The system is configured to allow a user to generate carbon objects for a single unit of production and/or product. As noted herein, many goods and services are consumed in smaller increments, such as a cup of coffee. The present disclosure implements a solution to assign and track environmental traits in small increments such as a nano credit (billionth of a metric) ton of CO2e. FIG. 12A and Table 2 show a carbon credit object for nano-piece carbon credits for hyper-targeted carbon credit management, report interfaces, and even improved packaging. As will be appreciated, carbon objects for nano-piece carbon credits can be employed to manage and report an accurate, verifiable GHG footprint EPD (environmental product) certificate digitally twinned down to a bag or even a cup of coffee. At block 450, a nano-credit of +1.0 kg of CO2e for growing the beans is added to the system. At block 451another nano-credit of + 1.0 kg of CO2e is added for milling and roasting, and at block 452, yet another+ 1.0 kg of CO2e is added for distribution of the milled and roasted coffee beans. At block 453, in conjunction with the distribution of the coffee beans, a carbon offset of 4.0 nano-credits is applied. At block 453, + 1.0 kg of CO2e is added for consumption. Accordingly, the system can allow a user to verify + 1.0 kg of CO2e is added to that the bag of coffee, from “farm to table” is a net declared carbon zero, or net declared carbon neutral product. For example, at block 455, the system can be configured to generate a QR-code that links to the verification certificate for the end CO2e for a product down to the nano-credit. As will be appreciated, the system can thus allow, for example, manufacturers and/or retailers to verify and market to carbon conscious customers net declared low carbon, net declared zero carbon, or even net declared negative carbon products. Similarly, carbon conscious consumers can readily identify the nano-credits for product verified to the system, allowing them to accurately measure and manage their own carbon footprint and diet.

The carbon life cycle and journey of each individual product at every stage, including activity at the point of consumption, can be accurately tracked and measured. For example, Table 2, shows a breakdown of the carbon consumption of Starbuck’s coffee products down to the gram of carbon, which can track and measured by implementing nano-credit carbon objects equal to 1 gm of carbon.

TABLE 2

Coffee

| | g/Co2e | $250 CO2°/ton | Restore |
|---|---|---|---|
| Latte | 550 | $0.1375 | $0.275 |
| Cappucino | 410 | $0.1025 | $0.205 |
| Flat White | 340 | $0.085 | $0.17 |
| Black | 21 | $0.0052 | $0.01 |

nano-credit= 1 gm of carbon
Starbucks 4 m cups/day=1,600 Ton/day=584,000 tons/yr
1 m ton/yrDAC disappears into 2bn cups of coffee.

Non-limiting exemplary advantages of the system configured for tracking nano-credits include the ability to generate and process the nano-credit level environmental instruments, which at kilogram scales are not divisible in conventional registries. Accordingly, small amounts such as 1 gram or 1 kWh (kilowatt-hour) can be assigned to and addressed by climate mitigation or abatement activity.

Examples for an industrial product becoming multiple smaller products are shown in FIG. 51 with the nano-credits representing 50,000 derivative objects from the original object.

Another non-limiting exemplary advantage is that instruments are not limited to those owned, transferred, and retired for claims or obligations by corporate entities. The system is configured to allows these entities to extend the assignment of carbon attributes to specific products and services. The carbon attributes then become embedded to the assigned goods and services themselves, and not by the entities, which allows ownership of the CO2e environmental attributes to be legally and publicly transferred across a value chain with these new traits tracked and traced with high environmental and accounting integrity. Thus, the carbon life cycle attributes of a product or process is independent of the various entities that implement a processes and product and generate the carbon and/or carbon offsets. An example of a Carbon Attribute is a renewable energy credit which could be assigned and associated with an object as supporting evidence of net declared low carbon. This is shown in FIG. 51, item 101 a renewable energy certificate is logically linked with item 102 an object representing electricity with a declared carbon intensity of 2 Mt of CO2e.

The system can be configured for confirmation of a product or process state/status against a carbon registry. The system can also be configured for confirmation of a product or process state/status an external registry and waivers therefrom.

FIG. 12B shows an example of a Carbon Chain-of-Custody GHG report. At block 460, the report includes an identification of the entity for whom the system generates the twinned report certificate, the product (a Lot Number for oil) a time of generation, and QR code for the report. At each stage of the life cycle of the product, a life cycle analysis is provided showing the carbon input and/or carbon offset associated with that stage of value added process. For example, at block 461, the report shows that during a steam cracking process the carbon object recorded 5,345,336 kg of carbon dioxide equivalent to which 7,691,121 kg CO2e was added. The measured emissions data includes propylene at 1.44 kg CO2e/kg for and ethylene 1.44 kg CO2e/kg, attested to by Occidental Chemicals. The processes employed for each are also given for each of the propylene and ethylene. Then at block 462, the report shows the carbon and carbon added for a Haber-Bosch process along with the measured emissions data and processes for ammonia, by Occidental Chemicals. The report also shows the life cycle analysis (LCA) is third party verified by the Ammonia Manufacturers Association.

At block 463, the report shows a naphtha refining process. The naphtha refining is broken down into Naphtha from light sweet crude oil and naphtha from medium sweet, with the processes and carbon measurements for each. The naphtha from light sweet crude oil is blended and is broken down further into different pumps with the respective carbon measurements for each pump. The report also shows the naphtha from light sweet crude oil is by Occidental Ltd, and the and naphtha from medium sweet is by Chesapeake Organization, LLC. The report also shows that the life cycle analysis (LCA) is third party verified by specific International Standards Organization (ISO) standards for the measurements (e.g., ISO 14440, ISO 14444). At block 464, the report shows a 1,500,000 kg CO2e offset for the naphtha refining is obtained from the OMNIA N2O Abatement Project, which was retired by Occidental Ltd. Then, at block 465, the report verifies that another 500,000 Kg CO2e offset from Niokolo Koba REDD.

FIG. 12C shows an immutable carbon intensity report (CI) certificate for CI signatures that are chained together. In the report, the system is configured to verify CI work product created, for example, CO2e reduced with offsets. The system is also configured to allow a user to link and verify electronic documents, including verified and cryptographically secured and signed documents, immutable ledger declarations, carbon standards (e.g., ISO, CARB, EU), and CI facts and risks. The report encodes a chain of digitally twinned environmental claims and attributes ownership custody, which the system and interfaces as described herein track for each product and process to the nano-credit for every entity in the life cycle.

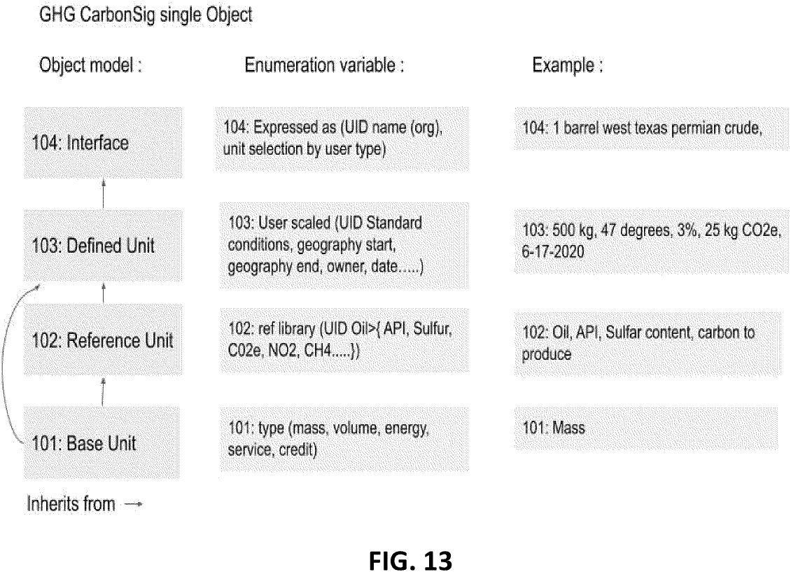

FIG. 13 shows an example of an object model for a single carbon object. As described herein, the carbon object enables the system to track the carbon products and processes throughout the carbon life cycle.

An object representing a product or service is defined by adding dimensions or and attributes that describe the object. At block 101, a carbon object Base Unit encodes an attribute, for example, mass, energy, volume, service, credit, and so on. At block 102, a Reference Unit carbon object encodes a Reference Unit, which encodes attributes such as product UID, chemical or material composition, or API call or reference. Reference Units can be created, processed, and stored at a Reference Unit library 208 as described with respect to FIG. 4. At block 103, a Defined Unit carbon object encodes a Defined Unit, which encodes attributes such as UID, standard conditions, geography, and so on. Defined Units can be created, processed, and stored at a Defined Unit library 208 as described with respect to FIG. 3. At block 104, the system is configured to ingest or output the carbon object attributes from the Base Unit, Defined Unit, and Base Unit linked and encoded to the carbon object as a single GHG object, along with user owner identification attributes such as the owner organization UID, and unit selections by user.

As described herein, Base Units, Reference Units, and Defined Units include attributes, which can be created and stored at an Attribute Library as described with respect to FIG. 5. As shown in FIG. 13, a GHG single carbon object consistently encodes attributes for a Base Unit, a Reference Unit, and Defined Unit that advantageously leverage the extensible markup language structure, which starts with the most basic element and is defined extended to specific attributes of a specific real-world good or service as a digital twin. The system is also configured to leverage the database and interface architecture to determine if the GHG carbon object is in inventory, has been, or can be consumed in a process. One of the attributes that is added to and tracked with a carbon object is the GHG equivalent CO2e that is related to the receiving, creating, or processing of the good or service. Table 3 is a non-limiting example of a general taxonomy for a carbon object.

TABLE 3

| Base unit: A | Reference unit: | Defined Unit: | Possible Action or states: |
|---|---|---|---|
| primitive non-dimensional trait | A defined base unit extension to incorporate the environmental impact of a given production pathway: Reference unit likely also have a “reference or specification sheet (ISO declaration)” identifying all of given or | a specific description | In transit, awaiting confirmation, consumed, in escrow, owned, possessed... |
| | anticipated traits that are “given” if not updated via additional base or reference units. | | |
| These are likely fixed and may reference other base units from a table (reference library) | Each reference unit type links to 1 or more base units which is either in a look up table or enumerated by a user from a reference library. | . the specific dimension to a physical product or service which can be owned or possessed by an entity | The states or actions ideally pre-defined for each of defined units. Linked to the reference unit. Typically, a user dimensionalized a reference unit from a template library and then adds to their inventory. Examples 50 barrels of oil. |
| mass | Kilogram, bushel, crate.... | An integer (5, 6, 7, etc.) | Boolean/ Full or partial representing loss/gain |
| volume | Some mass/ some volume | integer | Conditions standard/non-standard |
| loss/gain | mass/ energy | Integer | Attributed / non attributed |
| density | mass/unit of volume (describe) | | temp/pressure etc. state attributes |
| Location Site specific | Location maps | String: left shelf, warehouse 3 etc. | |
| Location | Long, latitude | Down to arc | Current, last, next |
| geographic coordinates | and/or GDN, | second | |
| Location map | map (address, city, street, post code, | | Current, last, next |
| Location Path | Location to location, either geographic coordinates or location map | Recognized coordinates of map elements, or pull-down site specific (tank #1 to tank #27 | Completed, expected. |
| pressure | Atmosphere, pascals | integer | Increase or decrease |
| Energy | Kwh, Mwh, joules.... | integer | Volt, amps, etc. |
| temperature | centigrade | 32 degrees | |
| time | Start, end, midpoint | 12:00.00.00 Zulu | Completed, expected |
| duration | Hours, minutes, days, months, years | 12 hours, | Completed, expected |
| ownership | Legal, physical possession | String name of legal entity, authority | Current, expected |
| Unit (named) | Box of cookies, widget, pallet, container, ship etc.....tbd (string) | integer | Divisible or not divisible |
| Identifying element | SKU, Purchase order, UPC code.... | String | UID (assumed source is “declaring entity/source” service) |
| Name (trait) | Product, any | string | Public, private |
| | descriptor....attac hed to another attribute | | |
| note | note | string | Private, public |
| Additional elements created and defined by user | Defined by user | String, int | Private, public |

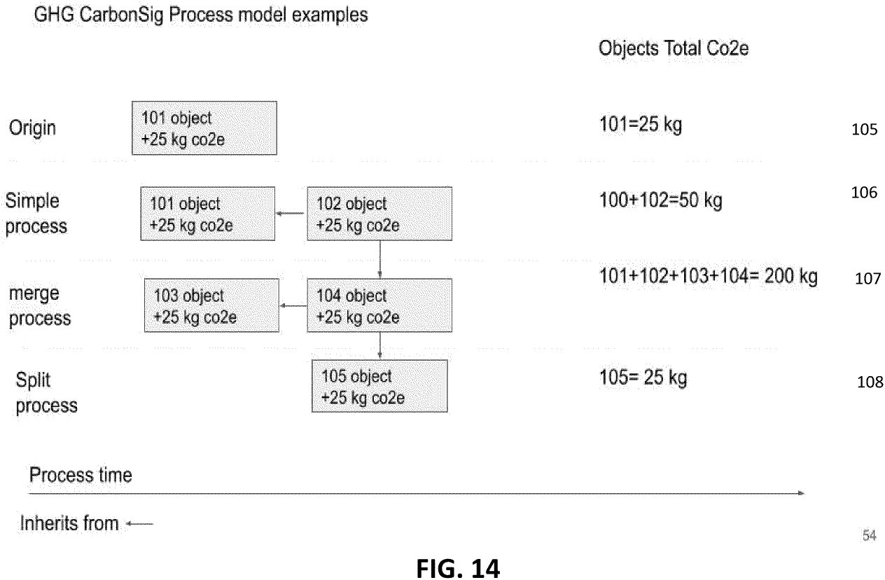

FIG. 14 shows a simplified logical flow and GHG process model for a simple carbon accounting and value add for a product or service employing carbon objects as shown in FIG. 11. At block 105, a carbon object encodes 25 kg of carbon dioxide equivalent. At block 106, in a simple addition, a second carbon object encodes 25 kg of carbon dioxide, and the system adds the first carbon object CO2e to the second carbon object CO2e to record a total of 50 kg of CO2e. At block 107, in a merge process, the system then merges a third carbon object encoding 25 kg of CO2e and a fourth carbon object encoding 25 kg of CO2e with the carbon object recording 50 kg of CO2e from block 106, thus encoding 200 kg of CO2e for the GHG life cycle with any associated certificates and instruments. Then, at block 108, a spilt process breaks out a 25 kg carbon object recording 200 kg of CO2e from block 106.

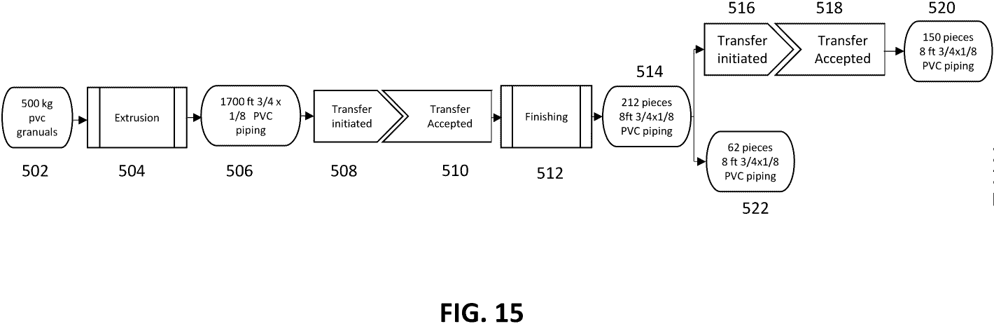

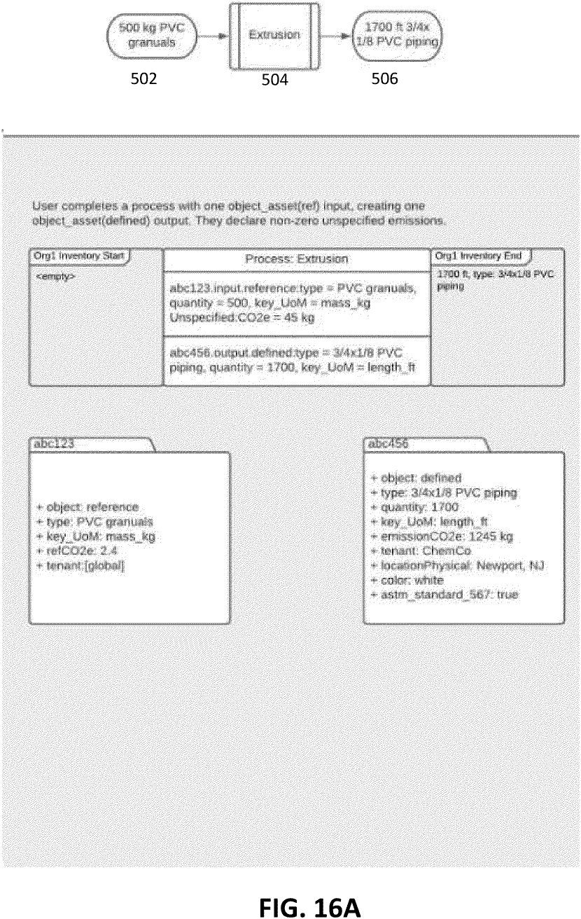

For example, FIG. 15 shows an example of a network map of objects and processes for a carbon life cycle for producing PVC piping. At block 502, the network starts with the first carbon for object, 500 kg of PVC granules. At 504, a process carbon object for extrusion shows an extrusion for the 500 kg of PVC granules into PVC piping. At block 506, a carbon object shows 1700 ft of ¾ × ⅛ PVC piping produced by extrusion. At block 508, a carbon object certificate shows the initiation of an ownership transfer of the PVC piping certificate, and at block 510, a carbon object shows the acceptance of the certificate ownership transfer. At block 512, a carbon object shows a finishing process for the PCV piping. At block 514, a carbon object shows an output of 212 pieces of finished ¾ × ⅛ PVC piping. At block 516, a carbon object shows the initiation of a transfer of 150 pieces of the 212 pieces of PVC piping, and at block 518, a carbon object certificate shows the acceptance of the transfer. At block 520 a carbon object records the 150 pieces of PVC piping accepted at the transfer. At block 522, a carbon object records the remaining 62 pieces of the 212 pieces of PVC piping in the user’s inventory.

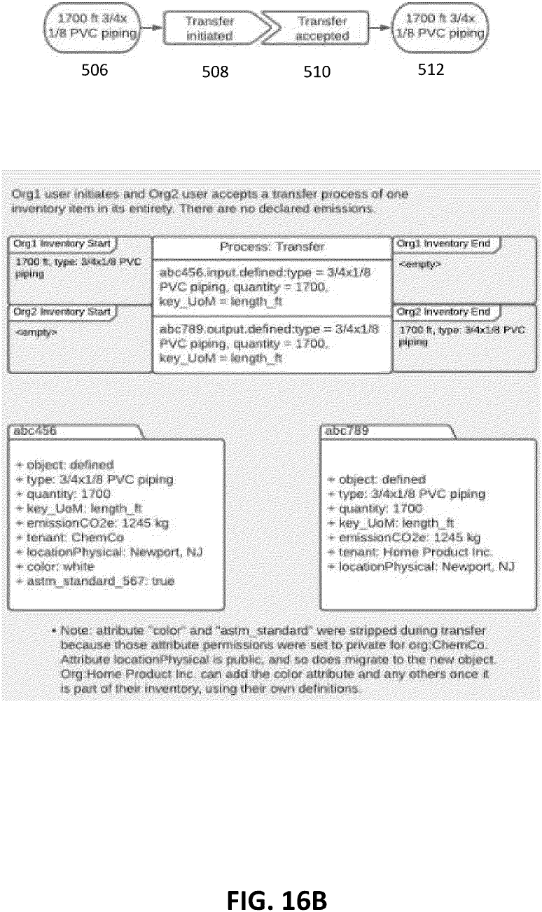

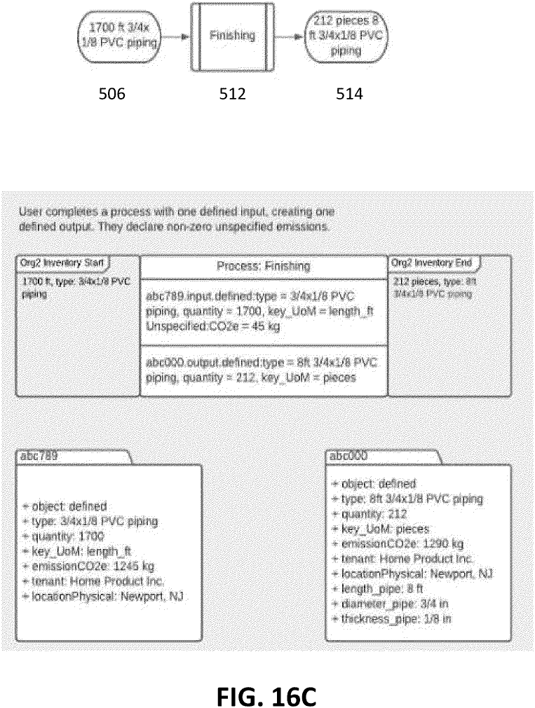

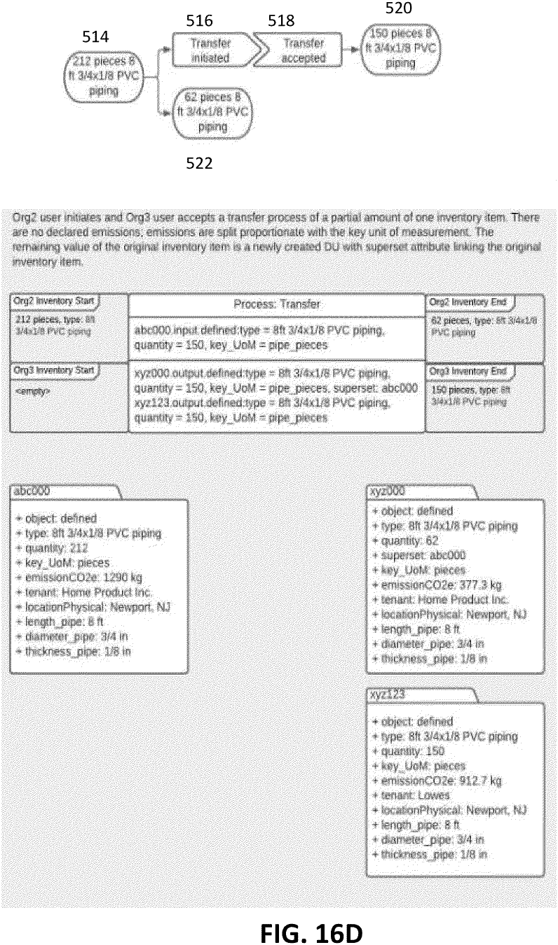

FIGS. 16A-16D and Tables 5-6 show carbon object encoding details for, inter alia, UoM, carbon related emissions, certificates, tenant and certificate ownership transfer processes as shown in FIG. 15. At block 502, the network starts with the first CO2e for object, 500 kg of PVC granules. A carbon object includes the data encoded in Table 4, which shows an empty Org1: Inventory Start object:

TABLE 4

| | | |
|---|---|---|
| Org1 inventory Start | Process: Extrusion | Org1 inventory End |
| <empty> | abc123.input.reference:type = PVC granuals Quantity = 500, key_UoM = mass_kg Unspecified:C02e = 45 kg | 1700 ft, type: ¾×⅛ PVC piping |
| | abc456.output.defined:type = ¾×⅛ PVC piping, quantity = 1700, key_UoM = length_ft | |

At 504, a process carbon object for extrusion shows an extrusion for the 500 kg of PVC granules into PVC piping. The carbon object encodes for the extrusion process:

TABLE 5

Process: Extrusion
abc123,.input.reference:type = PVC granuals Quantity = 500, key_UoM = mass_kg Unspecified:CO2e = 45 kg
abc456.output.defined:type = ¾×⅛ PVC piping, quantity = 1700, key_UoM = length_ft

At block 506, a carbon object shows 1700 ft of ¾ × ⅛ PVC piping produced by the extrusion:

TABLE 6

Org1 inventory End
1700 ft, type: ¾×⅛PVC piping

As shown in FIG. 16A, and Tables 4-6, above a system user is able to process, with a single carbon object reference input, as single carbon object defined output. The process also encodes for each entity, non-zero unspecified emission. As shown in Tables 7-8, each entity also has an interface, here showing a reference object for the PVC granules for entity abc123 a defined object for the PVC piping for entity abc456 for the respective input and outputs employed in the extrusion process.

TABLE 7

abc123

| | | |
|---|---|---|
| + | object: | reference |
| + | type: | PVC granuals |
| + | key UoM: | mass kg |
| + | refCO2e: | 2.4 |
| + | tenant: | [global] |

TABLE 8

abc456

| | | |
|---|---|---|
| + | object: | defined |
| + | type: | ¾x⅛PVC piping |
| + | quantity: | 1700 |
| + | key UoM: | length ft |
| + | emissionCO2e: | 1245 kg |
| + | tenant: | ChemCo |
| + | locationPhysical: | Newport, NJ |
| + | color | white |
| + | astm_standard_567: | true |

At block 508, a carbon object shows the initiation of a transfer of the PVC piping, and at block 510, a carbon object shows the acceptance of the transfer. As shown in FIG. 16B and Tables 9-10, the system allows a user organization to initiate a transfer process from one carbon object for an entire inventory item, shown as the 1700 ft of ¾ x ⅛ PVC.

TABLE 9

| | | |
|---|---|---|
| Org1 inventory Start | Process: Transfer | Org1 inventory End |
| 1700 ft, type: ¾×⅛ PVC piping | abc456.input.reference:type = ¾×⅛ PVC piping, quantity = 1700, key_UoM = length_ft | <empty> |
| Org2 inventory Start | abc789.output.defined:type = ¾×⅛ PVC piping, quantity = 1700, key_UoM = length_ft | Org2 inventory End |
| <empty> | | 1700 ft, type:¾×⅛ piping |

TABLE 10

abc456

| | | |
|---|---|---|
| + | object: | defined |
| + | type: | ¾×⅛ PVC piping |
| + | quantity: | 1700 |
| + | key UoM: | length_ft |
| + | emissionCO2e: | 1245 kg |
| + | tenant: | ChemCo |
| + | locationPhysical: | Newport, NJ |
| + | color: | white |
| + | astm_standard_567 | true |

abc789

| | | |
|---|---|---|
| + | object: | defined |
| + | type: | ¾×⅛ PVC piping |
| + | quantity: | 1700 |
| + | key UoM: | length_ft |
| + | emissionCO2e: | 1245 kg |
| + | tenant: | Home Product inc. |
| + | locationPhysical: | Newport, NJ |

It will be noted that the defined unit carbon object for the first organization abc456 encoded attribute fields for an ASTM standard and color. The resulting defined unit carbon object does not include these attributes. This is because the interface, as described herein, allows users to set libraries to public or private. As such, during the process, when a user transfers a carbon object from a public library inventory to a private inventory library, the system strips the attributes linked to the user ‘s private library, here the transferee. The user with the private library can use the system interfaces to define their own attributes once it is part of their inventory using the system interfaces as described above.

FIG. 16C and Tables 11-13 show the details of carbon objects for the finishing process. At block 512, a carbon object shows a finishing process for the PCV piping. At block 514, a carbon object shows an output of 212 pieces of finished ¾ × ⅛ PVC piping. As shown in Table 11, the carbon object encodes the input to be consumed and the output attributes for an organization’s abc 789 finishing process for producing an output of the 212 pieces of finished PVC piping, including an unspecified CO2e carbon of 45 kg.

TABLE 11

| | | |
|---|---|---|
| Org2 inventory Start | Process: Finishing | Org2 inventory End |
| 1700 ft, type: ¾×⅛ PVC piping | abc789,input,defined:type = ¾×⅛PVC piping, quantity = 1700, key_UoM = length_ft Unspecified:CO2e = 45 kg | 212 pieces, type: 8 ft ¾×⅛ PVC piping |
| | abc000.output.defined:type = 8 ft ¾×⅛ PVC piping, quantity = 212, key_UoM = pieces | |

As shown in Tables 12-13, the entity also has an interface, here showing a direct object for the input the PVC piping and direct object for output 212 pieces for the finishing process. Thus, the user can use the interface to complete a process with one defined input consumed and one defined output.

TABLE 12

abc789

| | | |
|---|---|---|
| + | object: | defined |
| + | type: | ¾×⅛ PVC piping |
| + | quantity: | 212 |
| + | key_UOM: | length_ft |
| + | emissionCO2e: | 1245 kg |
| + | tenant: | Home Product Inc. |
| + | locationPhyscial: | Newport, NJ |

TABLE 13

abc000

| | | |
|---|---|---|
| + | object: | defined |
| + | type: | 8 ft ¾×⅛ PVC piping |
| + | quantity: | 212 |
| + | key_UOM: | pieces |
| + | emissionCO2e: | 1290 kg |
| + | tenant: | Home Product Inc. |
| + | locationPhyscial: | Newport, NJ |
| + | length pipe: | 8 ft |
| + | diameter pipe | ¾ in |
| + | thickness pipe: | ⅛ in. |

FIG. 16D and Tables 14-17 show the details of carbon object certificates for an ownership transfer from one organization to another. At block 514, a carbon object shows an output of 212 pieces of finished ¾ × ⅛ PVC piping. At block 516, a carbon object shows the initiation of a transfer of 150 pieces of the 212 pieces of PVC piping, and at block 518, a carbon object shows the acceptance of the ownership transfer. As shown in Table 14, the systems carbon objects capture the change in the transferring entity’s inventory, the transfer profess, and the transferee user’s inventory

TABLE 14

| Org2 inventory Start | Process: Transfer | Org2 inventory End |
|---|---|---|
| 212 pieces, type: 8 ft ¾×⅛ PVC piping | abc000.input.reference:type= 8 ft ¾×⅛PVC piping,,quantity = 150, key_UoM = pipe_pieces | 62 pieces, type: 8 ft ¾×⅛ PVC piping |
| Org3 inventory Start | | Org3 inventory End |
| <empty> | xyz000,outuput.defined:type = 8 ft ¾×⅛ PVC piping, quantity = 150, key_UoM = pipe_pieces, superset: abc000 xyz123.output.defined:type = 8 ft ¾×⅛ PVC piping, quantity = 150, key_UoM = pipe_pieces | 150 pieces, type: 8 ft ¾×⅛ PVC piping |

As shown above in Table 14 and FIG. 16D, at block 520 a carbon object records the 150 pieces of PVC piping accepted at the transfer. At block 522, a carbon object records the remaining 62 pieces of the 212 pieces of PVC piping in inventory. As shown in Tables 15-17, three defined objects capture the ownership transfer between the two entities: two for transferor abc000 /xyz00 and one for transferee xyz123.

TABLE 15

abc000

| | | |
|---|---|---|
| + | object: | defined |
| + | type: | 8 ft ¾×⅛ PVC piping |
| + | quantity: | 212 |
| + | key_UoM: | pieces |
| + | emissionCO2e: | 1290 kg |
| + | tenant: | Home Product Inc. |
| + | locationPhysical: | Newport, NJ |
| + | length_pipe: | ¾ in |
| + | thickness_pipe: | ⅛ in |

TABLE 16

xyz000

| | | |
|---|---|---|
| + | object: | defined |
| + | type: | 8 ft ¾×⅛ PVC piping |
| + | quantity: | 62 |
| + | superset: | abc000 |
| + | key_UoM: | pieces |
| + | emissionCO2e: | 377.3 kg |
| + | tenant: | Home Product Inc. |
| + | locationPhysical: | Newport, NJ |
| + | length_pipe: | 8 ft |
| + | diameter_pipe: | ¾ in |
| + | thickness_pipe: | ⅛ in |

TABLE 17

xyz123

| | | |
|---|---|---|
| + | object: | defined |
| + | type: | 8 ft ¾×⅛ PVC piping |
| + | quantity: | 150 |
| + | key_UoM: | pieces |
| + | emissionCO2e: | 912.7 kg |
| + | tenant: | Lowes |
| + | locationPhysical: | Newport, NJ |
| + | length_pipe: | 8 ft |
| + | diameter_pipe: | ¾ in |
| + | thickness_pipe: | ⅛ in |

As shown above in FIG. 16D and Tables 14-17, when the transferring organization user transfers a partial amount of the single inventory item, there are no declared emissions for the transfer. Emissions are split in proper proportion with the transferee organization. In an embodiment, the system generates a new Defined Unit object for the remaining value of the inventory item for the transferring company and links the new Defined Unit object with a superset attribute to the original inventory item.

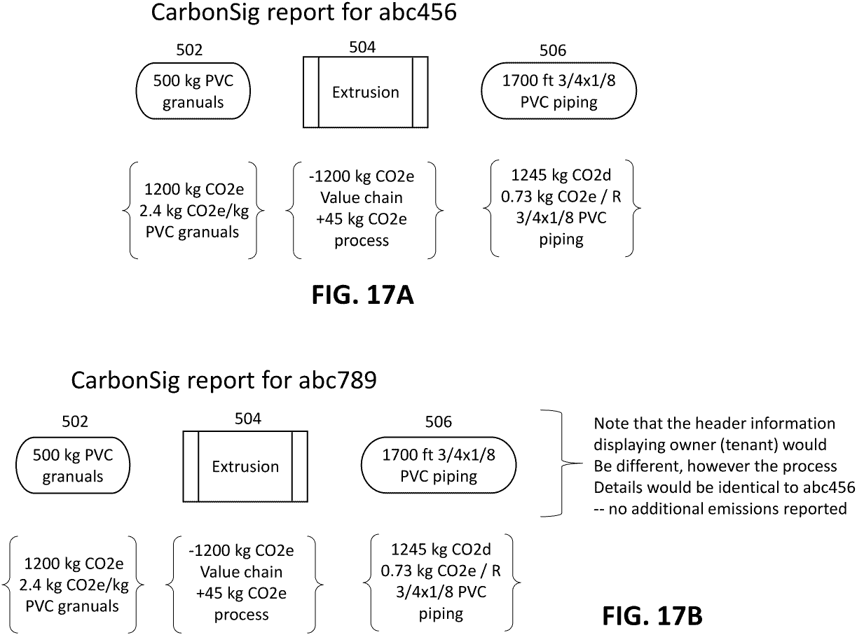

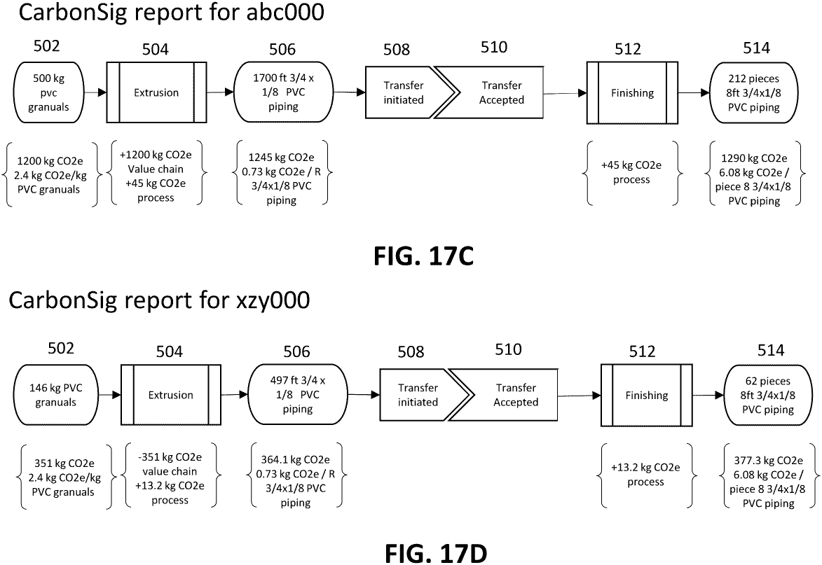

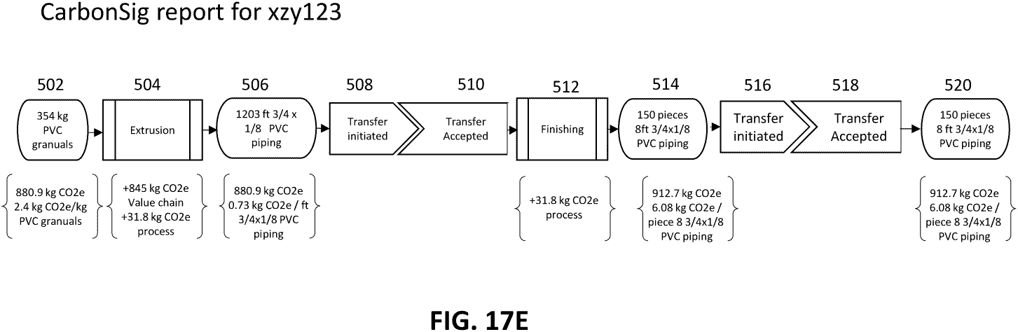

The system is configured to generate reports for carbon objects. FIGS. 17A-17E show examples of GHG reports for the carbon objects of FIGS. 15-16D and Tables 3-17. As shown in FIG. 15, because the system employs structured carbon objects that encode, inter alia, tenant organizations and CO2e for each component input and output for every process the life cycle of materials and manufactures, a highly accurate report and certificate can identify the carbon footprint of every organization from end-to-end.

For example, FIG. 17A shows an example of a carbon report for an organization abc456, who executes the extrusion at block 504. As the defined unit carbon object for extrusion shown in Tables 3-4 is for the defined unit of abc456, the carbon report for abc456 records the carbon values for abc456 for the reference carbon object encoded input object, 500 kg of PVC granules from block 502 and the process output type defined unit carbon object for extrusion of the 500 kg of PVC granules into PVC piping at block 504 to block 506. In particular, the value chain for abc456 carbon includes the 1,200 kg of CO2e for the PVC granules at block 502 and adds 45 kg of CO2e for the extrusion process at block 504. Thus, the output for abc456 at block 506 is 1,245 Kg CO2e. and the carbon object shows 1,700 ft of ¾ × ⅛ PVC piping produced by the extrusion.

FIG. 17B shows a carbon report certificate for organization abc789. As shown in blocks 508-510 and FIG. 16B and Tables 9-10, the system allowed user organization abc456 to add the carbon object for an entire inventory item -1,700 ft of ¾ × ⅛ PVC -- to organization abc789. As such at FIG. 17B the carbon report certificate for organization abc 789 is the same as that for organization abc456 as no additional emissions are recorded for the transfer. Thus, only the header information for the tenant changes to reflect the change of ownership.

FIG. 17C shows the carbon report generated from the defined object for organization abc000, which adds the 45 kg CO2e of carbon from the finishing process at block 512. As shown in Table 11, the carbon object encodes the input and the output attributes for an organization’s abc789 finishing process for producing an output of the 212 pieces of finished PVC piping, including an unspecified CO2e carbon of 45 kg.

FIG. 17D shows a carbon report for organization xyz000. As 150 pieces of the finished piping was transferred from organization abc000/xyz000 at blocks 516-514 and block 522, the organization was left with 62 pieces of piping, as shown in Tables 14 and 16. The system records 377.3 kg of CO2e, reflecting 13.2 kg of CO2e from the 45 kg of CO2e added at block 512, as shown in the direct object for xzy000 at Table 16 that was generated for the transfer.

FIG. 17E shows the carbon report for organization xyz123, which includes the defined object for the organization shown at Table 17 for the transfer of 150 pieces of pipe from organization abc000/xyz000 to organization xyz123 at blocks 514-520. The report shows the 912.7 kg of CO2e emissions carried over with the 150 pieces of PVC piping.

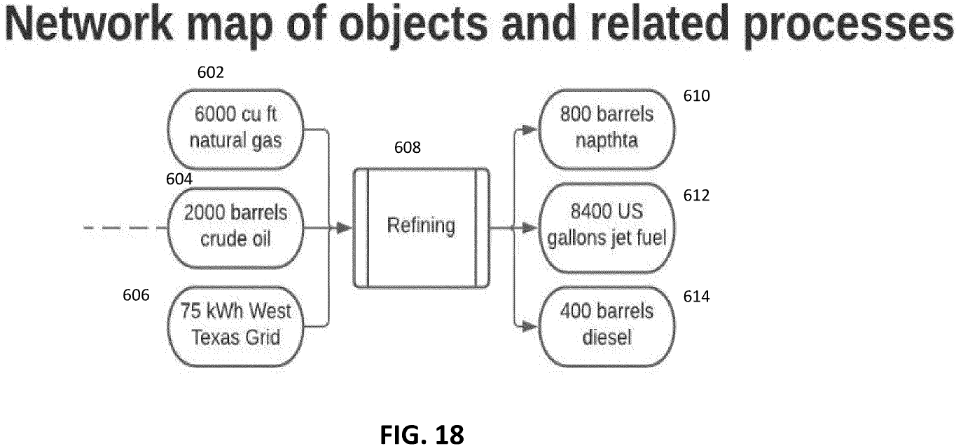

FIG. 18 shows an exemplary flow a network map for carbon objects a multiple input, multiple output (MIMO) process. FIG. 18 and Table 18 shows a directed graph packet for the carbon object inputs and outputs for the system. The example of FIG. 18 shows a network map of objects and processes for refining oil and natural gas. At block 602, the network starts with an input of 6000 cubic feet of natural gas. At 604, the network shows an input of 2000 barrels of crude oil. At block 606, a carbon object shows an energy application of 75 Kilowatt hours from the West Texas Grid. At block 608, a refining process is applied to the inputs of gas, oil, and the energy. At block 610, the refining outputs 800 barrels of naphtha. At block 612, the refining process also outputs 8,400 gallons of jet fuel. At block 614, the refining process outputs 400 barrels of diesel.

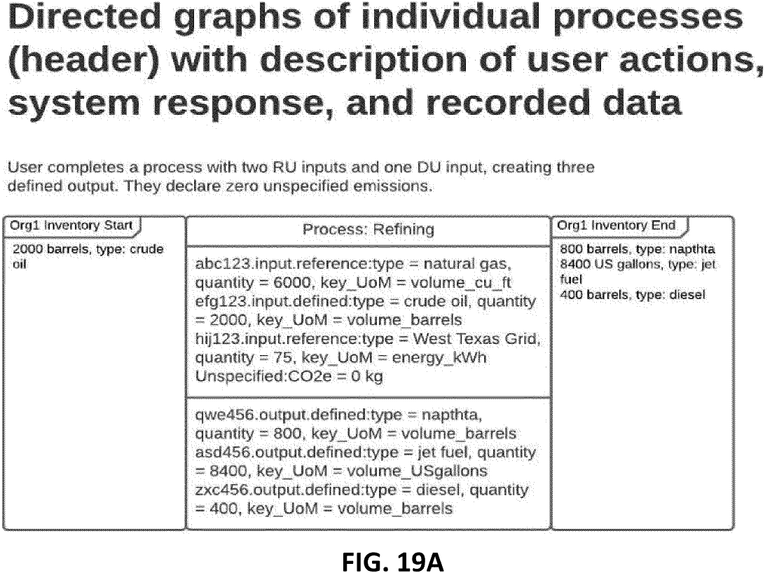

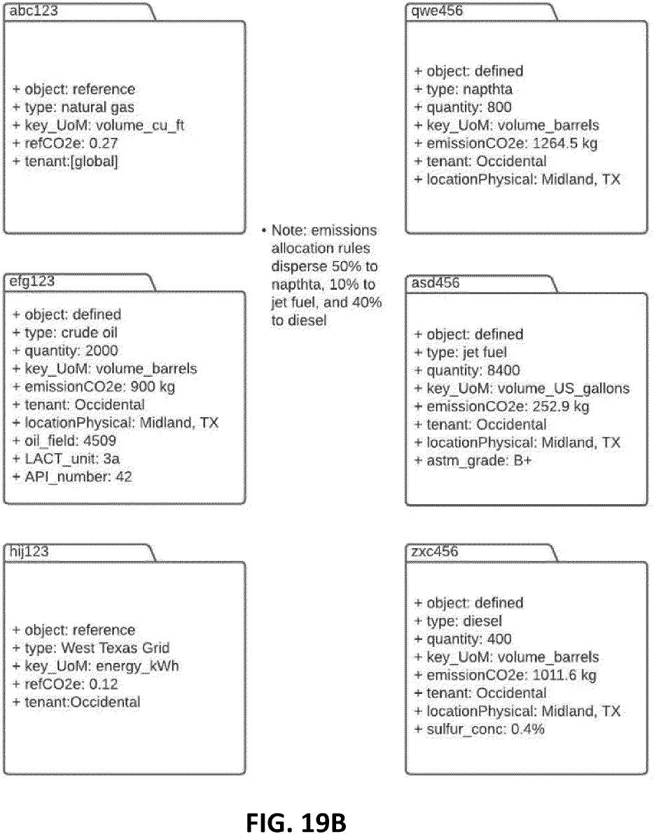

As shown in FIG. 19A, and Table 18, a system user is able to process, with a carbon object reference input and a Defined Unit object reference input, the MIMO for a refining process shown in FIG. 18. The process also encodes for each entity, non-zero unspecified emission. As shown in Table 18, a user entity Org 1 has an interface for an inventory start recording 2000 barrels of crude oil. A process header for the interface encodes a refining process instruction. The refining process packet includes a reference unit input that encodes, for entity abc123, the UoM and CO2e inputs for the 6000 cubic feet of natural gas, the input of 2000 barrels of crude oil, and the of 75 kilowatt hours from the West Texas Grid. The refining process header also includes a defined unit output for the 800 barrels of naphtha, the 8,400 gallons of jet fuel, and the 400 barrels of diesel.

TABLE 18

| | | |
|---|---|---|
| Org1 Inventory Start | Process: Refining | Org1 Inventory End |
| 2000 barrels, type: crude oil | abc123.input.reference:type = natual gas, quantity = 6000, key_UoM = volume_cu_ft efg123.input.defined:type = crude oil. quanity = 2000, key_UoM = volume_barrels hij123.input.reference:type = West Texas Grid, quantity = 75. key_UoM = energy_kWh Unspecified:CO2e = 0 kg | 880 barrels, type. napthtia 8400 US gallons, type: jet fuel 400 barrels, type diesel |
| | qwe456.output.defined:type = napitita, quantity = 800, key_UoM = volume_barrels asd456.output.defined:type = jet fuel. quantity = 8400, key_UoM = volume_USgallons zxc456.output.defined:type = diesel, quantity = 400, key_UoM = volume_barrels | |

As shown in Table 18 and FIG. 19A, the reference unit includes the three reference input types, and an entity assignation (abc123, efg123hij, hij123) for each. For all three reference unit inputs, and unspecified CO2e of 0 kg is encoded. The defined unit carbon object includes the three defined output types, and an entity assignation (qwe456, asd456, zxc456) for each. The packet then records the end inventory to include the outputted 800 barrels of naphtha, the 8,400 gallons of jet fuel, and the 400 barrels of diesel.

TABLE 19

abc.123

| | | |
|---|---|---|
| + | object: | reference |
| + | type: | natural gas |
| + | key_UoM: | volume_cu_ft |
| + | refCO2e: | 0.27 |
| + | tenant: | [global] |

TABLE 20

gwe.456

| | | |
|---|---|---|
| + | object: | defined |
| + | type: | napthis |
| + | quantity: | 800 |
| + | key_UoM: | volume_barrels |
| + | emissionCO2e: | 1264.5 kg |
| + | tenant: | Occidental |
| + | locationPhysical: | Midland, TX |

TABLE 21

efg.123

| + | object: | defined |
|---|---|---|
| + | type: | crude oil |
| + | quantity: | 2000 |
| + | key_UoM: | volume_barrels |
| + | emissionCO2e: | 900 kg |
| + | tenant: | Occidental |
| + | locationPhysical: | Midland, TX |
| + | oil_field: | 4509 |
| + | LACT_unit: | 3a |
| + | API_number: | 42 |

TABLE 22

asd456

| | | |
|---|---|---|
| + | object: | defined |
| + | type: | jet fuel |
| + | quantity: | 8400 |
| + | key_UoM: | volume_US_gallons |
| + | emissionCO2e: | 252.9 kg |
| + | tenant: | Occidental |
| + | locationPhysical: | Midland, TX |
| + | astm_grade: | B+ |

TABLE 23

hij123

| | | |
|---|---|---|
| + | object: | reference |
| + | type: | West Texas Grid |
| + | key_UoM: | energy_kWh |
| + | refCO2s: | 0.12 |
| + | tenant: | Occidental |

TABLE 24

zcc456

| + | object: | defined |
|---|---|---|
| + | type: | diessel |
| + | quantity: | 400 |
| + | key_UoM: | volume_barrels |
| + | ernissioriCO2e: | 1011.6 kg |
| + | tenant: | Occidental |
| + | locationPhysical: | Midland, TX |
| + | sulfur_canc: | 0.4% |

As shown above in Tables 19-24 and FIG. 19B, defined unit carbon objects record the input crude oil, the output naphtha and jet fuel, and the diesel to the respective entity assignations (efg123, qwe456, asd456 and zxc456) for each. Reference unit carbon objects include the CO2e references for the natural gas and kilowatt energy from the West Texas Grid. As will be noted, the tenant for the natural gas reference object is global, whereas the tenant for the other reference unit carbon object and the direct objects is Occidental. In the example, the objects encode emissions allocation rules, which disperses 50 percent of the carbon to the naphtha, ten percent to the jet fuel, and forty percent to the diesel.

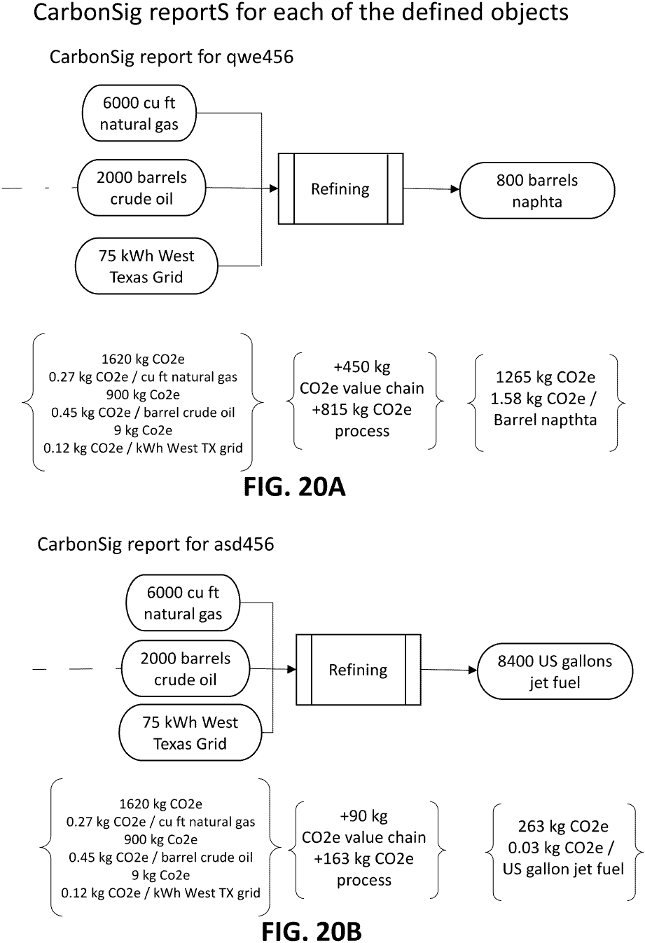

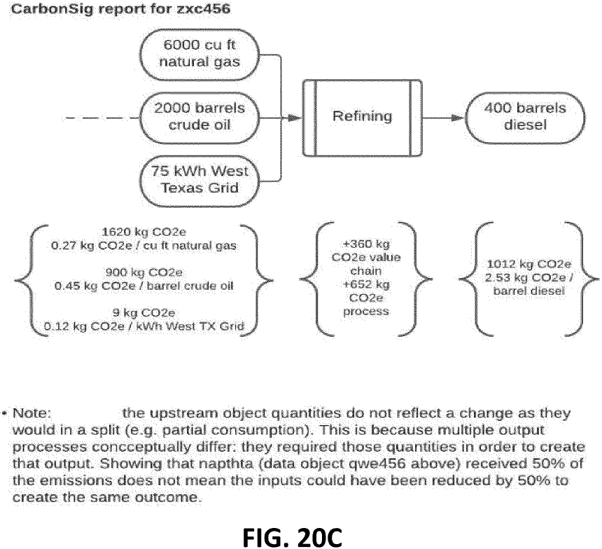

FIGS. 20A-20C shows examples of GHG reports for the defined unit carbon objects of FIGS. 18-19B and Tables 18-24. As shown in FIGS. 20A-20C, because the system employs structured carbon objects that encode, inter alia, tenant organizations and CO2e for each component input and output for every process, as well as the life cycle of materials and manufactures, a highly accurate report can identify the carbon footprint of every organization from end-to-end.

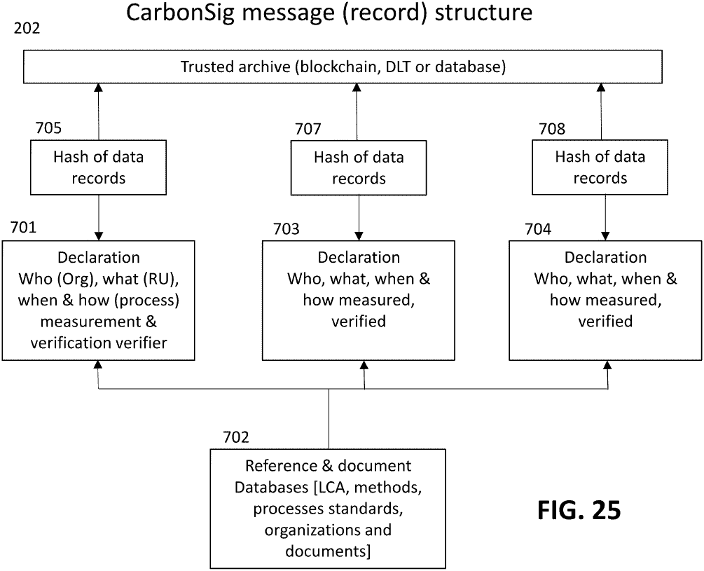

Notably, in the GHG reports the upstream objects for the diesel, jet fuel, and naphtha do not report a change, as would be the case if these were split via a partial consumption. In a multiple output process, the carbon outputs required the input quantities to produce the outputs. As such, when the naphtha for Defined Unit carbon object qwe456 receives fifty percent of the carbon emission allocation, this does not mean carbon inputs can be reduced by that amount to create that same outcome. Instead, as described below in more detail with respect to FIGS. 25-31, the system records and encodes allocation rules for the emissions distribution.

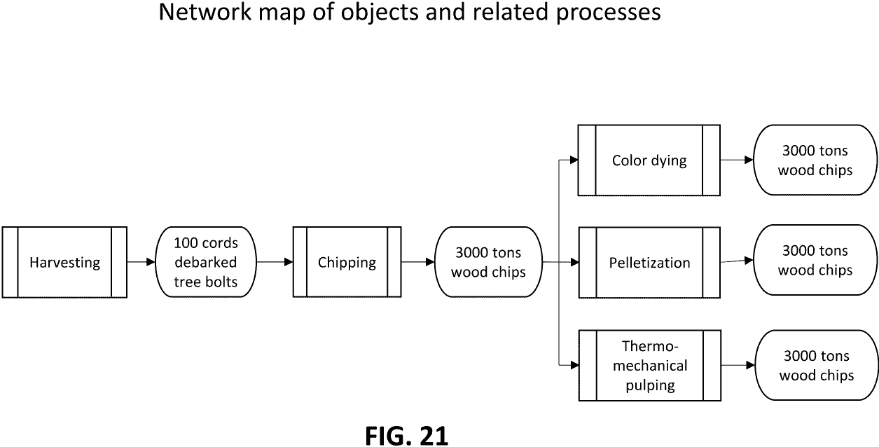

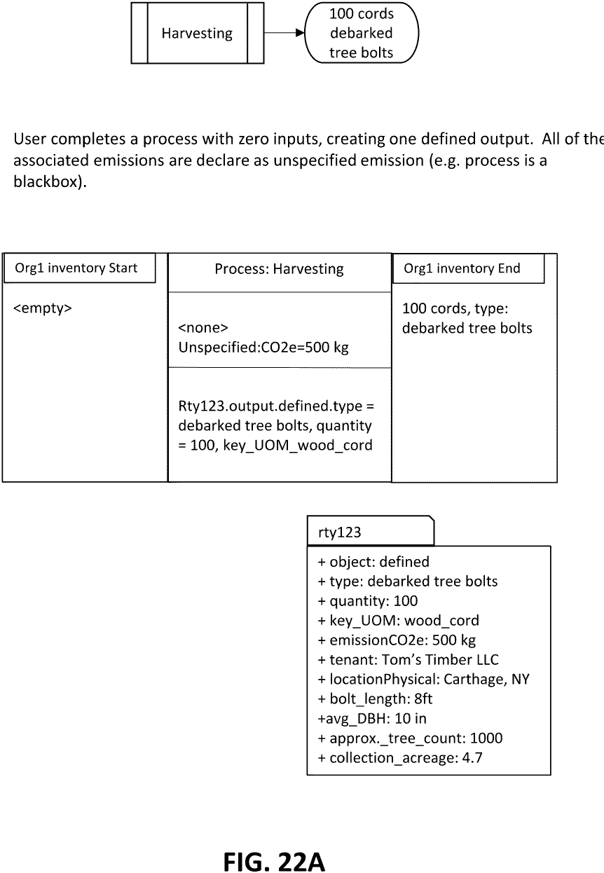

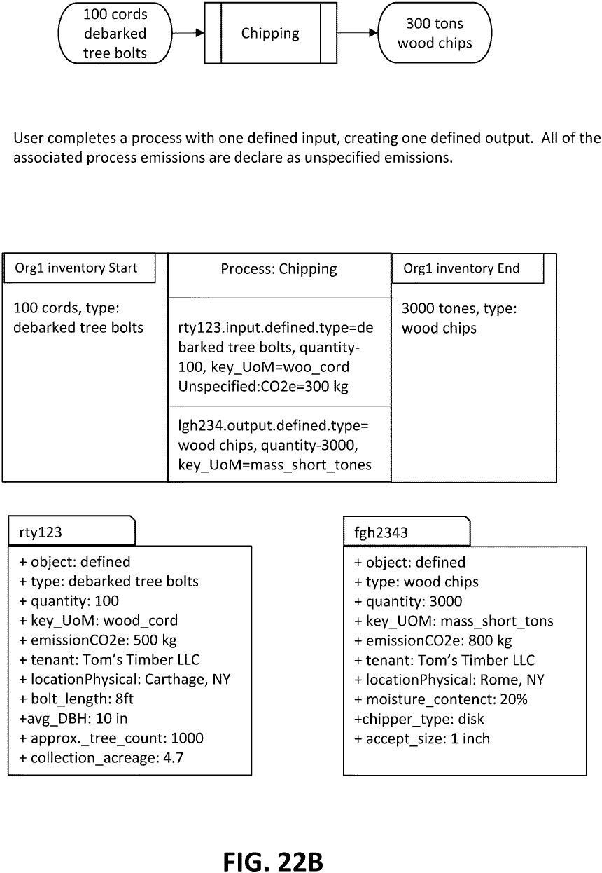

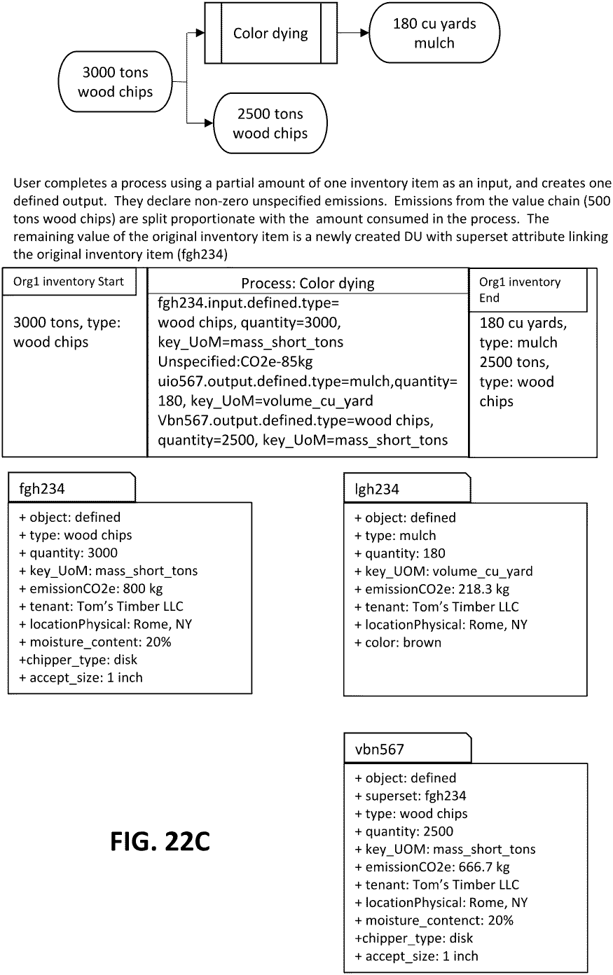

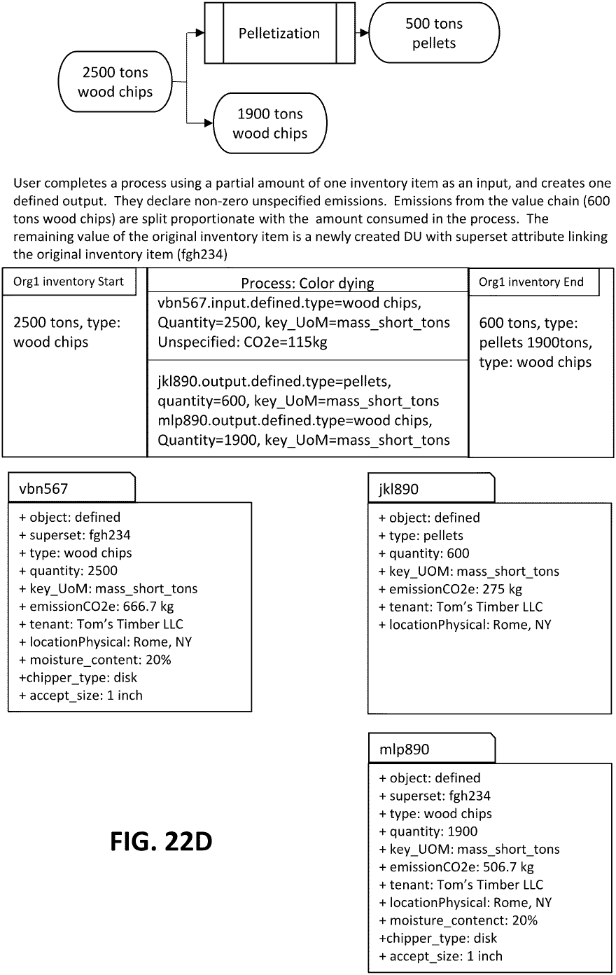

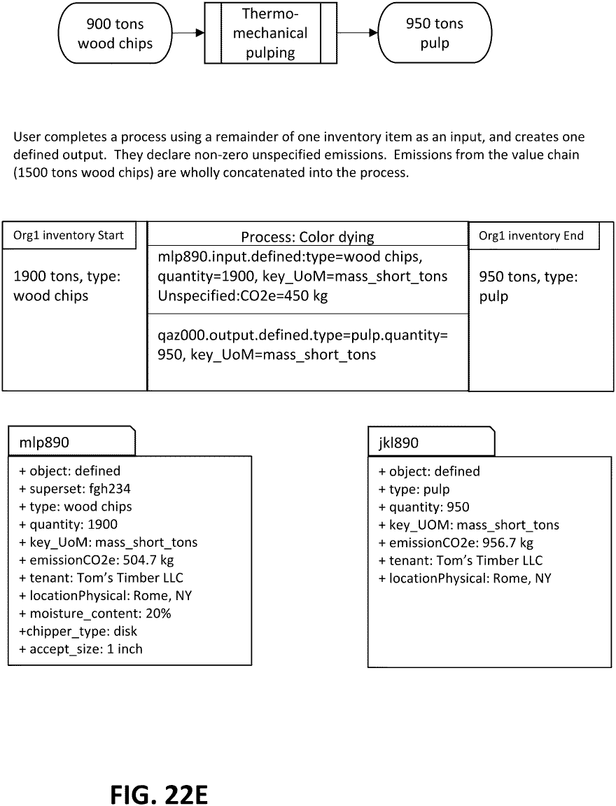

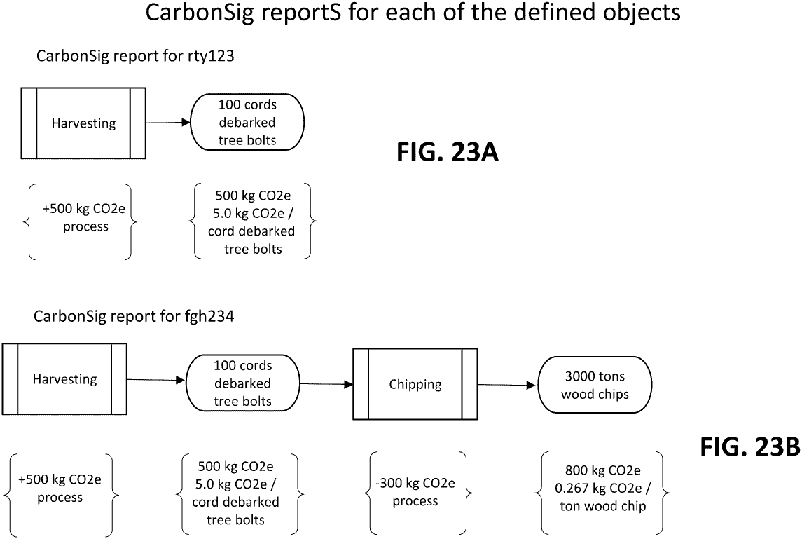

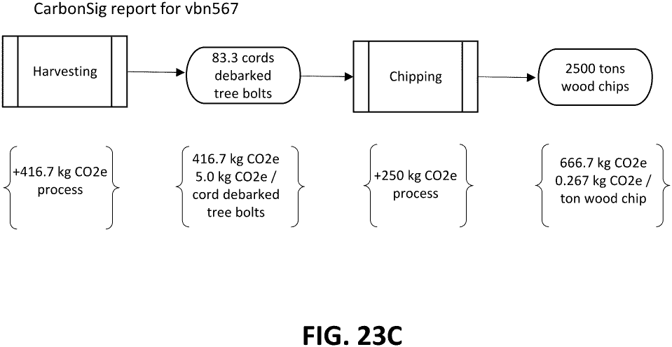

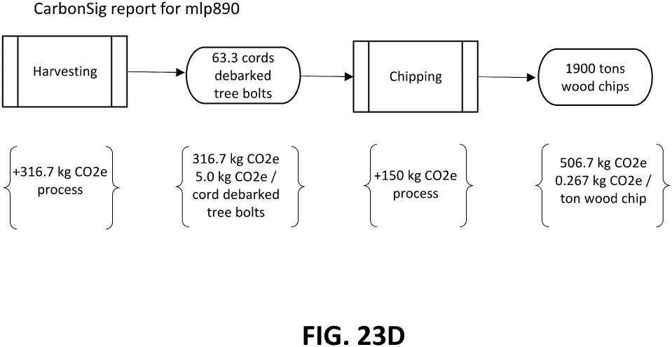

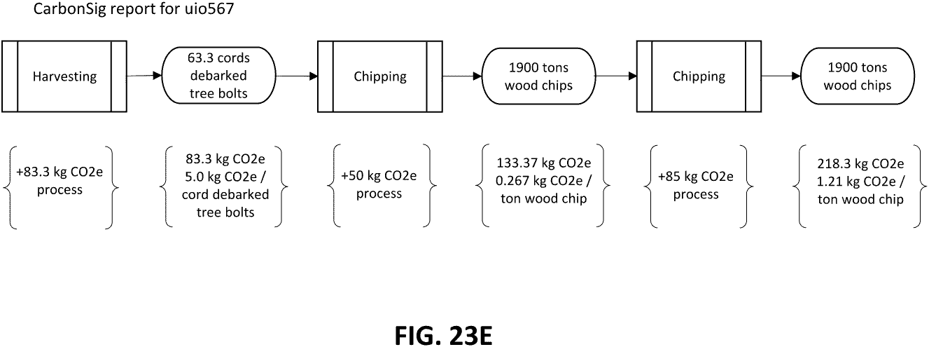

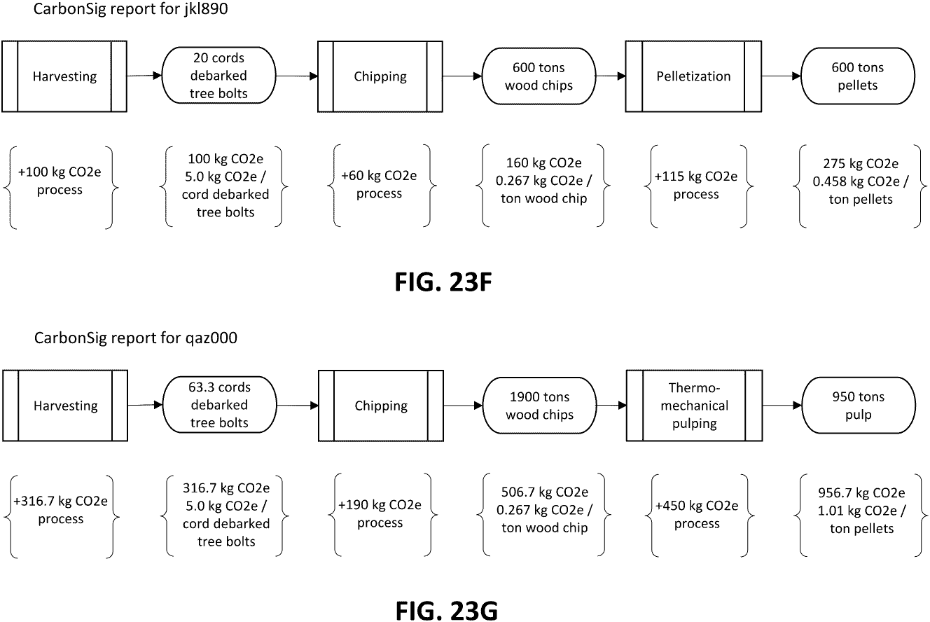

FIG. 21 shows a network map of carbon objects for processing lumber to wood products. FIGS. 22A-22E show a logical flow and directed graphs detailing user inputs and object definitions, system responses, and recorded databases for the processes of FIG. 21. FIGS. 23A-23G show carbon signature reports generated for each of the carbon objects generated in FIGS. 22A-22E. As will be appreciated. the network maps are able to record the CO2e associated for any process or manufacture, as the <CarML> interface, variables, tags, message types and coding is composable, consistent and agnostic and not user system dependent.

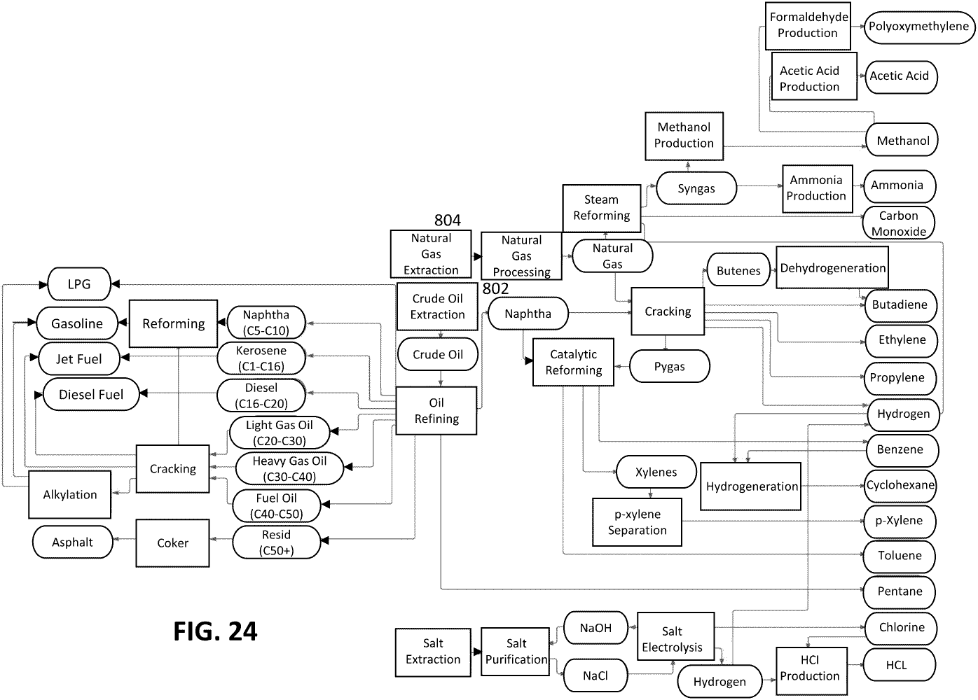

FIG. 24 shows a logical flow for user attribute contextualization dimension for the life cycle of a host of products and processes starting from raw crude oil extraction and raw natural gas extraction. For each block, the system is configured to allow a user to generate, process, offer, transfer, and record carbon object certificates so that at every step the carbon emissions and carbon related instruments and certificates are measured and identified to entities, products, and processes with great transparency and accuracy. The user API and object libraries are configured with a message structure that ensures users can generate and update carbon emissions and data for any product or process and for any entity including third party external systems including ERP and IOT data across any supply chain. Every step in the process can add GHG where it requires energy or related materials. In the example of FIG. 24, the exemplary flow starts with the extraction of raw product crude oil 802 and natural gas 804 are the center of this process map, similar exemplary system processes described with respect to FIGS. 9. and 18-20C, when extended to a larger life cycle. As FIG. 24 demonstrates, a vast number of multiple outputs and inputs are generated during these processes. As described above, the system and interfaces therefor allow for the generation, tracking, assigning, and managing the GHG associated with any products or process along any value and production chain with high environmental accounting integrity and transparency.

As described above with respect to FIGS. 20A-20C, the system records and encodes allocation rules for the emissions distribution. In an implementation, described is a system method for a carbon label object. FIG. 25 shows an exemplary carbon message record structure for recording and encoding, inter alia, references for carbon objects.

At block 702, a database comprises reference documents for LCA, methods, process standards, organizations, and other documentation. At blocks 701, 703, and 704 the system is configured to assign and verify the information to verification entities. At blocks 705, 707, and 708 each verified record is hashed and or recorded to a distributed immutable ledger 202. In the message structure Data Object Declarations 701, 702, 703, can be expanded for relative elements addressed in the object. An exemplary information structure for a Data Object Declaration of GHG intensity is shown in Table 25.

TABLE 25

Who is declaring the GHG: product/service owner at point in time
What is being Declared: in terms of GHG (amounts types/source/nature) combined with the related product(s)/services(s) and relative to prior events
Why: is this declaration being made (new product, service process or event) split/merge of existing products/services
When: did the change in GHG change occur and over what period of time.
Where: Where was the product service located. Where did the GHG impact occur either a point location or a transit/travel Route/path over time
How a Change in GHG happened: change: energy added, mess added/subtracted, or environmental attributes I (credits/offsets) assigned and embedded.
How it was proved: what was the mechanism for confirmation, 3rd party entity, data source
Who confirms these facts: govt, regulator 3rd party
How large % is the uncertainty (risk buffer) of the declaration: of the declared GHG

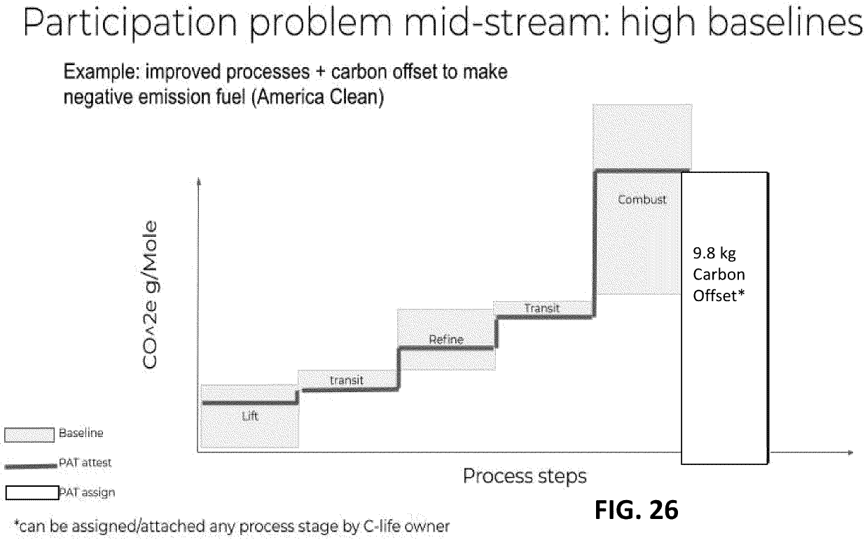

By employing verified carbon objects, the system is thereby configured to identify valid carbon emission declarations and compare these to baselines to identify, inter alia, mid-stream carbon emissions and net declared negative emissions for offsets. FIG. 26 shows a concatenation for a carbon offset or removal instrument. As shown in FIG. 26, a verified baseline and carbon object certificates with verified net declared emissions allow entities to demonstrate, at each stage of a product life cycle, a negative net declared emission when achieved. For example, for a product such as oil or gas has stages of lift, transit, refine, transit, and finally combustion. At each stage, user entities are able to use the system to verifiably demonstrate, via carbon objects, carbon emissions that are net declared lower than regulated or established baselines. By the end of the life cycle, at combustion, the system is able to record an accurate carbon offset (e.g., 9.8 kg) for the product publicly or privately to an immutable system of record.

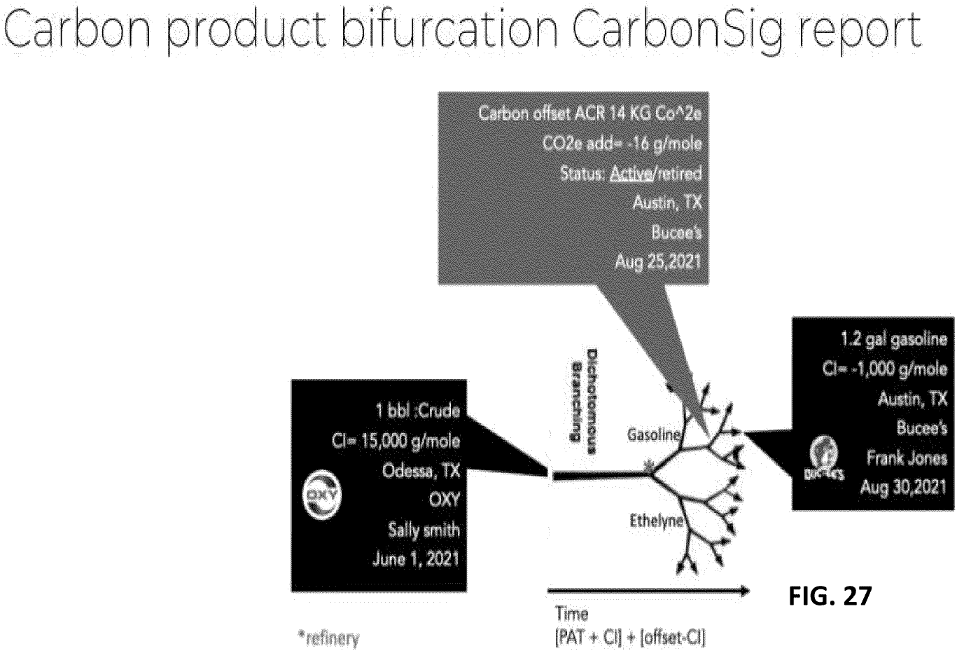

Further, the system is also advantageously configured to identify, at any point in produce of process life cycle, carbon offsets or carbon, whether such offsets are retired, and by whom. FIG. 27 shows an exemplary bifurcation of products and services across supply chains for a carbon product for a carbon report interface. As shown in FIG. 27, at a refinery, crude oil is branched into gasoline and ethylene. As demonstrated above, carbon output objects at this branch are output to inventories with carbon tracking, which in turn become carbon object inputs as the product moves through processes.

Environmental integrity is predicated on accounting integrity for many “open systems.” Open systems include but are not limited to electrical networks, blending tanks, stockyards, sorting bins, or any systems where homogenous items collect or flow in a difficult to track or trace environment. The problem in such situations is that the inputs become impossible to sort from the output items as they can become physically indistinguishable. In such open systems tracking the exact amount of a thing and the environmental or other attributes allows for accounting by limiting the assignment of certain attributes to be no greater than the previously declared inputs. For example, if only 10 fair trade oranges enter a bin, then only 10 fair trade oranges are ever allowed to be declared exiting the bin process. If 10 MWh of “green electricity” enters an electrical grid, then only 10 MWh of green electricity claims are allowed by users of the electrical network. If 1 bbl of “low carbon” oil than only 1 bbl or derived equivalent is allowed to exit a process of a storage tank.

In an implementation, the system can be configured to auto assign GHG amount if mass/service is lost. When a form of mass or service is lost or no longer economically viable to be transferred, the GHG associated with it still needs to be accounted for. The system automatically “conserves” environmental integrity by assigning “lost” GHG to the remaining economically valued goods and services through the product life cycle across the supply chain.

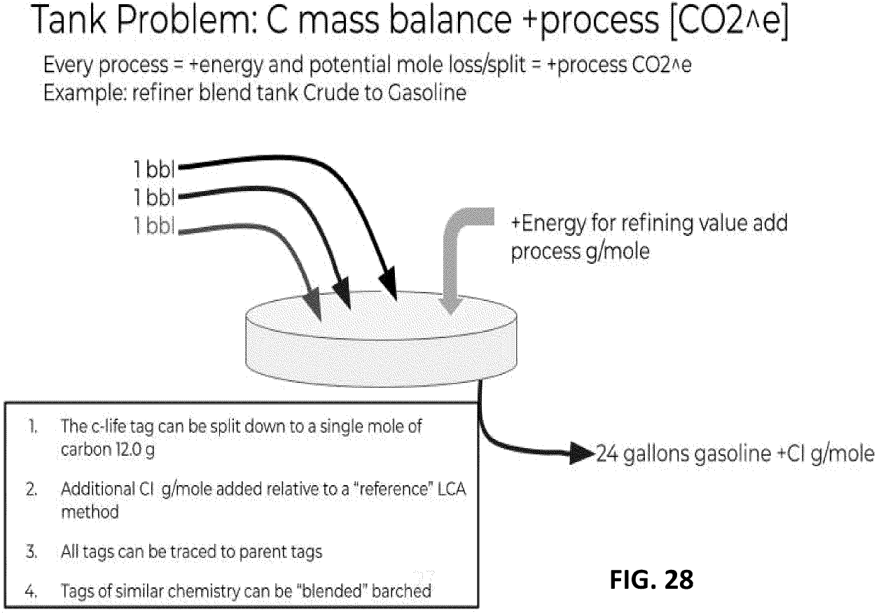

For example, FIG. 28 shows an auto sum total for conservation of carbon. In a “tank problem,” three inputs each add 1bbl of CO2e to a refining tank, and the refining adds more CO2e, such that 24 gallons of gasoline additional g/moles of CO2. As described herein, the system can track the carbon into nano pieces down to the mole. Additional attribute tags added relative to a reference LCA method can be traced to parent attribute tags of carbon objects. Further, attribute tags having a similar chemistry can be batched.

In an implementation, the system can similarly generate carbon objects and a GHG service life cycle report certificate for a complex service.

In an implementation, the system can be configured for machine checking data for GHG measurement (LCA life cycle analysis) and Mitigation (credits/offset) compliance with some specified guidelines using business logic. A system reference library can be configured for a user or service to query a database of known actors for accepted best practices in CO2e measurement, verification, declaration and management including the use of CO2e related certificates and instruments.

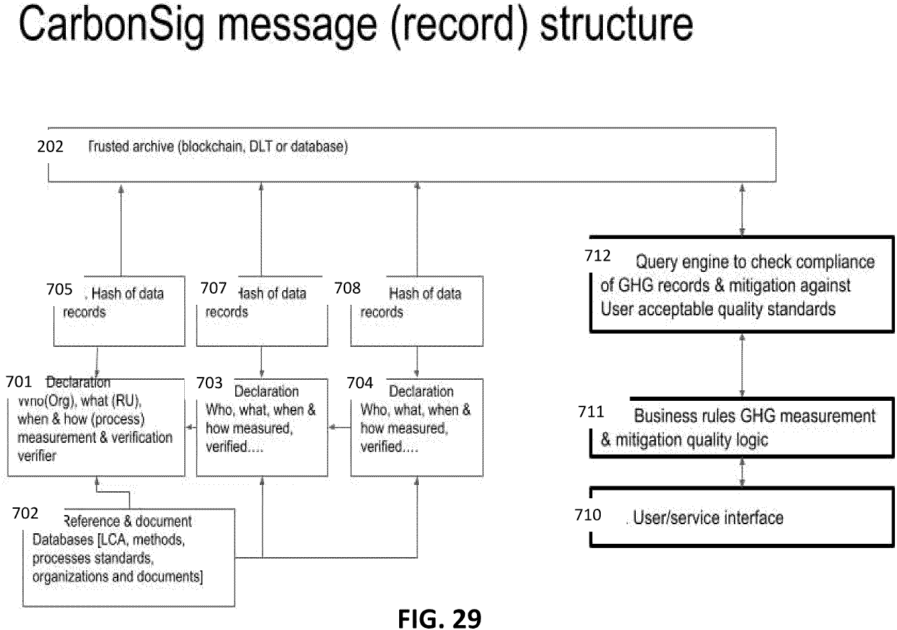

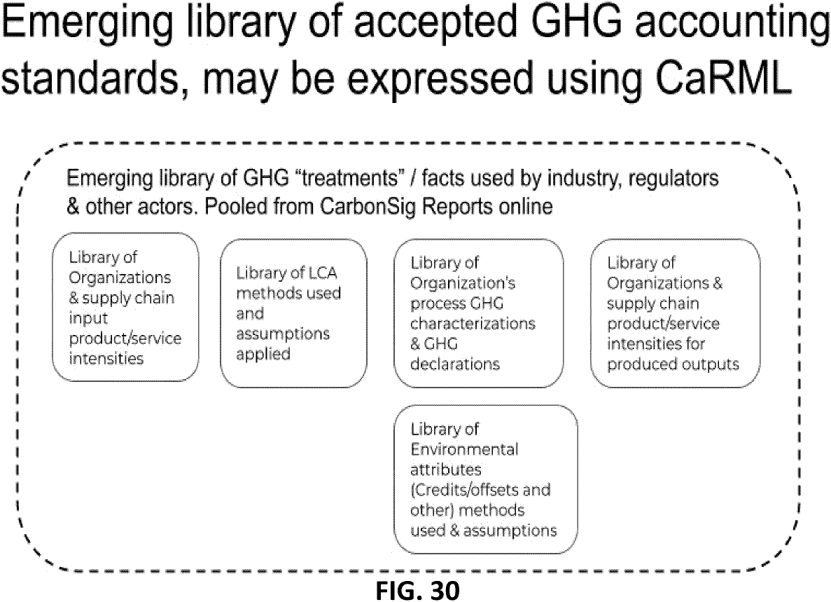

FIG. 29 shows an exemplary carbon message record structure interface. As described with respect to FIGS. 1 and 6, in an implementation, the system comprises a Public Life Cycle Inventory Library 212 including a database 212 of LCI objects, including verified or accepted LCA standards, GHG measurements and mitigations. The system can also comprise a Public GHG report certificate interface 213 can include a searchable report certificate database, in which the collection of GHG certificate reports and ownership transfers can be public. The types of public transfers, those GHG related declarations, measurements and mitigation accepted by downstream parties are accepted as commercially or regulatory widely accepted. Using the interface record structure shown in FIG. 29, at block 710 a user can use the Public GHG report certificate interface 213 to access the database to confirm normative practices when working with GHG declarations. At block 711, the system accesses the GHG database including the exemplary GHG mitigation standards database of accepted GHG mitigation standards for credits, shown in more detail at in FIG. 30. At block 712, the system comprises a query engine configured to allow a user to query the GHG certificate database to check, inter alia, GHG records, including compliance and mitigation against quality standards. The database can be expressed using <CarML>, described herein and below.

FIG. 30 shows an exemplary GHG database including the exemplary emerging GHG mitigation standards database of accepted GHG mitigation standards for credits. As shown in FIG. 30, the GHG database can include a library of organizations and supply chain inputs for products and processes. The GHG database can also include Library of LCA methods used and assumptions applied. The GHG database can include a library of organizations and supply chain outputs for products and processes, as well as a library of environmental attributes and credits or offsets.

As shown in FIG. 31, an exemplary dataset of GHG declarations and reporting standards can be generated and stored over time as users transfer reports and declarations of attributes to other parties across industry sectors and boundaries as a user employs the <CarML> interfaces, UIDs, variables and message types. For example, a first organization adds value 751 a declaration for a GHG dedication. Next, a second organization contributes a value 752 to the GHG declaration. In a third step, a third organization contributes a value 753, value 754 and value 755 to the declaration certificate.

In an implementation, referring to FIG. 1, the system 200 can be configured to comprise a Carbon Reporting Markup Language <CarML> 219. The <CarML> 219 is a markup language and meta-schema that is extensible similar to XBRL. <CarML> and other extensible languages that are domain specific aid in structured communications between actors. Extensibility means a core set of common data elements can serve as collectively shared core framework for data sharing, while supporting local data structure term extensions for smaller groups of actors.

<CarML> 219 uses existing multiple reference schema already in use where possible at its core to define and delineate in a structured way the actors, actions, objects, processes, and elements associated with tracking, reporting, recording, declaring, and transferring goods and services that have GHG associated with them. Extensibility of the language is a feature allowing multiple actors across domains to use a shared core language, message types, variable and third party UIDs for defining and describing the processes, products, and services they work with. <CarML> 219 is configured to put a carbon C02e context around existing descriptive taxonomies used in accounting, supply chains, process and other systems dealing with physical goods and services.

FIG. 32 shows a taxonomy that can be employed in a Carbon Markup Language <CarML> schema. <CarML> can be expressed as a specific XML data schema with tags for data objects configured to provide a carbon related variable or message type. Each terminal branch can be configured with specific tags. An XML tag schema follows a “<descriptor> /” convention for separating the meta data from the data in an evolving schema, for example, such as XBRL and iXBRL languages. As shown in FIG. 31 the <CarML> schema comprises root tags for Geography, Products, Services, Regulatory Entities, Organizational Entities, Time, GHG Mitigation Instrument, Measurements, and Intangible States. Each root tag in the schema has leaves that can be sub-tagged with metadata and or global Unique ID specific and useful for product carbon related tracking, declaration and management. For example, a Geography root tag can have leaf tags for a Standard reference set (e.g., GIS/ISO), a geographical point, or a path. A root tag for regulatory entities can have tagged data objects for environmental entities, customs entities (export/import), and taxing or financial entities. A GHG mitigation instrument root tag can include data objects tagged for removals, offsets, credits, regulatory compliance systems and units, environmental tag traits, intended transaction mitigations, outcomes, and other metadata. A measurement root tag can include branch metadata tags for good/service parameters, LCA life cycle analysis, standardized measurements (e.g.: ISO), risk/uncertainty standards, industry benchmarks, and environmental conditions. As will be appreciated, because the <CarML> schema is extensible and integrated into the interfaces, logical layer, and representational layer, the system interfaces are configured to allow users to flexibly publish and consume new carbon relevant metadata in a system agnostic standardized format. The carbon metadata can thus be generated, stored, published, pulled, consumed and tracked by and across any system. Further, as will be appreciate, <CarML> data objects can be expressed in XML, XSLT, JSON or another structure DTD (document type definition), allowing the same flexibility and interoperability as XML and XML extensible code interfaces. As a machine-readable extensible language, the core <CarML> language can be read by various entities and groups for whom data object tags are configured for, as shown in the exemplary chart of FIG. 32.

FIG. 33 shows an example of a <CarML> implemented in a JSON schema via an API, shown in Table 27. Also shown in FIG. 32 is a comparison with XML schema, shown in Table 26. As shown in FIG. 33, an XML note encodes a standard ISO-8859-1 <?xml version=“1.0″ encoding= “ISO-8859-1″>. The XML schema as tags for note, to, from, heading, and body.

TABLE 26

<7xml version=^{x}1.0”
encoding= “ISO-8859-1”?>
<note>
<to>Tove</to>
<from>Jani</from>
<heading>Reminder</heading>
<body>Don’t forget me this
weekendl</body >
</note>

The <CarML> schema version 1.0 is also shown as encoding ISO-8859-1 <?carml version “1.0” encoding= “ISO-8859-1″>. As shown in FIG. 33, the schema encodes tags for a <CarML> container that includes Product, Owner, CO2eKG, description, mitigation, and mitigation amount.

TABLE 27

<?carml version=^{x}1.0” encodfng=“ISO-8853-1″?>
<carml>
<Product>Cookies</Product>
<Owner>Smith Bakery</Owner>
<CO2eKG>5.02</CO2eK6>
<description>Cookies baked with renewable
energy</description>
<mitigation >Carbon_offset< /mitigation>
<mitigation_Amount_KG>2.0</ mitigation_Amount_
</carml>

As the example shows, <CarML> is configured to tag carbon specific data objects with containers, tags and data values which can be systematically added as schema extensions using new locally contextually relevant tags by users in a consistent, machine-readable language. Thus, <CarML> is configured to be readily extensible to cover, inter alia, the exemplary root and branch structures such as that shown in FIG. 33.

The extensibility means that the “global” public definitions of <CarML> may be extended for specific industry, commercial or even intercompany data transfer purposes requiring machine export, import or analysis of structured data associated with the GHG of goods and services as described herein.

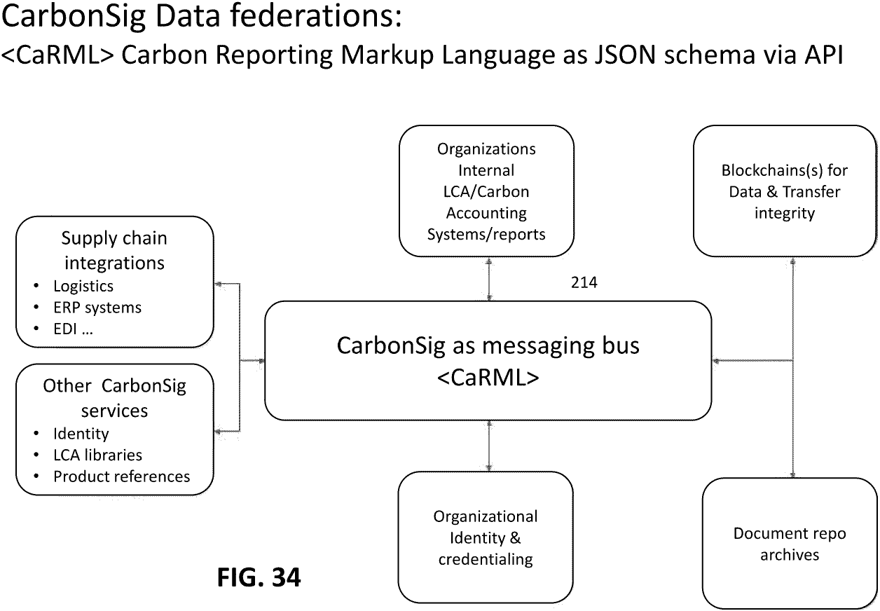

FIG. 34 shows an exemplary architecture interface for a <CarML> encoded messaging bus 214 for a carbon system platform. As shown in FIG. 33, <CarML> codes can be configured to interface with internal or external organizational systems, ledgers and distributed immutable ledgers, IOT systems, MRP systems, supply chain integrations including logistical and enterprise resource planning systems, organizational identity and credentialing systems, and library and document archives including legal verification documentation. The <CarML> encoded messaging bus interface can also be integrated with a carbon platform configured to provide identity verification and libraries for carbon information as described herein. A <CarML> interface can also be configured for messaging application integrations, for example, distributed immutable ledger applications or third party systems. As explained above, a platform Service Bus 214 can be integrated via an API and to microservices using an extensible carbon language <CarML> or other methods. Operating between the logical layer and the representational layer, the platform Service Bus 214 can be configured to manage access to external digital information or requests for information from within the platform system 200. The communication between these mutually interacting software applications and the structure of data being transferred are formalized by a platform Service Bus 214.

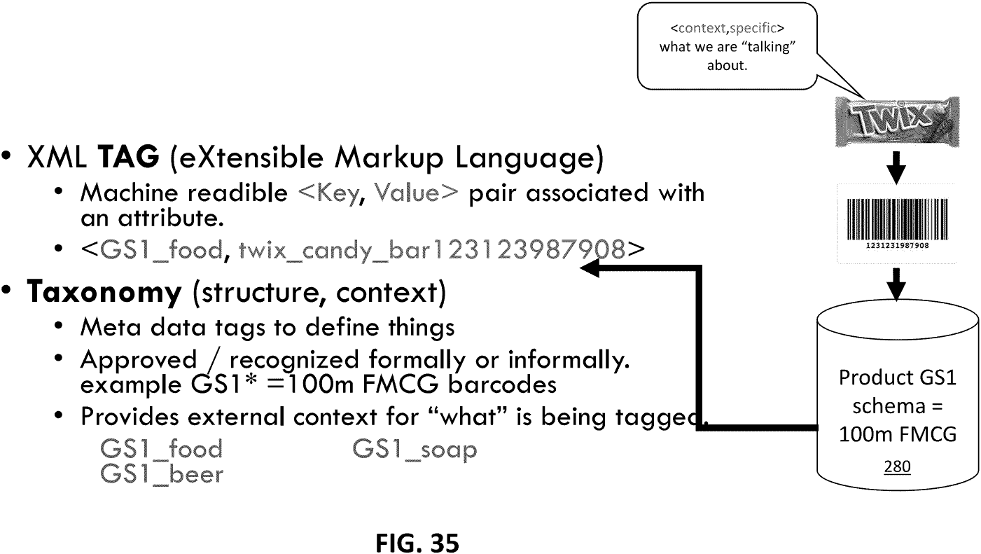

In an implementation, <CarML> is configured to provide a local “contextless” declaration system into a globally usable extensible context system. <CarML> can be configured to map into extant systems and databases for including carbon attributes. FIG. 35 shows an example of an XML structure and a massive database of unique identifier XML data. As shown in FIG. 35, GS1 fast moving consumer goods (FMCG) 100 million product barcode database 280 includes XML barcode tag data. A machine-readable key and value pair <Key, Value> tag is associated with an attribute, here a specific type of candy bar. The XML Key/Value pair encodes GSl_food as the Key and twix-candybar12312398790 to a GS1 fast moving consumer goods (FMCG) 100 m product barcode database. The taxonomy of the XML container is encoded with metadata tags that provides the structure and context of the container. For example, as shown in FIG. 35, the database is configured to include metatags for generating GS1 standardized Barcodes for FMCG goods. Thus, the Key can be GS1_food, GS1_beer, GS1_soap, and so on, and the product value tagged to a selected Key.

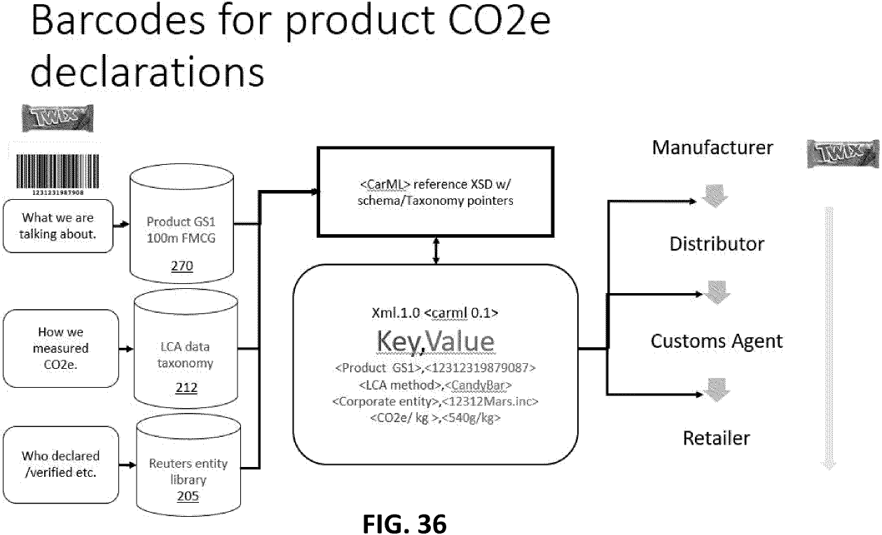

FIG. 36 shows an exemplary <CarML> structure configured for tracking carbon objects. As shown in FIG. 36, a <CarML> reference can encode a reference XML Schema Definition including schema and taxonomy pointers from existing databases. As shown in the example, a first Key, Value pair can include and leverage an extant XML encoded standard, for example the GS1 fast moving consumer goods (FMCG) 100 m product barcode <GS1_food, twix-candybar12312398790 as shown in FIG. 35. Because the <CarML> schema leverages an XML schema, <CarML> is readily integrated into such databases for extensibility. As shown in FIG. 35, the <CarML> schema includes Key, Value pairs for Product GS1, LCA method, Corporate Entity, and C02e/kg.

Each of the carbon Key, Value pairs can come from databases for this information as described herein. For example, the LCA method and CO2e/kg key, value pairs can be obtained from, inter alia, process library 207 public life cycle library 212, which is interfaced with Attribute Library 212, Defined Unit library 209, Reference Unit library 208 as discussed herein. Key, value pairs for a verification entity or a corporate entity be obtained from organization and user manager 205 and organization and user object libraries 206. As such, the <CarML> schema container can integrate this carbon information for carbon enhanced barcodes employing the GS1 product barcode. This barcode information can then be accessed or pushed downstream to manufacturers, distributors, customs, and retailers. As such a simple or detailed carbon report or certificate can be embedded with a barcode or unique identifier such as a fixed URL for tracking through the life cycle of the product as described herein. Thus, as detailed herein, Embodied C02e of a product or service can be tracked and displayed at the product level.

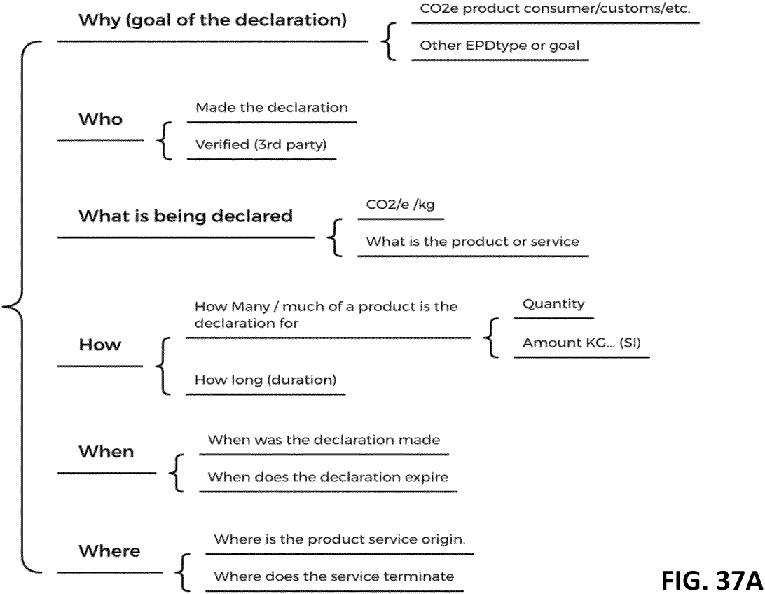

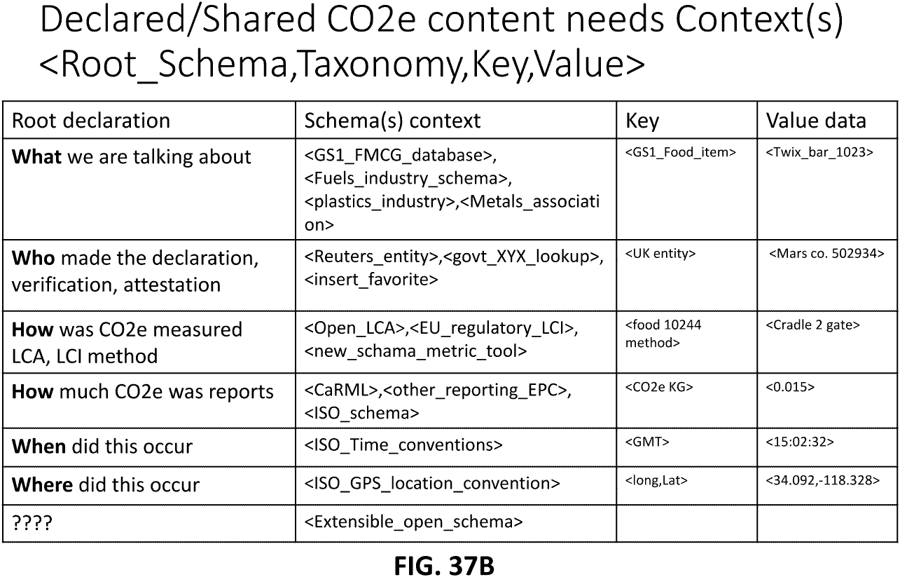

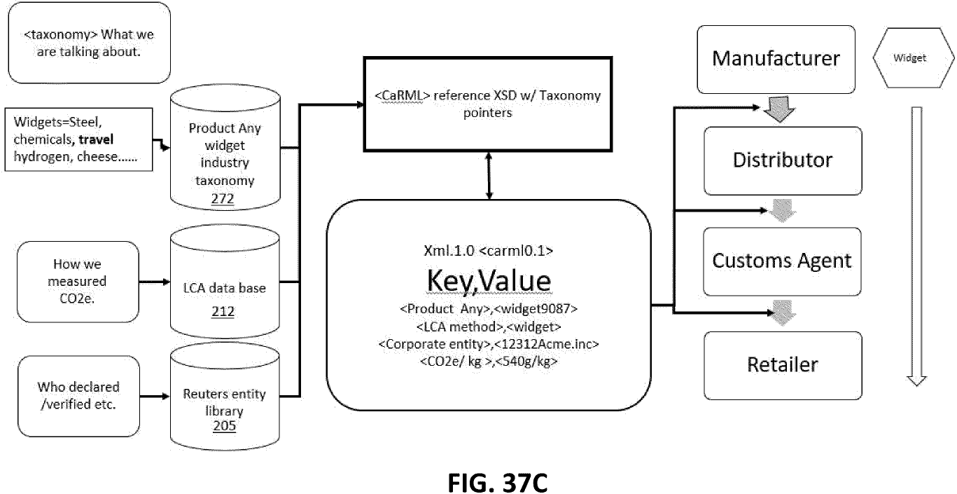

As will be appreciated, a GS1 product barcode and database is an example of a <CarML> integration for a <CarML> environmental product declaration message type. FIG. 37A shows an exemplary <CarML> declaration schema which lays out the taxonomic structure for <CarML> key, value pairs and object metadata. The “Why” for a CO2e declaration can be for a host of reasons, for example, customs reporting, retail packaging, reporting, and so on. Organizations for the <CarML> declaration schema can be the entity making the declaration, and a verifying entity for verifying the authenticity of the carbon declaration. As for what is declared, key value tags can be set for the product and service and the CO2e/kg amounts. Key and value pairs can also be set for how much of product the declaration is for (quantity/amount), when the declaration was made, when it expires, the origin location of the product or service and their termination points. FIG. 37B and Table 28, show an exemplary <CarML> Root Schema, Taxonomy, and Key Value tagging for declaration data objects.

TABLE 28

| | | | |
|---|---|---|---|
| Root declaration | Schema(s) context | Key | Value data |
| What we are talking about | <GS1_FMCG_database>, <Fuels_industry_schema>, <plastics_industry>,<Meta ls_association> | <GSl_Food_ite m> | <Twix_bar_1023 > |
| Who made the declaration, verification, attestation | <Reuters_entity>,<govt_X YX_lookup>, <insert_favorite> | <UK entity> | <Mars co. 502934> |
| How was CO2e measured LCA, LCI method | <Open_LCA>,<EU_regulat ory_LCI>, <new_schama_metric_tool > | <food 10244 method> | <Cradle 2 gate> |
| How much CO2e was reports | <CarML>,<other_reportin g_EPC>, <ISO_schema> | <CO2e KG> | <0.015> |
| When did this occur | <ISO_Time_conventions> | <GMT> | <15:02:32> |
| Where did this occur | <ISO_GPS_location_conven tion> | <long, Lat> | <34.092,-118.328> |
| User determined schema level extension, variable or | <Extensible_open_schema > | User defined | User defined |
| message type | | | |

Thus, as shown in FIG. 37C, the <CarML> schema illustrated in FIG. 36 can be expanded to any product or service library or database 272.

### Exemplary Network Architecture

In at least one embodiment, a system 200 or a network computer, comprises a network computer including a signal input/output, such as via a network interface or interface unit, for receiving input, a processor and memory that includes program memory, all in communication with each other via a bus. In some embodiments, processor can include one or more central processing units. In some embodiments, processor can include additional hardware devices such as Graphical Processing Units (GPUs) or AI accelerator application-specific integrated circuits. Network computer also can communicate with the Internet, or some other communications network, via network interface unit, which is constructed for use with various communication protocols including the TCP/IP protocol. Network interface unit is sometimes known as a transceiver, transceiving device, or network interface card (NIC). Network computer also comprises input/output interface for communicating with external devices, such as a keyboard, or other input or output devices. Input/output interface can utilize one or more communication technologies, such as USB, infrared, Bluetooth, or the like.

Memory generally includes RAM, ROM and one or more permanent mass storage devices, such as hard disk drive, flash drive, SSD drive, tape drive, optical drive, and/or floppy disk drive. Memory stores operating system for controlling the operation of network computer. Any general-purpose operating system can be employed. Basic input/output system (BIOS) is also provided for controlling the low-level operation of network computer. Memory can include processor readable storage media. Program memory, which can be a processor readable storage media, can be referred to and/or include computer readable media, computer readable storage media, and/or processor readable storage device. Processor readable storage media can include volatile, nonvolatile, removable, and non-removable media implemented in any method or technology for storage of information, such as computer readable instructions, data structures, program modules, or other data. Examples of processor readable storage media include RAM, ROM, EEPROM, SSD, flash memory or other memory technology, optical storage, magnetic storage devices or any other media that can be used to store the desired information and can be accessed by a computer.

Memory further includes one or more data storages, which can be utilized by network computer to store, among other things, applications and/or other data. For example, data storage can also be employed to store information that describes various capabilities of network computer. The information can then be provided to another computer based on any of a variety of events, including being sent as part of a header during a communication, sent upon request, or the like. Data storage can also be employed to store messages, web page content, or the like. At least a portion of the information can also be stored on another component of network computer, including, but not limited to, processor readable storage media, hard disk drive, or other computer readable storage medias (not shown) in network computer.

Data storage can include a database, text, spreadsheet, folder, file, or the like.

Data storage can further include program code, data, algorithms, and the like, for use by a processor, such as processor, to execute and perform actions. In one embodiment, at least some of data store might also be stored on another component of network computer, including, but not limited to, processor readable storage media, hard disk drive, or the like.

One or more functions of system 200 can be a single network computer or distributed across one or more distinct network computers. Moreover, system 200 or computer is not limited to a particular configuration. Thus, in one embodiment, computer has a plurality of network computers. In another embodiment, a network server computer has a plurality of network computers that operate using a master/slave approach, where one of the plurality of network computers of network server computer is operative to manage and/or otherwise coordinate operations of the other network computers. In other embodiments, a network server computer operates as a plurality of network computers arranged in a cluster architecture, a peer-to-peer architecture, and/or even within a cloud architecture. System 200 can be implemented on a general-purpose computer under the control of a software program and configured to include the technical innovations as described herein. Alternatively, system 200 can be implemented on a network of general-purpose computers and including separate system components, each under the control of a separate software program, or on a system of interconnected parallel processors, system 200 being configured to include the technical innovations as described herein. Thus, the innovations described herein are not to be construed as being limited to a single environment, and other configurations, and architectures are also envisaged.

As described herein, embodiments of the system 200, processes and algorithms can be configured to run on a web service and/or distributed immutable ledger platform host such as Amazon Web Services (AWS), Microsoft Azure, Hyperledger, Ethereum, and so on. A cloud computing architecture is configured for convenient, on-demand network access to a shared pool of configurable computing resources (e.g., networks, network bandwidth, servers, processing, memory, storage, applications, virtual machines, and services). A cloud computer platform can be configured to allow a platform provider to unilaterally provision computing capabilities, such as server time and network storage, as needed automatically without requiring human interaction with the service’s provider. Further, cloud computing is available over a network and accessed through standard mechanisms that promote use by heterogeneous thin or thick client platforms (e.g., mobile phones, laptops, and PDAs). In a cloud computing architecture, a platform’s computing resources can be pooled to serve multiple consumers, partners or other third-party users using a multi-tenant model, with different physical and virtual resources dynamically assigned and reassigned according to demand. A cloud computing architecture is also configured such that platform resources can be rapidly and elastically provisioned, in some cases automatically, to quickly scale out and rapidly released to quickly scale in.

Cloud computing systems can be configured with systems that automatically control and optimize resource use by leveraging a metering capability at some level of abstraction appropriate to the type of service (e.g., storage, processing, bandwidth, and active user accounts). Resource usage can be monitored, controlled, and reported. As described herein, in embodiments, the system 200 is advantageously configured by the platform provider with innovative algorithms and database structures for carbon and GHG attribute management.

A Software as a Service (SaaS) platform is configured to allow a platform provider to use the provider’s applications running on a cloud infrastructure. The applications are accessible from various client devices through a thin client interface such as a web browser (e.g., web-based e-mail). The consumer typically does not manage or control the underlying cloud infrastructure including network, servers, operating systems, storage, or even individual application capabilities, with the possible exception of limited user-specific application configuration settings.

A cloud computing environment is service oriented with a focus on statelessness, low coupling, modularity, and semantic interoperability. At the heart of cloud computing is an infrastructure comprising a network of interconnected nodes.

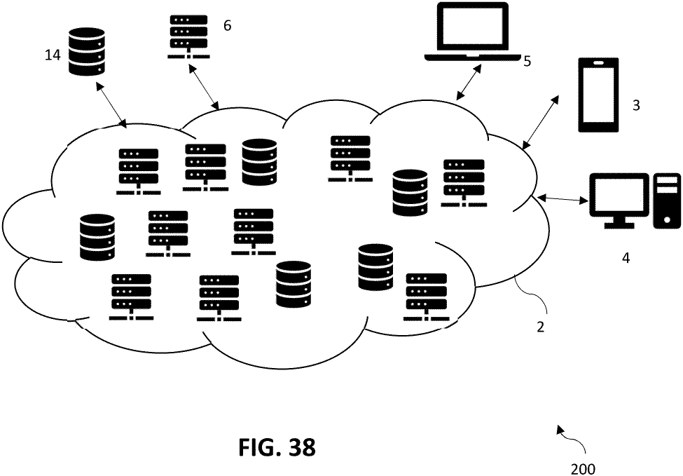

Referring now to FIG. 38 an illustrative cloud computing environment for the system 200 is depicted. As shown, cloud computing environment 100 comprises one or more cloud computing nodes 2 with which local computing devices used by cloud consumers, such as, for example, personal digital assistant (PDA) or cellular telephone 3, desktop computer 4, laptop computer 5, data source 14, and network computer 6. Nodes 2 can communicate with one another. They can be grouped (not shown) physically or virtually, in one or more networks, such as private, community, public, or hybrid clouds as described herein, or a combination thereof. The cloud computing environment 1 is configured to offer infrastructure, platforms and/or software as services for which a cloud consumer does not need to maintain resources on a local computing device. It is understood that the types of computing devices shown in FIG. 32 are intended to be illustrative only and that computing nodes 2 and cloud computing environment 1 can communicate with any type of computerized device over any type of network and/or network addressable connection (e.g., using a web browser).

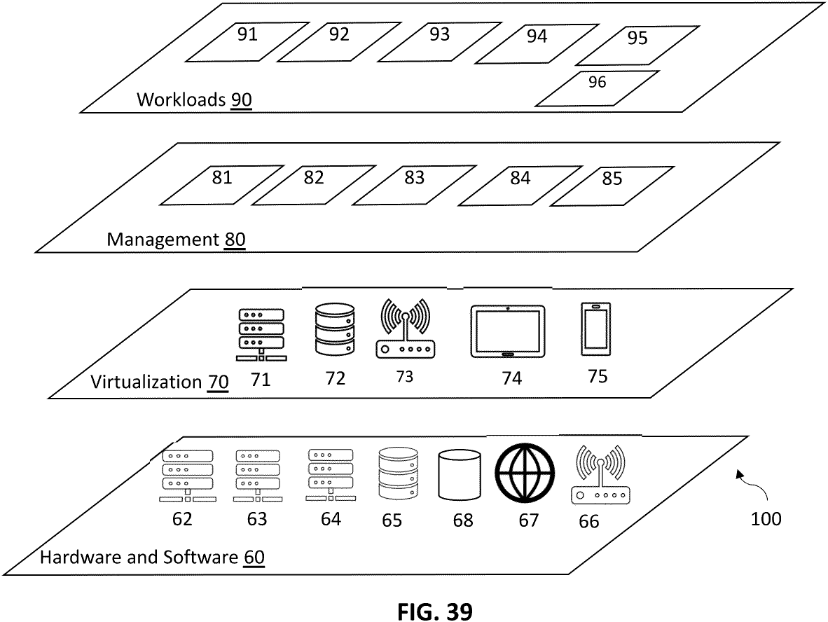

Referring now to FIG. 39, a set of functional abstraction layers provided by cloud computing environment 100 (FIG. 38) are shown. The components, layers, and functions shown in FIG. 33 are illustrative, and embodiments as described herein are not limited thereto. As depicted, the following layers and corresponding functions are provided.

A hardware and software layer 60 can comprise hardware and software components. Examples of hardware components include, for example: mainframes 61; servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management so that required service levels are met. Service Level Agreement (SLA) planning and fulfilment 85 provides pre-arrangement for, and procurement of, cloud computing resources for which a future requirement is anticipated in accordance with an SLA.

Workloads layer 90 provides examples of functionality for which the cloud computing environment can be utilized. Examples of workloads and functions that can be provided from this layer include mapping 91; input event processing 92, data stream processing 93; distributed immutable ledger interface 94; Carbon API 95; and data delivery 96.

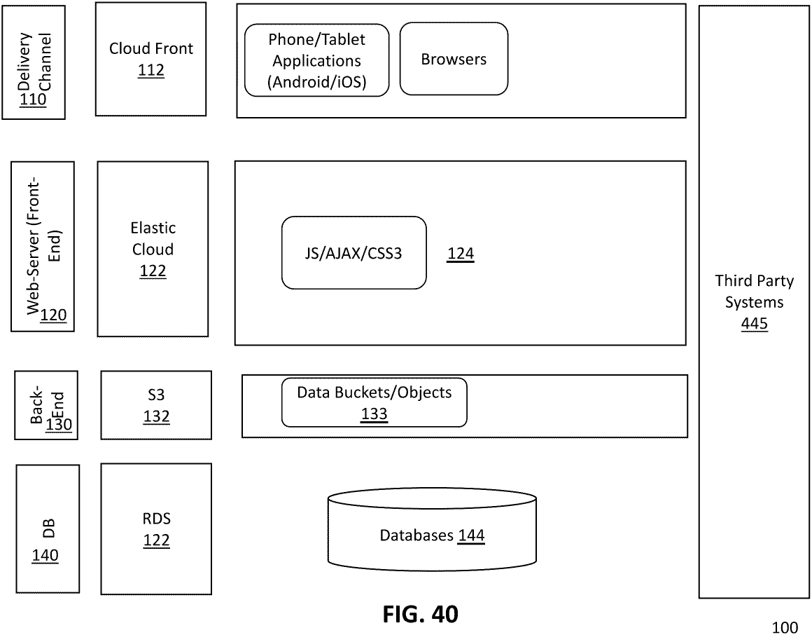

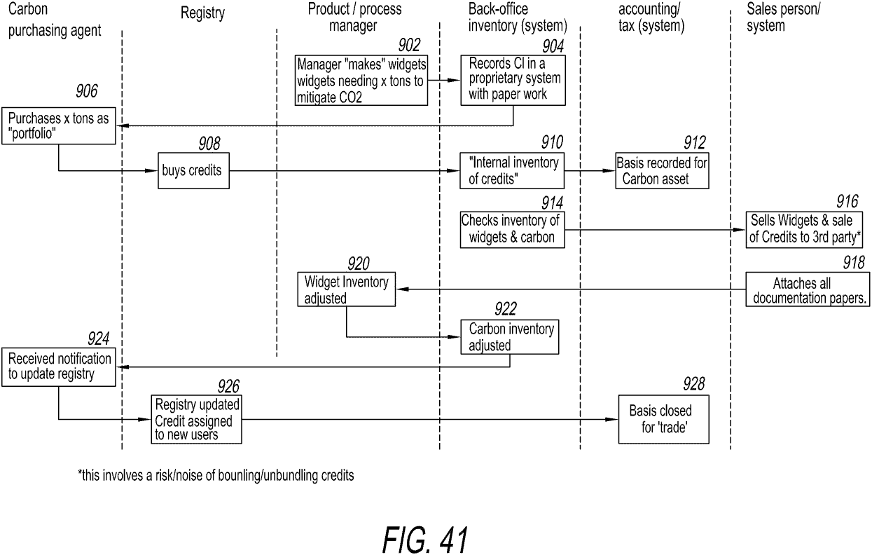

FIG. 40 shows the logical architecture for an embodiment. The system 200 can be built on an exemplary platform, for example, a Web Service platform or distributed immutable ledger platform which could be a blockchain, although other platforms for supporting application content delivery and network infrastructure can be employed. As shown in FIG. 40, a Delivery Channel tier 110 can be provided via a cloud front 112 to client computers. A front-end web server tier 120 can be built on an elastic cloud (EC2) architecture 122 and can provide front end interfaces, for example such as interfaces built on Angular JS 24 or other JS modules 124. The back-end tier 130 can be operatively connected to front end architecture tier by web sockets, and can be built on an S3 architecture 132 and include data buckets and objects 133 for web-scale data storage and retrieval, and the databases layer can include, for example, databases 144 on a Relational Database Structure tier architecture, or a distributed immutable ledger architecture. One or more third party systems 445 can be integrated or operatively connected to the architecture 100, which can include a blockchain as an external system.

Although this disclosure describes embodiments on a cloud computing platform, implementation of embodiments as described herein are not limited to a cloud computing environment.

In an implementation, the logical architecture can be integrated or built on a distributed immutable ledger architecture such as Blockchain, Hyperledger Fabric, Ethereum, and so on. In an implementation, the system can be configured to integrate with a distributed immutable ledger 202 or Blockchain. In an embodiment, carbon data transactions can be hashed with a unique hash as an identifier that is recorded, replicated, shared, and synchronized with a consensus of digital data logs that are spread across multiple sites without a central administrator. That said, in an implementation, the system can be configured as a managed blockchain, for example to integrate with a web service or platform host.

A distributed immutable ledger is a shared ledger that can be either public or private for recording the history of electronic business transactions that take place in a peer-to-peer (P2P) business network. A distributed immutable ledger network is a decentralized system for the exchange of assets and recording of transactions. A distributed immutable ledger network may use Proof of Work, Proof of Authority, delegated authority or another consensus mechanism, as a basis of trust, accountability, and transparency. In an embodiment, each permissioned node of the network has a replicated copy of the ledger, and within the network, all events on the ledger are synched across all nodes forming the network and are immutable, resulting in full transparency and data record integrity for all node members.

A transaction system for a distributed immutable ledger can include digital signatures, cryptographic hashes, a timestamp server, and a decentralized consensus protocol that member nodes use to agree on ledger content. In a public ledger, integrity, privacy, and security are engineered in. For example, a blockchain ledger is comprised of unchangeable, digitally recorded data in packages called blocks. These digitally recorded “blocks” of data are stored in a linear chain. Each block in the chain contains data (e.g., for a cryptocurrency transaction, or a smart contract executable), that is cryptographically hashed. The blocks of hashed data draw upon the previous block (which came before it) in the chain, ensuring all data in the overall “blockchain” has not been tampered with and remains unchanged. A distributed immutable ledger peer-to-peer network is resilient and robust thanks to its decentralized topology architecture. As member nodes join or leave the network dynamically, messages are exchanged between the network participants on a best-effort broadcast basis.

Exemplary distributed immutable ledger networks include Bitcoin, Ethereum, Ripple, Hyperledger, Stellar, IBM Blockchain, Algorand, Polygon, and other enterprise solutions.

Ethereum, for example, is a programmable distributed immutable ledger blockchain. Ethereum allows users to create their own operations of any complexity. In this way, the Ethereum distributed immutable ledger platform can support many different types of decentralized blockchain applications, including but not limited to cryptocurrencies and smart contracts. Ethereum comprises a suite of protocols that define a platform for decentralized applications. The platform comprises an Ethereum Virtual Machine (“EVM”), which can execute code of arbitrary algorithmic complexity. Developers can create applications that run on the EVM using friendly programming languages modelled on existing languages, for example, JavaScript and Python.

For another example, the IBM blockchain implementation called Hyperledger Fabric is configured users to create their own operations of any complexity. The permissioning in the Hyperledger Fabric network is native to the Hyperledger Fabric network. Instead of an architecture that allows anyone to participate by default, participants in any Hyperledger Fabric network must be granted permission to participate by a Root Certificate Authority. Hyperledger Fabric also allows the submission of transactions in channels; users can create and send transactions only to certain parties, and not to the network as a whole.

A distributed immutable ledger 202 or blockchain includes a peer-to-peer network protocol. A distributed immutable ledger database is maintained and updated by many nodes connected to a network. For example, nodes in the same network can run and execute the same instruction for massive parallelization of computing across the entire network. This maintains consensus and immutability for the transactions and events on the ledger. Decentralized consensus imbues the blockchain with high fault tolerance, ensures zero downtime, and makes data stored on the distributed immutable ledger forever unchangeable and censorship resistant.

Nodes can download a distributed immutable ledger application that provides a gateway to decentralized applications on a network blockchain. For example, a distributed immutable ledger application can be configured to hold and secure crypto assets built on the blockchain, as well as to code, deploy and employ, inter alia, self-executing smart contracts.

On the distributed immutable ledger network, users can set up a node that replicates the necessary data for all nodes to reach an agreement and be compensated by users. This allows user data to remain private and applications to be decentralized. A distributed immutable ledger can also enable developers create, inter alia, fully automated applications that, for example, store registries of debts or promises, send messages, move funds in accordance with predetermined instructions, including encoding those given long in the past (e.g., like a will or a futures contract).

Distributed immutable ledger server computers include virtually any network computer capable of sharing a ledger across a network and configured as a distributed immutable ledger node, including client computers and network computers as described herein. distributed immutable ledger server computers are distributed across one or more distinct network computers in a peer-to-peer architecture. Other configurations, and architectures are also envisaged.

In an embodiment, a distributed immutable ledger network can be private to the parties concerned, permissioned so only authorized parties are allowed to join, and can be secure using cryptographic technology to ensure that participants only see what they are allowed to see. The shared ledger is replicated and distributed across the networked computers. Transactions are immutable (unchangeable) and final. Computers that may be arranged to operate as distributed immutable ledger server computers include various network computers, including, but not limited to personal computers, desktop computers, multiprocessor systems, microprocessor-based or programmable consumer electronics, network PCs, server computers, network appliances, and the like.

One of ordinary skill in the art will appreciate that the architecture of system 200 is a non-limiting example that is illustrative of at least a portion of an embodiment. As such, more or less components can be employed and/or arranged differently without departing from the scope of the innovations described herein. System 200 is sufficient for disclosing at least the innovations claimed herein.

The operation of certain embodiments has described with respect to FIGS. 1-40. In at least one of various embodiments, processes described in conjunction with FIGS. 1-40, respectively, can be implemented by and/or executed on a single computer. In other embodiments, these processes or portions of these processes can be implemented by and/or executed on a plurality of computers. Embodiments are not limited, and various combinations of network computers, client computers, virtual machines, hardware devices or the like can be utilized.

It will be understood that each block of the flowchart illustrations, and combinations of blocks in the flowchart illustrations, can be implemented by computer program instructions. These program instructions can be provided to a processor to produce a machine, so that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the present innovations.

Accordingly, blocks of the flowchart illustration support combinations of ways for performing the specified actions, combinations of steps for performing the specified actions and program instruction means for performing the specified actions. It will also be understood that each block of the flowchart illustrations, and combinations of blocks in the flowchart illustrations can be implemented by special purpose hardware-based systems, which perform the specified actions or steps, or combinations of special purpose hardware and computer instructions. Special purpose hardware can include, but is not limited to, graphical processing units (GPUs) or AI accelerator application-specific integrated circuits. The foregoing example should not be construed as limiting and/or exhaustive, but rather, an illustrative use case to show an implementation of at least one of the various embodiments of the present innovations.

Primitive logical elements of the system of this disclosure are shown in FIG. 42. An object 101 is a software representation of a digital twin of a product or service having multiple attributes or descriptions. In the system, users can add and label as many attributes as they wish to make generic objects. Objects may be stored in FIG. 1 at item 206 Organization & user object libraries and at item 209 Defined Unit inventory. A LCI (life cycle inventory) 102 is a data record which comprises a set of greenhouse gases, the interpretations using GWP global warming potentials, and the sources of the data. LCI data records can be found in FIG. 1 at item 212 Public LCI library. Process (physical or logical) 103 is a modelling element for transforming one or more inputs into one or more outputs. A process can be physical such as baking a cookie using heat or it can be logical such as transforming the legal ownership, tax status, regulatory status or some other logical attribute of a product or service. Processes are stored in FIG. 1 at item 207 Process Library (public/private).

Assigning a LCI (life cycle inventory) CO2e (carbon dioxide equivalent) functional unit to an object is shown in FIG. 43 at item 101 is a digital twin record of a real-world object. Item 102 is the LCI data associated with a similar or canonical reference object similar to the real-world object. The LCI data is found in FIG. 1 at item 212 Public LCI library. Item 103 is the process of linking the digital twin and the reference object together. Item 104 is the attribute which has a calculated CO2e derived from the quantity of the digital twin and the LCI data.

A system for combining any mix of objects and processes to determine the process emissions associated with a terminal object representing a product or service is shown in FIG. 44. Objects 101 represent input(s) into a process. These objects may be products or services (like electricity/energy) associated with CO2e. Process 102 takes in the combined CO2e from the input(s) and allocated the CO2e to output(s) using accepted allocation rules to conserve the systems associated CO2e. These rules could include, but are not limited to, economic value weighting, mass-based allocations, or other generally accepted CO2e allocation methods. A process output object 103 example shows 1 KG/ CO2e allocated. A process output object 104 represents one or multiple outputs with 2 KG CO2e allocated to it. A logical process 105 adds 2 KG CO2e which may involve another actor in the supply chain. Output 106 is from an output allowing for the calculation and summation of all the initial objects appropriately allocated for the terminal objects 2 KG/ CO2e values and the associated process values to create a net declared CO2e value for the terminal object (product or service).

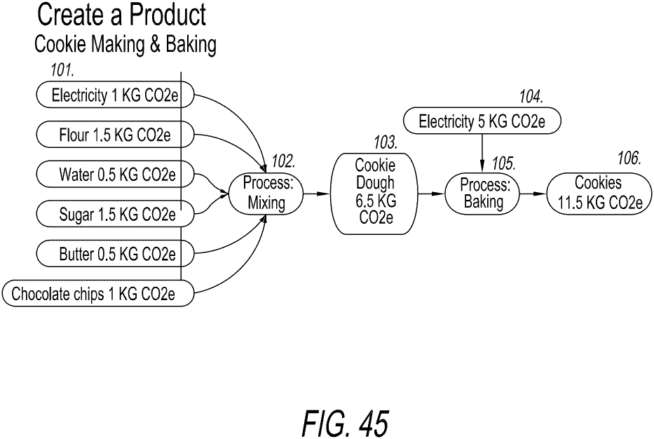

Creating a product’s CO2e footprint using a digital carbon twin to model a mix of products, services, and processes across a value chain is shown in FIG. 45. Ingredient objects 101 are objects with different CO2e values. These object inputs to the process would be found in FIG. 1. At item 206 Organization & user object libraries public/private. The process 102 involves mixing ingredients together. The process data is found in FIG. 1 at item 207 Process Library (public/private). Item 103 is the resultant output of process 102 which reflects the summation and allocation of prior CO2e factors. Output objects from the process are stored in FIG. 1 at item 206 Organizations & user object libraries public/private. Item 104 is an object representing electricity services consumed in the baking process with the cookie dough 103. The process 105 of baking combines input CO2e’s factor to produce output product(s). The process data is found in FIG. 1 at item 207 Process Library (public/private). The terminal output product(s) 106 has a calculated 11.5 KG CO2e associated. These object outputs from the process would be found in FIG. 1 at item 206 Organization & user object libraries public/private.

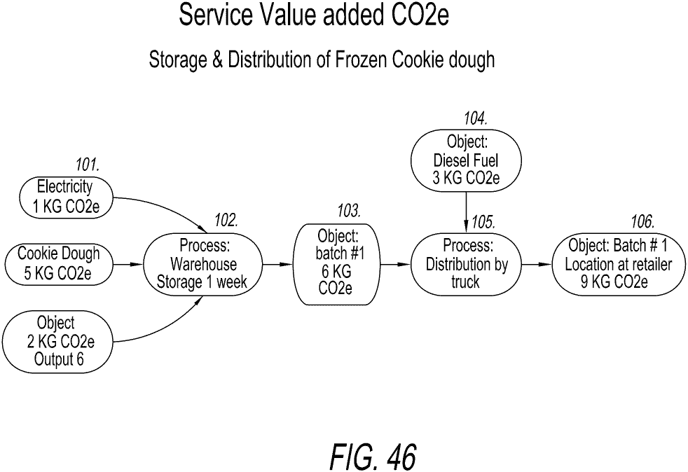

Creating a digital carbon twin to track CO2e of a service using multiple objects and processes in a model is shown in FIG. 46. Multiple input products and services 101 are inputs to a process. These object inputs to the process would be found in FIG. 1 at item 206 Organization & user object libraries public/private. A process warehouse storage 102 may require energy, etc. and have a duration all associated with CO2e that can be assigned to an output(s). An output object 103 has the cumulative and correct allocated CO2e associated with it. These output objects to the process would be found in FIG. 1 at item 206 Organization & user object libraries public/private. Item 104 is an energy object input for a process (distribution by truck). Item 105 is a process combining 104 diesel fuel and an object Batch #1 of cookies to create an output product. The process data is found in FIG. 1 at item 207 Process Library (public/private). An output product object 106 shows the stored and transported cookie dough Batch #1 with the distribution CO2e added to the digital twin.

Special objects associated with managing and sharing the declared CO2e of products and services across various owner’s supply chains and process transformations are shown in FIG. 47. A carbon instrument 101 is used to attest to environmental actions related to avoiding, reducing, removing, or declaring the embodied net declared CO2e associated with an object (product or service) in the system. A digital certificate 102 holds all of the data and substantiating documentation to support the environmental claims of a specific product or service and it’s legal owner. The digital certificate has an “owner” attribute assigned to a real-world product or service owned or delivered by a legal entity.

Attaching a carbon related instrument or declaration to an object using a special process is shown in FIG. 48. Item 101 is a software object representing a real-world product or service with associated CO2e data linked. Item 102 is an assignment or digital claim of environmental rights or assignable declaration of CO2e related facts. It can be a carbon credit, removal instrument, compliance instrument, or CO2e related declaration associated with a physical product or service like a renewable energy credit (REC). A process in software 103 is where the carbon instrument 102 is logically associated for declarative purposes with a 101 object. The combination of these facts is incorporated into a recordable digital certificate 104 that can be transferred, recorded, or presented to third parties as a statement of net CO2e facts associated with a product or service. Item 105 is an example of a product (e.g., cookie dough) with CO2e associated with its production up to a point in time. Item 106 is an example of a carbon instrument rights assignment (credit) representing 1 ton of CO2e removed from the atmosphere. Item 107 is the logical linking of the ton of CO2e removed with the 1 ton of CO2e associated with the cookie dough object. The combined statement of facts in digital certificate(s) form 108 which can be represented as a single amount of cookie dough or broken into multiple certificates with the embodied carbon and the instrument related carbon allocated in a proportional way to each object.

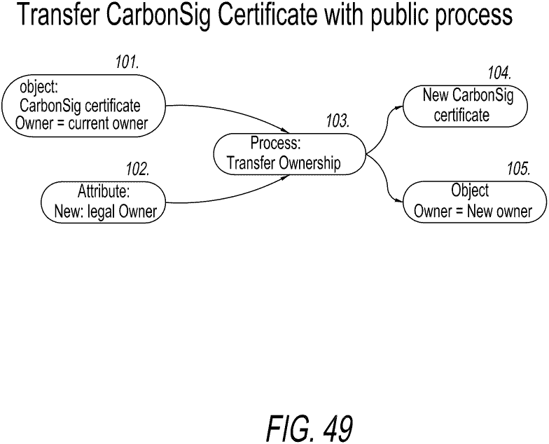

Transferring environmental process claims associated with an object (i.e., process or service) representing a digital carbon twin to a third party who then owns the environmental claims is shown in FIG. 49. Item 101 is a digital certificate reflecting the cradle to gate provenance of a product or service and its associated environmental claims which may include carbon related instruments (e.g., credits, removals, offsets, etc.). Item 102 is an attribute that can be appended to the certificate establishing a “chain” of custody or ownership of the associated digital carbon twin certificate(s). Item 103 is the process by which the new legal owner is concatenated and added on to the certificate to reflect the provenance of the certificate and ascertain the new ownership. A newly generated digital certificate 104 reflects the new owner of the carbon digital twin. Item 105 is a software object output which exists in the inventory of a new owner certificates may be split or if of a similar type merged by the owner user of the system.

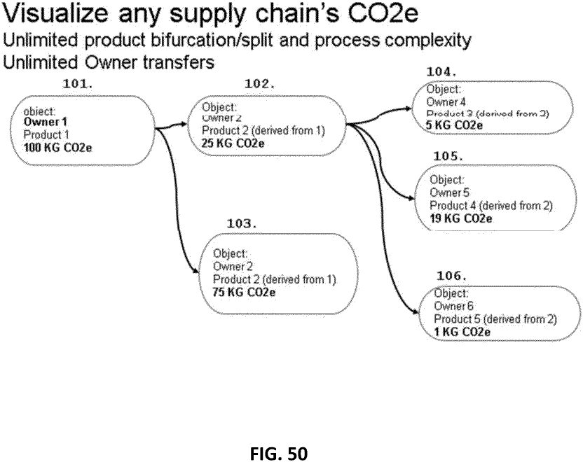

The ability to visualize any product or service’s provenance of CO2e declarations is shown in FIG. 50. Item 101 is the origin declaration of CO2e for a product or service which may begin at the start or mid-section of a supply chain. The origin declaration includes all related CO2e data including carbon instrument up to the point and time of the declaration. An example of object transfers across organizations are found in FIG. 31, items 751, 752, 753, 754, and 755. Item 102 is a digital twin representing a portion of the original object transferred to a new owner. Item 103 is a digital twin representing the remaining portion or portions of an original object transferred to new owner(s). Item 104 is a digital twin representing a derived object from 102, plus any CO2e associated with value added by the owner of 102. Item 105 is a digital twin representing a derived object from 102, plus any CO2e associated with value added by the owner of 102. Item 106 is a digital twin representing the object from 102, plus any CO2e associated with value added by the owner of 102.

Adding value to a product or service by managing the net declared CO2e across supply chains for multiple end products is shown in FIG. 51. Item 101 is a carbon declaration instrument (e.g., renewable energy credit) attached to an electricity object to attest to low carbon intensity. Item 102 shows inputs into creating a managed raw aluminum, including physical raw materials and services (e.g., bauxite, KOH Potassium hydroxide, electricity services) and an environmental declaration via an environmental instrument in this case a REC (renewable energy credit). The process 103 combines the objects and declarations found in 101, to create a new carbon managed output. Item 104 is a carbon managed output object which includes the CO2e associated with previous objects embodied CO2e and any environmental instruments or declarations to create a net declared CO2e carbon managed digital twin. Item 105 is the process by which a certificate of all the environmental and digital twin facts are transferred to a new owner. An example of object certificate transfers across organizations are found in FIG. 31, items 751, 752, 753, 754, and 755. Item 106 is the electricity service added to a process of producing aluminum cans from the carbon managed object 103.Item 107 is the process of combining the electricity associated CO2e with the 104 ingot to produce multiple output objects and associated digital twin certificates. One or multiple certificates 108 represent the digital provenance of embodied CO2e, related carbon instruments and declarations plus a net CO2e figure for the terminal product(s) that could be 50,000 cans.

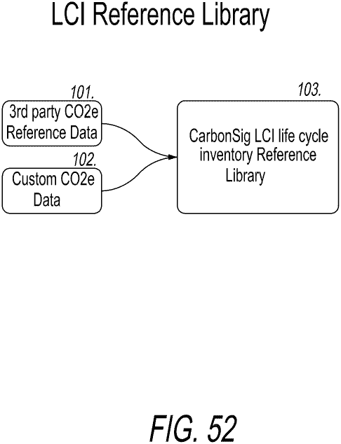

The LCI Reference library for maintaining private, public, and declared reference and specific product embodied carbon facts is shown in FIG. 52. Item 101 is third party reference embodied carbon related data which is accessible to the system users, and may be associated with an object (i.e., product or service) to derive a CO2e for that object. Item 102 is custom CO2e data which is created by system users and made available to the public for use which may be product or service specific. Item 103 is the CarbonSig LCI Life cycle inventory Reference Library shown in FIG. 6, item 212 Public LCI library.

A method of keeping and using third party and custom LCI (life cycle inventory) embodied, and net declared CO2e data is shown in FIG. 53. Item 101 is third party greenhouse gas related data. Item 102 is a data repository housing 101, and user provided LCI data. Item 102 also houses global warming potential look-up tables, and a translation engine to derive a net declared CO2e based on the GWP required by the user. The Global LCI library & services is found in FIG. 1, item 212 Public LCI library. Item 103 is the LCI library available to local users of the system which may include private (non-public) embodied carbon related data. The local LCI library & services is found in FIG. 1, item 212 Public LCI library. Object inventory library 104 houses the generic object with embodied declared CO2e. Item 105 is the object inventory of “assembled objects”, i.e., objects which have been run through a process that alters their embodied carbon and/or some other attributes of the object. A carbon certificate 106 comprises the embodied carbon associated with all historical processes used in assembling 105, and any carbon instruments associated with assembling the terminal object 105. The certificate 106 also includes a net declared CO2e factor combining the embodied CO2e less any carbon instruments associated with the object. The CarbonSig certificate is found in FIG. 1, item 213 Public GHG report which is found in the system with a duplicate data record or unique hash stored on the FIG. 1, item 202 Blockchain/DLT recording. FIG. 25 also highlights the blockchain implementation.

The following are preferred embodiments of this disclosure.

Embodiment 1. A system comprising input and a memory including non-transitory program memory for storing at least instructions and a processor that is operative to execute instructions that enable actions, the system comprising:
a subsystem configured to generate extensible carbon objects, said subsystem comprising an application programming interface (API) gateway server between a logical layer and a representational layer, the API gateway server being configured with an extensible Carbon Reporting Markup Language (<CarML>) configured to interface software with the logical layer, the <CarML> comprising a core set of common data schema and message types including interface objects for extensible carbon objects, and third party external systems, the API gateway server configured to allow the user to generate an extensible carbon object representing a carbon instrument; and
a Life Cycle Inventory (LCI) library database configured to store an environmental embodied CO2e record for a cradle to gate life cycle of an item or process, based on the process inputs and outputs of one or more Reference Units and one or more Defined Units.

Embodiment 2. The system of embodiment 1, which is configured to generate a report expressed as a unique transferrable certificate representing the carbon life cycle of the carbon object from the LCI representing an embodiment associated with a real-world digital twin of a physical product or service.

Embodiment 3. The system of embodiment 1, wherein the logical layer comprises a plurality of library modules for monitoring and tracking carbon emissions, said plurality of library modules comprising:
a process library comprising a user interface to an external client; and
a Reference Unit Library comprising an extensible absolute unit reference manager to instantiate and store the Reference Unit object, wherein the Reference Unit object comprises a unit of emission datum.

Embodiment 4. The system of embodiment 3, wherein the Reference Unit Library comprises a conversion algorithm configured to convert data values to base units associated with the Reference Units.

Embodiment 5. The system of embodiment 3, wherein said plurality of library modules further comprises:
an Attribute Library comprising a plurality of extensible attribute objects configured to include a plurality of attribute dimensions including a dimensional structure for the Reference Units and the Defined Units, the attribute dimensions comprising the environmental CO2e related attribute data, and <CarML> attributes.

Embodiment 6. The system of embodiment 1, wherein the logical layer further comprises:
a relational database comprising a database for carbon data transactions, wherein the relational database comprises a distributed immutable ledger.

Embodiment 7. The system of embodiment 1, further comprising a display layer interface comprising:
a display manager user interface configured to allow a user to input data to a storage and compute layer; and
a report manager, the report manager being configured to generate a greenhouse gas (GHG) cradle to gate life cycle for an item or process as a structured data object and a machine-readable code associated with a Defined Unit, as a legally transferrable and legally assignable certificate recorded to a public system of record.

Embodiment 8. The system of embodiment 1, which is configured to encode carbon emissions and removals for a carbon life cycle analysis (LCA) to the extensible carbon object.

Embodiment 9. The system of embodiment 1, which is configured to encode searchable carbon objects that are stored to a searchable greenhouse gas (GHG) database and reporting module.

Embodiment 10. A method of embodied CO2e management of a product or service over a cradle to gate life cycle of the product or service, said method comprising:
providing a system comprising input and a memory including non-transitory program memory for storing at least instructions, a processor that is operative to execute instructions that enable actions; a subsystem comprising an application programming interface (API) gateway server between a logical layer and a representational layer, third party external systems; and a Life Cycle Inventory (LCI) library database;
configuring the subsystem to generate extensible carbon objects;
configuring the API gateway server to support an extensible Carbon Reporting Markup Language <CarML>;
configuring the <CarML> message types, variables and unique identifiers (UIDs) to interface software with the logical layer or third party external system, the <CarML> comprising a core set of common public extensible data schema, message types, variables and UID’s including interface objects for extensible carbon objects;
configuring the API gateway server to allow a user to generate an extensible carbon object certificate for a carbon instrument;
configuring the LCI library database to store an environmental embodied CO2e record for the cradle to gate life cycle of the product or service, based on the process inputs and outputs of one or more Reference Units and one or more Defined Units; and
generating an embodied CO2e cradle to gate life cycle analysis (LCA) of the product or service from the LCI library database, at any point in time during the life cycle of the product or service.

Embodiment 11. The method of embodiment 10, further comprising:
configuring the system to generate a report expressed as a unique transferrable certificate representing the embodied CO2e cradle to gate life cycle of the carbon object from the LCI representing an embodiment associated and digitally twinned with a real-world physical product or service.

Embodiment 12. The method of embodiment 10, wherein the logical layer comprises a plurality of library modules for monitoring and tracking carbon emissions, said plurality of library modules comprising:
a process library comprising a user interface to an external client; and
a Reference Unit Library comprising an extensible absolute unit reference manager to instantiate and store the Reference Unit object, wherein the Reference Unit object comprises a unit of emission datum.

Embodiment 13. The method of embodiment 12 further comprising:
configuring a conversion algorithm of the Reference Unit Library to convert data values to base units associated with the Reference Units.

Embodiment 14. The method of embodiment 12 further comprising:
configuring an Attribute Library comprising a plurality of extensible attribute objects to include a plurality of attribute dimensions including a dimensional structure for the Reference Units and the Defined Units, the attribute dimensions comprising the environmental carbon attribute data.

Embodiment 15. The method of embodiment 10, wherein the logical layer further comprises:
a relational database comprising a database for carbon data transactions, wherein the relational database comprises a distributed immutable ledger.

Embodiment 16. The method of embodiment 10 further comprising:
configuring a display manager user interface to allow a user to input data to a storage and compute layer; and
configuring a report certificate manager to generate a greenhouse gas (GHG) embodied CO2e cradle to gate life cycle digital twin for an item or process as a structured data object certificate which has a machine-readable code associated with a Defined Unit, and can be recorded to a public ledger.

Embodiment 17. The method of embodiment 10 further comprising:
configuring the system to encode carbon emissions and removals for an embodied CO2e cradle to gate life cycle analysis (LCA) to the extensible carbon object.

Embodiment 18. The method of embodiment 10 further comprising:
configuring the system to encode searchable carbon objects that are stored to a searchable greenhouse gas (GHG) database and reporting module.

Embodiment 19. A method of gathering, accounting, recording, offering, tracking and/or displaying of embodied CO2e of a product or service over a cradle to gate life cycle of the product or service, said method comprising:
providing a system comprising input and a memory including non-transitory program memory for storing at least instructions, a processor that is operative to execute instructions that enable actions; a subsystem comprising an application programming interface (API) gateway server between a logical layer and a representational layer, third party external systems; and a Life Cycle Inventory (LCI) library database;
configuring the subsystem to generate extensible carbon objects;
configuring the API gateway server to support an extensible Carbon Reporting Markup Language <CarML>;
configuring the <CarML> message types, variables and unique identifiers (UIDs) to interface software with the logical layer or third party external system, the <CarML> comprising a core set of common public extensible data schema, message types, variables and UID’s including interface objects for extensible carbon objects;
configuring the API gateway server to allow a user to generate an extensible carbon object certificate for a carbon instrument;
configuring the LCI library database to store an environmental embodied CO2e record for the cradle to gate life cycle of the product or service, based on the process inputs and outputs of one or more Reference Units and one or more Defined Units; and
generating an embodied CO2e cradle to gate life cycle analysis (LCA) of the product or service from the LCI library database, at any point in time during the life cycle of the product or service.

Embodiment 20. The method of embodiment 19 which can be conducted across any supply chain path or value adding processes.

Embodiment 21. A system comprising input and a memory including non-transitory program memory for storing at least instructions and a processor that is operative to execute instructions that enable actions, the system comprising:
a logical layer comprising a plurality of library modules for capturing, monitoring, tracking, and publicly declaring carbon emission data as a digital twin associated with a real world product or service, including:
   a process library comprising a user interface to an external client;
   a Reference Unit Library comprising an extensible absolute unit reference manager to instantiate and store a Reference Unit object, the Reference Unit object comprising a unit of emission datum;
   a Defined Unit Inventory configured to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data;
   an Attribute Library comprising a plurality of extensible attribute objects configured to include a plurality of attribute dimensions including a dimensional structure for the Reference Units and the Defined Units, the attribute dimensions comprising the environmental carbon attribute data and <CarML> tags; an application programming interface (API) gateway between a logical layer and a representational layer, the API gateway server being configured with an extensible Carbon Reporting Markup Language (CarML) configured to interface software with logical layer, the CarML comprising a core set of common data schema and message types including interface objects for extensible carbon objects, and third party external systems.

Embodiment 22. The system of embodiment 21, wherein the library modules further comprise:
a Conversion Library comprising extensible conversion information for the environmental carbon attribute data and comprising a conversion algorithm configured to convert data values to base units associated with the Reference Units conversion library;

Embodiment 23. The system of embodiment 21, wherein the library modules further comprise:
a Life Cycle Inventory (LCI) library database configured to store an environmental embodied CO2e record for a cradle to gate life cycle of an item or process, based on the process inputs and outputs of the Reference Units and the Defined Units.

Embodiment 24. The system of embodiment 21, wherein the system further comprises:
a relational database comprising a database for carbon data transactions; and
a distributed immutable ledger.

Embodiment 25. The system of embodiment 21 further comprising a display layer interface comprising:
a display manager user interface configured to allow a user to input data to a storage and compute layer; and
a report manager, the report manager being configured to generate a GHG life cycle digital twin for an item or process as a structured data object report or assignable certificate which has a machine-readable code associated with a Defined Unit, and can be recorded to a public ledger.

Embodiment 26. The system of embodiment 21, wherein extensible attribute objects further comprise:
an import attribute configured to import an attribute into a client user’s Attribute Library;
a create new attribute object configured to create a new attribute type for an attribute library;
a modify attribute object configured to allow a user to modify an attribute, wherein each version of the attribute object is stored on the system;
an archive attribute configured to remove an attribute from a library, depreciate objects associated with the attribute, and alert users to the depreciation;
a copy attribute object; and
a designate attribute object configured to designate an object as a unit of measurement and/or <CarML> compliant attributes.

Embodiment 27. The system of embodiment 26, wherein an attribute object designated as a unit of measurement (UoM) attribute is configured be selected as key UoM for an object or as a functional UoM for an LCI.

Embodiment 28. The system of embodiment 21, wherein system is configured to encode carbon emissions and removals for a carbon life cycle analysis (LCA) to the extensible carbon object.

Embodiment 29. The system of embodiment 21, wherein the system is configured to encode searchable carbon objects, as reports and assignable certificates, that are stored to a searchable greenhouse gas database and reporting certificate module, and act as a system of public record.

Embodiment 30. A method of gathering, accounting, recording, tracking, displaying and/or transferring of embodied CO2e of a product or service as an assignable certificate, said method comprising:
providing a system comprising input and a memory including non-transitory program memory for storing at least instructions and a processor that is operative to execute instructions that enable actions; a logical layer comprising a plurality of library modules for capturing, monitoring, tracking, and publicly declaring carbon emission data as a digital twin associated with a real world product or service; an application programming interface (API) gateway between a logical layer and a representational layer, the API gateway server being configured with an extensible Carbon Reporting Markup Language (CarML) configured to interface software with logical layer, the CarML comprising a core set of common data schema and message types including interface objects for extensible carbon objects, and third party external systems; wherein the plurality of library modules includes:
   a process library comprising a user interface to an external client;
   a Reference Unit Library comprising an extensible absolute unit reference manager to instantiate and store a Reference Unit object, the Reference Unit object comprising a unit of emission datum;
   a Defined Unit Inventory; and
   an Attribute Library comprising a plurality of extensible attribute objects;
configuring the Defined Unit Inventory to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data;
configuring the Attribute Library to include a plurality of attribute dimensions including a dimensional structure for the Reference Units and the Defined Units, the attribute dimensions comprising the environmental carbon attribute data and <CarML> tags; and
configuring a report manager to generate an embodied CO2e life cycle of a product or service as a structured data object report or assignable certificate which has a machine-readable code associated with the Defined Unit, and can be recorded to a public ledger.

Embodiment 31. The method of embodiment 30, wherein the environmental carbon attribute data comprises one or more of carbon credits, offsets, or other mitigation instruments.

Embodiment 32. The method of embodiment 30, wherein the environmental carbon attribute data is used to reduce the declared embodied CO2e of a product or service.

Embodiment 33. The method of embodiment 30, wherein the library modules further comprise:
a Conversion Library comprising extensible conversion information for the environmental carbon attribute data and comprising a conversion algorithm.

Embodiment 34. The method of embodiment 33 further comprising:
configuring the conversion algorithm to convert data values to base units associated with the Reference Units conversion library.

Embodiment 35. The method of embodiment 30, wherein the library modules further comprising a Life Cycle Inventory (LCI) library database.

Embodiment 36. The method of embodiment 35 further comprising:
configuring the Life Cycle Inventory (LCI) library database to store an environmental embodied CO2e record for a cradle to gate life cycle of an item or process, based on the process inputs and outputs of the Reference Units and the Defined Units.

Embodiment 37. The method of embodiment 30, wherein the system further comprises:
a relational database comprising a database for carbon data transactions; and
a distributed immutable ledger.

Embodiment 38. The method of embodiment 30 wherein the system further comprises a display layer interface.

Embodiment 39. The method of embodiment 38 further comprising:
configuring the display layer interface to allow a user to input data to a storage and compute layer.

Embodiment 40. The method of embodiment 30, wherein extensible attribute objects further comprise one or more of an import attribute, a create new attribute object, a modify attribute object, an archive attribute, a copy attribute object, and a designate attribute object.

Embodiment 41. The method of embodiment 40 further comprising one or more of:
configuring the import attribute to import an attribute into a client user’s Attribute Library;
configuring the create new attribute object to create a new attribute type for an attribute library;
configuring the modify attribute object to allow a user to modify an attribute, wherein each version of the attribute object is stored on the system;
configuring the archive attribute to remove an attribute from a library, depreciate objects associated with the attribute, and alert users to the depreciation; and
configuring the designate attribute object to designate an object as a unit of measurement and/or <CarML> compliant attributes.

Embodiment 42. The method of embodiment 30 further comprising:
configuring an attribute object designated as a unit of measurement (UoM) attribute to be selected as key UoM for an object or as a functional UoM for an LCI.

Embodiment 43. The method of embodiment 30 further comprising:
configuring the system to encode carbon emissions and removals for a carbon life cycle analysis (LCA) to the extensible carbon object.

Embodiment 44. The method of embodiment 30 further comprising:
configuring the system to encode searchable carbon objects, as reports and assignable certificates, that are stored to a searchable greenhouse gas database and reporting certificate module, and act as a system of public record.

Embodiment 45. A system comprising input and a memory including non-transitory program memory for storing at least instructions and a processor that is operative to execute instructions that enable actions, the system comprising:
a system configured to generate extensible carbon objects representing real world products and services including the use of carbon instruments and related environmental certificates comprising an application programming interface (API) gateway between a logical layer and a representational layer, the API gateway server being configured with an extensible Carbon Reporting Markup Language (CarML) configured to interface software with the logical layer, the CarML comprising a core set of common data schema and message types including interface objects for extensible carbon objects and third party external systems, the API gateway configured to allow the user to generate the extensible carbon objects representing carbon instruments;
a registry;
an interface to a legacy registry systems for tracking carbon instruments, environmental certificates, or other related carbon data,
a platform comprising a ledger configured for tracking and assigning extensible carbon objects for carbon instruments, the trading platform comprising:
   an interface tool for transacting for carbon instruments;
   wherein the ledger is a distributed immutable ledger or blockchain.

Embodiment 46. The system of embodiment 45, wherein the ledger is configured to:
record an extensible carbon object digital twin comprising a CO2e life cycle inventory (LCI);
accept a carbon transaction comprising an extensible carbon object including a carbon offset, credit, removal, environmental certificate, or environmental instrument for the CO2e LCI;
record the carbon offset to generate a lower CO2e LCI object;
record a transfer of the lower carbon LCI to another entity; and
record a retirement of the lower CO2e LCI.

Embodiment 47. The system of embodiment 45 which is configured to generate a report or assignable public certificate of the embodied CO2e over a cradle to gate life cycle of the carbon object associated with a real world product or service.

Embodiment 48. The system of embodiment 45, wherein the system comprises a Defined Unit Inventory configured to inventory a Defined Unit for a tenant member user entity as a digital twin of a real world product or service, the Defined Unit being configured to deplete as an input, wherein the Defined Unit is configured to be inputted and outputted across a plurality of tenant member user entities carbon adding processes as a concatenation of carbon process data, the Defined Unit Inventory comprising environmental carbon attribute data, and the system is configured to execute instructions to at least:
to initiate a transfer of ownership of a defined object from a tenant member Defined Unit inventory to another tenant member entity Defined Unit inventory;
record the Defined Unit transfer to the distributed immutable ledger or blockchain.

Embodiment 49. The system of embodiment 48, wherein the initiate transfer operation is configured to place the Defined Unit object certificate in a transfer state for the Defined Unit object certificate transfer.

Embodiment 50. The system of embodiment 49, wherein the Defined Unit transfer state digital CO2e twin certificate comprises a plurality of transfer states including an open market offered state, a transfer to another part initiated state, a pending transfer state, and an accepted transfer state, wherein the recipient takes legal possession of the assignable environmental embodiments associated with the certificate.

Embodiment 51. The system of embodiment 50, wherein the system is configured to change an object owner attribute for on object when the Defined Unit is legally transferred from tenant to another tenant, and publicly registered in the system, with the system acting as a public system of record.

Embodiment 52. The system of embodiment 45 further comprising:
a logical layer comprising a plurality of library modules for monitoring and tracking CO2e emissions, including:
   a Process Library comprising a user interface to an external client
   a Reference Unit Library comprising an extensible absolute unit reference manager to instantiate and store a Reference Unit object, the Reference Unit object comprising a unit of CO2e emission associated datum, the Reference Unit Library comprising a conversion algorithm configured to convert data values to base units associated with the Reference Units;
   an Attribute Library comprising a plurality of extensible attribute objects configured to include a plurality of attribute dimensions including a dimensional structure for the Reference Units and the Defined Units, the attribute dimensions comprising the environmental carbon attribute data.
   a LCI library database configured to store an environmental embodied CO2e record for the cradle to gate life cycle of an item or process, based on the process inputs and outputs of the Reference Units and the Defined Units;
   a searchable greenhouse gas equivalence database and reporting module;
a relational database comprising a database for carbon data transactions;
a distributed immutable ledger or blockchain;
a conversion library comprising extensible conversion information for the environmental carbon equivalence attribute data;
a display layer interface comprising
   a display manager user interface configured to allow a user to input data to a storage and compute layer; and
   a report manager, the report manager being configured to generate a GHG life cycle report or assignable certificate twinned with an item or process, as a structured data object and a machine-readable code associated with a Defined Unit.

Embodiment 53. A method of gathering, accounting, recording, tracking, and displaying embodied CO2e of a product or service as a report or assignable certificate recorded in a registry, said method comprising:
providing system comprising input and a memory including non-transitory program memory for storing at least instructions and a processor that is operative to execute instructions that enable actions; an application programming interface (API) gateway between a logical layer and a representational layer, the API gateway server being configured with an extensible Carbon Reporting Markup Language (CarML) configured to interface software with the logical layer, the CarML comprising a core set of common data schema and message types including interface objects for extensible carbon objects and third party external systems, the API gateway configured to allow the user to generate the extensible carbon objects representing carbon instruments; a registry; an interface to a registry system for tracking carbon instruments, environmental certificates, or other related carbon data; and a platform comprising a distributed immutable ledger or blockchain having an interface tool for transacting for carbon instruments;
configuring the system to generate extensible carbon objects representing real world products and services including the use of carbon instruments and related environmental certificates;
configuring the platform for tracking and assigning extensible carbon objects representing carbon instruments; and
configuring a report manager to generate an embodied CO2e life cycle of a product or service as a structured data object report or assignable certificate which has a machine-readable code associated with a Defined Unit, and recorded in the registry.

Embodiment 54. The method of embodiment 53 further comprising configuring the distributed immutable ledger or blockchain to:
record an extensible carbon object digital twin comprising a CO2e life cycle inventory (LCI);
accept a carbon transaction comprising an extensible carbon object including a carbon offset, credit, removal, environmental certificate, or environmental instrument for the CO2e LCI;
record the carbon offset to generate a lower CO2e LCI object;
record a transfer of the lower carbon LCI to another entity; and
record a retirement of the lower CO2e LCI.

Embodiment 55. The method of embodiment 53 further comprising configuring the system to generate a report or assignable public certificate of the embodied CO2e over a cradle to gate life cycle of the carbon object associated with a real world product or service, recorded in the registry.

Embodiment 56. The method of embodiment 53, wherein the system further comprises a Defined Unit Inventory comprising environmental carbon attribute data.

Embodiment 57. The method of embodiment 56 further comprising:
configuring the Defined Unit Inventory to inventory a Defined Unit for a tenant member user entity as a digital twin of a real world product or service;
configuring the Defined Unit to deplete as an input;
configuring the Defined Unit to be inputted and outputted across a plurality of tenant member user entities, carbon adding processes, as a concatenation of carbon process data, the Defined Unit Inventory comprising environmental carbon attribute data; and
configuring the system to execute instructions to at least:
to initiate a transfer of ownership of a defined object from a tenant member Defined Unit inventory to another tenant member entity Defined Unit inventory; and
record the Defined Unit transfer to the distributed immutable ledger or blockchain.

Embodiment 58. The method of embodiment 57 further comprising configuring the initiate transfer operation to place the Defined Unit object certificate in a transfer state for the Defined Unit object certificate transfer.

Embodiment 59. The method of embodiment 58, wherein the Defined Unit transfer state digital CO2e twin certificate comprises a plurality of transfer states including an open market offered state, a transfer to another part initiated state, a pending transfer state, and an accepted transfer state, wherein the recipient takes legal possession of the assignable environmental embodiments associated with the certificate.

Embodiment 60. The method of embodiment 59 further comprising configuring the system to change an object owner attribute for on object when the Defined Unit is legally transferred from tenant to another tenant, and publicly registered in the system, with the system acting as a public system of record.

Embodiment 61. The method of embodiment 53, wherein the system further comprises:
a logical layer comprising a plurality of library modules for monitoring and tracking CO2e emissions, including:
   a Process Library comprising a user interface to an external client;
   a Reference Unit Library comprising an extensible absolute unit reference manager to instantiate and store a Reference Unit object, the Reference Unit object comprising a unit of CO2e emission associated datum, the Reference Unit Library comprising a conversion algorithm;
   an Attribute Library comprising a plurality of extensible attribute objects;
   a LCI library database;
   a searchable greenhouse gas equivalence database and reporting module;
a relational database comprising a database for carbon data transactions;
a distributed immutable ledger or blockchain;
a conversion library comprising extensible conversion information for the environmental carbon equivalence attribute data;
a display layer interface comprising
   a display manager user interface; and
   a report manager.

Embodiment 62. The method of embodiment 53 further comprising:
configuring the conversion algorithm to convert data values to base units associated with the Reference Units;
configuring the Attribute Library to include a plurality of attribute dimensions including a dimensional structure for the Reference Units and the Defined Units, the attribute dimensions comprising the environmental carbon attribute data;
configuring the LCI library database to store an environmental embodied CO2e record for the cradle to gate life cycle of an item or process, based on the process inputs and outputs of the Reference Units and the Defined Units;
configuring the display manager user interface to allow a user to input data to a storage and compute layer; and
configuring the report manager to generate an embodied CO2e GHG life cycle report or assignable certificate twinned with an item or process, as a structured data object and a machine-readable code associated with a Defined Unit.

Embodiment 63. A system configured to generate extensible carbon objects comprising input and a memory including non-transitory program memory for storing at least instructions and a processor that is operative to execute instructions that enable actions, the system comprising:
an application programming interface (API) gateway server between a logical layer and a representational layer, the API gateway server being configured with an extensible Carbon Reporting Markup Language (<CarML>) configured to interface software with the logical layer, the <CarML> comprising a core set of common data schema and message types including interface objects for extensible carbon objects, and third party external systems, the API gateway configured to allow the user to generate an extensible carbon object representing a carbon instrument.

Embodiment 64. The system of embodiment 63 further comprising a Life Cycle Inventory (LCI) library database configured to store an environmental embodied CO2e record for a cradle to gate life cycle of an item or process, based on the process inputs and outputs of a Reference Unit and a Defined Unit, wherein the system comprises a public ledger configured to record an extensible carbon object to the LCI.

Embodiment 65. The system of embodiment 64, wherein the system is configured to generate an embodied CO2e record for the cradle to gate life cycle of a product or service, based on the process inputs and outputs of one or more Reference Units and one or more Defined Units, from the LCI.

Embodiment 66. The system of embodiment 63 further comprising:
the logical layer comprising a plurality of library modules for gathering, researching, monitoring, modelling, and tracking carbon emissions, including:
a process library comprising a user interface to an external client
a Reference Unit Library comprising an extensible absolute unit reference manager to instantiate and store the Reference Unit object, wherein the Reference Unit object comprises a unit of emission datum.

Embodiment 67. The system of embodiment 66, wherein the Reference Unit Library comprises a conversion algorithm configured to convert data, locally contextual data, values to global SI (International System of Units) base units associated with the Reference Units.

Embodiment 68. The system of embodiment 66, wherein the logical layer comprising the plurality of library modules for monitoring and tracking carbon emissions further includes:
an Attribute Library comprising a plurality of extensible attribute objects configured to include a plurality of attribute dimensions including a dimensional structure for the Reference Units and the Defined Units, the attribute dimensions comprising the environmental carbon attribute data.

Embodiment 69. The system of embodiment 63, wherein the logical layer comprising the plurality of library modules for monitoring and tracking carbon emissions further includes:
a relational database comprising a database for carbon data transactions; and
a distributed immutable ledger or blockchain.

Embodiment 70. The system of embodiment 63 further comprising a display layer interface comprising:
a display manager user interface configured to allow a user to input data to a storage and compute layer; and
a report manager, the report manager being configured to generate a GHG life cycle for an item or process as a structured data object and a machine-readable code associated with a Defined Unit.

Embodiment 71. The system of embodiment 63, wherein the <CarML> is used to encode CO2e emissions and removals for a carbon life cycle analysis (LCA) to the extensible carbon object.

Embodiment 72. The system of embodiment 63, wherein the <CarML> is used to encode searchable carbon objects that are stored to a searchable greenhouse gas database and reporting module.

Embodiment 73. A method for generating extensible carbon objects and public assignable certificates that encode carbon dioxide equivalent (CO2e) emissions data, said method comprising:
providing a system comprising input and a memory including non-transitory program memory for storing at least instructions, a processor that is operative to execute instructions that enable actions, and an application programming interface (API) gateway server between a logical layer and a representational layer;
configuring the API gateway server with an extensible Carbon Reporting Markup Language (<CarML>) configured to interface software with the logical layer, wherein the <CarML> comprises a core set of common data schema and message types including interface objects for extensible carbon objects, and third party external systems; and
configuring the API gateway to allow a user to generate an extensible carbon object representing a carbon instrument that encodes carbon dioxide equivalent (CO2e) emissions data.

Embodiment 74. The method of embodiment 73, wherein the system further comprises a Life Cycle Inventory (LCI) library database, and a public ledger.

Embodiment 75. The method of embodiment 73 further comprising:
configuring the Life Cycle Inventory (LCI) library database to store an environmental embodied CO2e record for a cradle to gate life cycle of an item or process, based on the process inputs and outputs of a Reference Unit and a Defined Unit.

Embodiment 76. The method of embodiment 74 further comprising:
configuring the public ledger to record an extensible carbon object to the LCI.

Embodiment 77. The method of embodiment 73 further comprising:
configuring the system to generate an embodied CO2e record for the cradle to gate life cycle of a product or service, based on the process inputs and outputs of one or more Reference Units and one or more Defined Units, life cycle from the LCI.

Embodiment 78. The method of embodiment 73, wherein the system further comprises:
the logical layer comprising a plurality of library modules for gathering, researching, monitoring, modelling, and tracking CO2e emissions, including:
a process library comprising a user interface to an external client; and
a Reference Unit Library comprising an extensible absolute unit reference manager to instantiate and store the Reference Unit object, wherein the Reference Unit object comprises a unit of emission datum.

Embodiment 79. The method of embodiment 73, wherein the system further comprises a Reference Unit Library comprising a conversion algorithm.

Embodiment 80. The method of embodiment 78 further comprising:
configuring the Reference Unit Library comprising a conversion algorithm to convert data, locally contextual data, values to global SI (International System of Units) base units associated with the Reference Units.

Embodiment 81. The method of embodiment 73, wherein the logical layer comprising the plurality of library modules for monitoring and tracking carbon emissions further includes:
an Attribute Library comprising a plurality of extensible attribute objects.

Embodiment 82. The method of embodiment 81 further comprising:
configuring the Attribute Library comprising a plurality of extensible attribute objects to include a plurality of attribute dimensions including a dimensional structure for the Reference Units and the Defined Units, the attribute dimensions comprising the environmental carbon attribute data.

Embodiment 83. The method of embodiment 73, wherein the logical layer comprising the plurality of library modules for monitoring and tracking carbon emissions further includes:
a relational database comprising a database for carbon data transactions; and
a distributed immutable ledger or blockchain.

Embodiment 84. The method of embodiment 73, wherein the system further comprises a display layer interface comprising:
a display manager user interface; and
a report manager.

Embodiment 85. The method of embodiment 84 further comprising:
configuring the display manager user interface to allow a user to input data to a storage and compute layer; and
configuring the report manager to generate a GHG life cycle for an item or process as a structured data object and a machine-readable code associated with a Defined Unit.

Embodiment 86. The method of embodiment 73, wherein the <CarML> is used to encode CO2e emissions and removals for a carbon life cycle analysis (LCA) to the extensible carbon object.

Embodiment 87. The method of embodiment 73, wherein the <CarML> is used to encode searchable carbon objects that are stored to a searchable greenhouse gas database and reporting module.

1. A system comprising input and a memory including non-transitory program memory for storing at least instructions and a processor that is operative to execute instructions that enable actions, the system comprising:
a logical layer comprising a plurality of library modules for capturing, monitoring, tracking, and publicly declaring carbon emission data as a digital twin associated with a real world product or service, including:
a process library comprising a user interface to an external client;
a Reference Unit Library comprising an extensible absolute unit reference manager to instantiate and store a Reference Unit object, the Reference Unit object comprising a unit of emission datum;
a Defined Unit Inventory configured to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data;
an Attribute Library comprising a plurality of extensible attribute objects configured to include a plurality of attribute dimensions including a dimensional structure for the Reference Units and the Defined Units, the attribute dimensions comprising the environmental carbon attribute data and <CarML> tags;
an application programming interface (API) gateway between a logical layer and a representational layer, the API gateway server being configured with an extensible Carbon Reporting Markup Language (<CarML>) configured to interface software with logical layer, the <CarML> comprising a core set of common data schema and message types including interface objects for extensible carbon objects, and third party external systems.

2. The system of claim 1, wherein the library modules further comprise:
a Conversion Library comprising extensible conversion information for the environmental carbon attribute data and comprising a conversion algorithm configured to convert data values to base units associated with the Reference Units conversion library.

3. The system of claim 1, wherein the library modules further comprise:
a Life Cycle Inventory (LCI) library database configured to store an environmental embodied CO2e record for a cradle to gate life cycle of an item or process, based on the process inputs and outputs of the Reference Units and the Defined Units.

4. The system of claim 1, wherein the system further comprises:
a relational database comprising a database for carbon data transactions; and
a distributed immutable ledger.

5. The system of claim 1, further comprising a display layer interface comprising:
a display manager user interface configured to allow a user to input data to a storage and compute layer; and
a report manager, the report manager being configured to generate a GHG life cycle digital twin for an item or process as a structured data object report or assignable certificate which has a machine-readable code associated with a Defined Unit, and can be recorded to a public ledger.

6. The system of claim 1, wherein extensible attribute objects further comprise:
an import attribute configured to import an attribute into a client user’s Attribute Library;
a create new attribute object configured to create a new attribute type for an attribute library;
a modify attribute object configured to allow a user to modify an attribute, wherein each version of the attribute object is stored on the system;
an archive attribute configured to remove an attribute from a library, depreciate objects associated with the attribute, and alert users to the depreciation;
a copy attribute object; and
a designate attribute object configured to designate an object as a unit of measurement and/or <CarML> compliant attributes.

7. The system of claim 6 wherein an attribute object designated as a unit of measurement (UoM) attribute is configured be selected as key UoM for an object or as a functional UoM for an LCI.

8. The system of claim 1, wherein system is configured to encode carbon emissions and removals for a carbon life cycle analysis (LCA) to the extensible carbon object.

9. The system of claim 1, wherein the system is configured to encode searchable carbon objects, as reports and assignable certificates, that are stored to a searchable greenhouse gas database and reporting certificate module, and act as a system of public record.

10. A method of gathering, accounting, recording, tracking, displaying and/or transferring of embodied CO2e of a product or service as an assignable certificate, said method comprising:
providing a system comprising input and a memory including non-transitory program memory for storing at least instructions and a processor that is operative to execute instructions that enable actions; a logical layer comprising a plurality of library modules for capturing, monitoring, tracking, and publicly declaring carbon emission data as a digital twin associated with a real world product or service; an application programming interface (API) gateway between a logical layer and a representational layer, the API gateway server being configured with an extensible Carbon Reporting Markup Language (<CarML>) configured to interface software with logical layer, the <CarML> comprising a core set of common data schema and message types including interface objects for extensible carbon objects, and third party external systems; wherein the plurality of library modules includes:
a process library comprising a user interface to an external client;
a Reference Unit Library comprising an extensible absolute unit reference manager to instantiate and store a Reference Unit object, the Reference Unit object comprising a unit of emission datum;
a Defined Unit Inventory; and
an Attribute Library comprising a plurality of extensible attribute objects;
configuring the Defined Unit Inventory to inventory a Defined Unit for a user entity, the Defined Unit being configured to deplete an input, wherein the Defined Unit is configured to be inputted and outputted across a plurality of user entities as a concatenation of carbon process data, the Defined Unit Inventory comprising environmental carbon attribute data;
configuring the Attribute Library to include a plurality of attribute dimensions including a dimensional structure for the Reference Units and the Defined Units, the attribute dimensions comprising the environmental carbon attribute data and <CarML> tags; and
configuring a report manager to generate an embodied CO2e life cycle of a product or service as a structured data object report or assignable certificate which has a machine-readable code associated with the Defined Unit, and can be recorded to a public ledger.

11. The method of claim 10 wherein the environmental carbon attribute data comprises one or more of carbon credits, offsets, or other mitigation instruments.

12. The method of claim 10 wherein the environmental carbon attribute data is used to reduce the declared embodied CO2e of a product or service.

13. The method of claim 10, wherein the library modules further comprise:
a Conversion Library comprising extensible conversion information for the environmental carbon attribute data and comprising a conversion algorithm.

14. The method of claim 13, further comprising:
configuring the conversion algorithm to convert data values to base units associated with the Reference Units conversion library.

15. The method of claim 10, wherein the library modules further comprising a Life Cycle Inventory (LCI) library database.

16. The method of claim 15, further comprising:
configuring the Life Cycle Inventory (LCI) library database to store an environmental embodied CO2e record for a cradle to gate life cycle of an item or process, based on the process inputs and outputs of the Reference Units and the Defined Units.

17. The method of claim 10, wherein the system further comprises:
a relational database comprising a database for carbon data transactions; and
a distributed immutable ledger.

18. The method of claim 10, wherein the system further comprises a display layer interface.

19. The method of claim 18, further comprising:
configuring the display layer interface to allow a user to input data to a storage and compute layer.

20. The method of claim 10, wherein extensible attribute objects further comprise one or more of an import attribute, a create new attribute object, a modify attribute object, an archive attribute, a copy attribute object, and a designate attribute object.

21. The method of claim 20, further comprising one or more of:
configuring the import attribute to import an attribute into a client user’s Attribute Library;
configuring the create new attribute object to create a new attribute type for an attribute library;
configuring the modify attribute object to allow a user to modify an attribute, wherein each version of the attribute object is stored on the system;
configuring the archive attribute to remove an attribute from a library, depreciate objects associated with the attribute, and alert users to the depreciation; and
configuring the designate attribute object to designate an object as a unit of measurement and/or <CarML> compliant attributes.

22. The method of claim 10 further comprising:
configuring an attribute object designated as a unit of measurement (UoM) attribute to be selected as key UoM for an object or as a functional UoM for an LCI.

23. The method of claim 10, further comprising:
configuring the system to encode carbon emissions and removals for a carbon life cycle analysis (LCA) to the extensible carbon object.

24. The method of claim 10, further comprising:
configuring the system to encode searchable carbon objects, as reports and assignable certificates, that are stored to a searchable greenhouse gas database and reporting certificate module, and act as a system of public record.
